(19) United States
(12) Patent Application Publication
(10) Pub. No.: US 2024/0037818 A1
(43) Pub. Date: Feb. 1, 2024

(54) IMAGE PROCESSING METHOD, IMAGE PROCESSING APPARATUS, AND NUCLEAR MEDICAL DIAGNOSTIC APPARATUS

(71) Applicant: SHIMADZU CORPORATION, Kyoto-shi (JP)

(72) Inventor: Yoshiyuki YAMAKAWA, Kyoto-shi (JP)

(21) Appl. No.: 18/221,161

(22) Filed: Jul. 12, 2023

(30) Foreign Application Priority Data
Jul. 25, 2022 (JP) 2022-118164

(51) Int. Cl. G06T 11/00

(52) U.S. Cl. CPC G06T 11/008; G06T 2211/424

(57) ABSTRACT

An image processing method includes a reconstruction step of reconstructing a radiographic image of a subject by performing reconstruction processing on radiological data of the subject, a count number calculation step of calculating a count number in a subject area in the radiographic image, a standard deviation calculation step of calculating a noise standard deviation in the radiographic image from a relation between the count number in each of a plurality of pre-acquired function calculation radiographic images and the noise standard deviation, by substituting the count number in the subject area into a pre-acquired basic noise deviation function a function in which a value of the count number and a value of the noise standard deviation correspond to each other, and a noise reduction processing step of performing NLM filter processing on the radiographic image using the noise standard deviation calculated in the standard deviation calculation step.

### CROSS-REFERENCE TO RELATED APPLICATIONS

This application claims priority under 35 U.S.C. § 119 to Japanese Patent Application No. 2022-109775 filed on Jul. 7, 2022, the entire disclosure of which is incorporated herein by reference in its entirety.

### BACKGROUND OF THE INVENTION

### Field of the Invention

The present invention relates to an image processing method, an image processing apparatus, and a nuclear medicine diagnostic apparatus.

### Description of the Related Art

The following description sets forth the inventor's knowledge of the related art and problems therein and should not be construed as an admission of knowledge in the prior art.

A PET (Positron Emission Tomography) apparatus is one example of a nuclear medicine diagnostic apparatus used in the medical field. In a PET apparatus, a radiopharmaceutical agent labeled with a positron emitting nuclide is administered to a test target, and a pair of radiation (“γ-rays”) generated by a pair annihilation of positrons is detected. That is, a plurality of detectors for detecting γ-rays are arranged around a test target, and when a pair of γ-rays is detected within a certain time (coincidence), they are regarded as valid signals and measured. The γ-ray measurement data acquired from the measurement is called emission data.

After acquiring the emission data, a radiographic image (PET image) showing the distribution of the radiopharmaceutical agent is acquired by performing reconstruction processing exemplified by a successive approximation method on the emission data. The PET image acquired by the reconstruction processing is further subjected to noise reduction processing to produce an image more suitable for image diagnostics.

As one example of a noise reduction method for PET images, NLM (Non-Local Means) filter processing is exemplified. NLM filter processing is particularly excellent noise reduction processing method among edge-preserving smoothing filter processing exemplified by bilateral filter processing. When performing NLM filter processing, the user sets the following four parameters. The four parameters are the size of the support window, the size of the template window, the noise standard deviation σ, and the standard deviation h of the deviation evaluation function (Gaussian function).

NLM filter processing is a product of a filter coefficient matrix W and a filter processing target image x. By setting the four parameters described above, the (j, k) element wjk in the filter coefficient matrix is defined using Formula (11) and Formula (12) described below. Note that “Sj” denotes a support window centered at a signal point j, and “tj” denotes a vector consisting of a signal value in a template window Tj centered at the signal point j.

$${w}_{jk} = \frac{1}{{Z}_{j}} exp ( - \frac{max ( {‖ {t}_{j} - {t}_{k} ‖}_{2}^{2} - 2 {σ}^{2} , 0 )}{{h}^{2}} ) \qquad ( 11 )$$

$${Z}_{j} = {\sum }_{k ∈ {S}_{i}} exp ( - \frac{max ( {‖ {t}_{j} - {t}_{k} ‖}_{2}^{2} - 2 {σ}^{2} , 0 )}{{h}^{2}} ) \qquad ( 12 )$$

### PRIOR ART DOCUMENT

### Non-Patent Document

Non-Patent Document 1: Bundes, Antoni, Bartomeu Coll, and J-M. Morel, “A non-local algorithm for image denoising.” 2005 IEEE Computer Society Conference on Computer Vision and Pattern Recognition(CVPR'05)). Vol. 2. IEEE, 2005.

### SUMMARY OF THE INVENTION

However, in the case of the conventional example with this configuration, there are following problems.

In the case of performing NLM filter processing, the user is required to set four parameters as described above. Among the four parameters, the appropriate value for the noise standard deviation σ differs depending on the imaging or reconstruction processing conditions under which the PET images are acquired.

As one example, in cases where the imaging time of a PET image is shorter than usual, the count number in the PET image will become less than usual, resulting in less statistical precision and relatively more noise in the PET image. Therefore, in cases where the imaging time is short, it is necessary to set a value larger than usual as the noise standard deviation σ in order to perform NLM filter processing. Similarly, when the reconstruction processing conditions, i.e., the various parameters used in the reconstruction processing, change, the noise contained in the PET image increases or decreases, and therefore the appropriate value of the noise standard deviation σ changes.

In cases where the noise standard deviation σ is set lower than the appropriate value, the noise reduction processing will become weaker, thereby making it impossible to distinguish between the diagnostic target exemplified by a tumor and the noise. On the other hand, in cases where the noise standard deviation σ is set higher than appropriate, the noise reduction processing becomes too strong, and therefore, even the diagnostic target exemplified by a tumor is smoothed out. As described above, since the appropriate noise standard deviation σ varies depending on the various conditions of the PET imaging, it is difficult to improve the accuracy of the NLM filter processing for PET images.

In order to properly perform NLM filter processing on a PET image, the user is required to determine, by trial and error, the value of the noise standard deviation σ appropriate for the imaging and reconstruction processing conditions of the PET image each time a PET image of a subject or the like is captured. In the conventional configuration in which the noise standard deviation σ is determined by trial and error, the time required for appropriate PET image noise reduction processing is prolonged, and the burden on the user increases.

The present invention has been made in view of the circumstances, and it is an object to provide an image processing method, an image processing apparatus, and a nuclear medicine diagnostic apparatus capable of improving the accuracy of noise reduction processing using NLM filter processing and quickly performing noise reduction processing.

### Means for Solving the Problem

In order to achieve these objects, the present invention adopts the following configurations.

That is, according to a first aspect of the present invention, an image processing method includes:
a reconstruction step of reconstructing a radiographic image of a subject by performing reconstruction processing on radiological data of the subject;
a count number calculation step of calculating a count number in a subject area in the radiographic image of the subject;
a standard deviation calculation step of calculating a noise standard deviation in the radiographic image of the subject from a relation between the count number in each of a plurality of function calculation radiographic images acquired in advance and the noise standard deviation, by substituting the count number in the subject area into a basic noise deviation function acquired in advance as a function in which a value of the count number and a value of the noise standard deviation correspond to each other; and
a noise reduction processing step of performing NLM filter processing on the radiographic image of the subject, using the noise standard deviation calculated in the standard deviation calculation step.

Further, according to a second aspect of the present invention, an image processing apparatus includes:
a reconstruction processing unit configured to reconstruct a radiographic image of a subject by performing reconstruction processing on radiographic data of the subject for which radiographic imaging has been performed;
a count number calculation unit configured to calculate a count number in a subject area in the radiographic image of the subject;
a standard deviation calculation unit configured to calculate a noise standard deviation in the radiographic image of the subject from a relation between the count number in each of a plurality of function calculation radiographic images acquired in advance and the noise standard deviation function by substituting the count number in the subject area into a basic noise deviation function acquired in advance as a function in which a value of the count number and a value of the noise standard deviation corresponds to each other; and
a noise reduction processing unit configured to perform NLM filter processing on the radiographic image of the subject using the noise standard deviation calculated by the standard deviation calculation unit.

Further, according to a third aspect of the present invention, a nuclear medicine diagnostic apparatus includes:
a radiation detector configured to detect radiation transmitted through a subject and output radiation data; and
the image processing apparatus according to the second aspect of the present invention.

### Effects of the Invention

According to the first aspect of the present invention, the basic noise deviation function is acquired from the relation between the count number in each of the plurality of function calculation radiographic images acquired in advance and the noise standard deviation. The basic noise deviation function is a function in which the value of the count number in a radiographic image and the value of the noise standard deviation correspond to each other. Then, reconstruction processing is performed on the radiographic data of the subject to reconstruct the radiographic image of the subject, and the count number in the subject area in the radiographic image of the subject is calculated.

In the standard deviation calculation step, the noise standard deviation in the radiographic image of the subject is calculated by substituting the calculated count number into the basic noise deviation function. In the basic noise deviation function, an appropriate value of a noise standard deviation according to the value of the count number in the radiographic image is associated. Therefore, even in a case where radiographic images of the subject are captured under various imaging conditions, a value of the appropriate noise standard deviation can be quickly calculated according to each of the imaging conditions by the standard deviation calculation step. By performing NLM filter processing using the noise standard deviation calculated by the standard deviation calculation step, highly accurate noise reduction processing can be performed quickly according to the imaging condition of the radiographic image.

According to the second aspect of the present invention, the basic noise deviation function is acquired from the relation between the count number in each of a plurality of function calculation radiographic images acquired in advance and the noise standard deviation. The basic noise deviation function is a function in which the value of the count number in a radiographic image and the value of the noise standard deviation correspond to each other. The reconstruction processing unit performs reconstruction processing on the radiographic data of the subject for which radiographic imaging has been performed to reconstruct the radiographic image of the subject, and the count number calculation unit calculates the count number in the subject area in the radiographic image of the subject.

The standard deviation calculation unit calculates the noise standard deviation in the radiographic image of the subject by substituting the calculated count number into the basic noise deviation function. In the basic noise deviation function, an appropriate value of the noise standard deviation according to the value of the count number in the radiographic image is associated. Therefore, even in cases where radiographic images of the subject are captured under various imaging conditions, the appropriate noise standard deviation value can be quickly calculated by the standard deviation calculation unit according to each of the imaging conditions. By performing NLM filter processing by the noise reduction processing unit using the noise standard deviation calculated by the standard deviation calculation unit, the noise reduction processing unit can quickly perform highly accurate noise reduction processing according to the imaging condition of the radiographic image.

According to a third aspect of the present invention, a nuclear medicine diagnostic device is provided with the image processing apparatus according to the second aspect of the present invention. Therefore, highly accurate noise reduction processing according to the imaging condition of the radiographic image can be quickly performed on the radiographic image acquired by performing radiographic imaging on the subject.

### BRIEF DESCRIPTION OF THE DRAWINGS

The preferred embodiments of the present invention are shown by way of example, and not limitation, in the accompanying figures.

FIG. 1 is a vertical cross-sectional view and a functional block diagram describing a schematic configuration of a PET apparatus according to Example 1.

FIG. 2 is a diagram describing a configuration of a detector ring according to Example 1.

FIG. 3 is a flowchart describing an operation of a PET apparatus according to Example 1.

FIG. 4 is a diagram describing images used for estimating a basic noise deviation model according to Example 1.

FIG. 5 is a diagram describing Step S2 according to Example 1.

FIG. 6 is a diagram describing the steps of estimating a function corresponding to a basic noise deviation model using a scatter diagram in Step S2 according to Example 1.

FIG. 7 is a diagram schematically describing Steps S5 to S7 according to Example 1.

FIG. 8 is a functional block diagram describing a configuration of a PET apparatus according to Example 2.

FIG. 9 is a flowchart describing an operation of a PET apparatus according to Example 2.

FIG. 10 is a diagram describing images used for estimating a correction noise deviation model according to Example 2.

FIG. 11 is a diagram describing Step S2 according to Example 2.

FIG. 12 is a diagram describing steps of estimating a function corresponding to a correction noise deviation model using a scatter diagram in Step S2 according to Example 2.

FIG. 13 is a diagram schematically describing S5 to S7 according to Example 2.

FIG. 14 is a flowchart describing the details of Step SA according to Example 6.

FIG. 15 is a flowchart describing the details of Step S6 according to Example 6.

FIG. 16 is a diagram describing a model estimation image group according to Example 6.

FIG. 17 is a diagram schematically describing Steps S5 to S7 according to Example 6.

### EMBODIMENTS FOR CARRYING OUT THE INVENTION

### Example 1

Hereinafter, Example 1 of the present invention will be described with reference to the attached drawings.

### Description of General Configuration

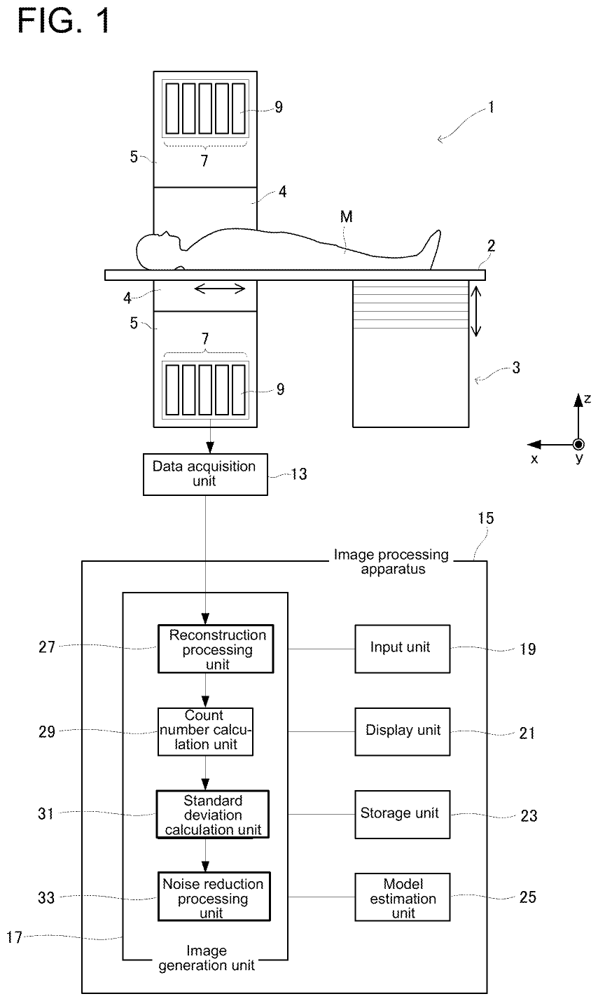

As shown in FIG. 1, the PET apparatus 1 according to Example 1 is provided with a bed device 3 having a top board 2 for placing a subject M thereon, and a gantry 5 having an opening 4. The bed device 3 is configured to ascend and descend the top board 2 in the vertical direction and translate the top board 2 along the body axis direction of the subject M. The opening 4 of the gantry 5 is configured to open in a tunnel-like configuration. The gantry 5 is equipped with a detection unit 7 for detecting γ-rays generated from the subject M. In FIG. 1, the x-direction corresponds to the body axis direction of the subject M, and the z-direction corresponds to the vertical direction.

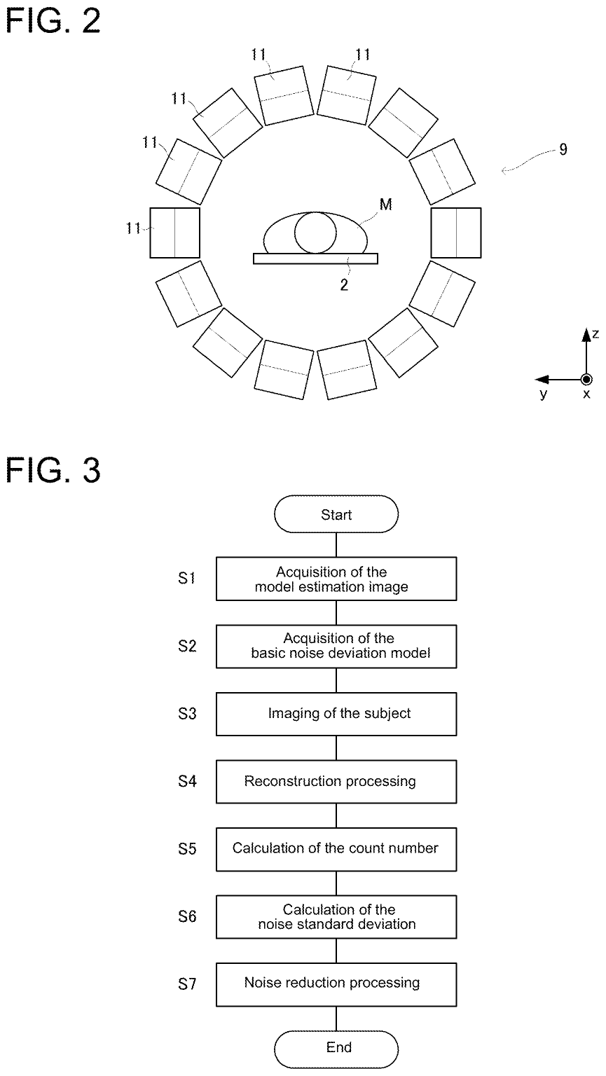

As shown in FIG. 2, the detection unit 7 is composed of a number of detector rings 9 stacked in the body axial direction of the subject M. The detector ring 9 has a configuration in which a plurality of radiation detectors 11 is arranged in a ring shape around the body axis of the subject M. The radiation detector 11 is composed of a detector block equipped with a scintillator block, a light guide, and a photomultiplier tube, as an example (none of which are shown in the figure). The scintillator block is composed of a plurality of scintillators. The scintillator block converts the γ-rays generated from the subject M, to which a radiopharmaceutical has been administered, into light, the converted light is guided by a light guide, and the photomultiplier tube converts the light into photoelectric signals and outputs electrical signals.

The PET apparatus 1 is further provided with a data acquisition unit 13 and an image processing apparatus 15. The data acquisition unit 13 collects coincidence data by measuring (counting) LOR (Line of Response), which indicates the line connecting the detector pair where two γ-rays emitted in opposite directions by 180° are detected, based on the electrical signals (detection signals) output from the radiation detectors 11.

Specifically, when a radiopharmaceutical agent is administered to a test target, such as, e.g., a subject M or a phantom, two γ-rays are generated due to the disappearance of positrons in the positron-emitting RI. The data acquisition unit 13 checks the position of the radiation detectors 11 and the incident timing of γ-rays and determines that the electrical signals sent in are appropriate data only when γ-rays are incident at the two radiation detectors 11 on both sides of the test target within a specific time. When γ-rays are incident on only one radiation detector 11, the data acquisition unit 13 dismisses the data. The electrical signal data determined to be appropriate data by the data acquisition unit 13 is transmitted from the data acquisition unit 13 to the image processing apparatus 15 as coincidence data (emission data).

The image processing apparatus 15 is provided with information processing means, such as, e.g., a central processing unit (CPU) as one example, and performs various types of arithmetic processing. The image processing apparatus 15 is provided with an image generation unit 17, an input unit 19, a display unit 21, a storage unit 23, and a model estimation unit 25. The image generation unit 17 performs various calculations using the coincidence data or the like collected by the data acquisition unit 13 to generate a PET image showing the distribution of the radiopharmaceutical agent within the detection target.

The input unit 19 inputs operation instructions by the user (operator). Examples of the input unit 19 include a keyboard input device, a touch input device, or a mouse input device. The display unit 21 displays various data exemplified by image information, an example of which is a liquid crystal display. The PET image generated by the image generation unit 17 is displayed on the display unit 21.

The storage unit 23 stores various types of data, such as, e.g., coincidence data and various types of image information. One example of the storage unit 23 is a nonvolatile memory. Further, in the storage unit 23, data of a plurality of model estimation images F, which will be described later, has been stored in advance. The model estimation unit 25 estimates a noise deviation model by using each of the model estimation images F. The details of the noise deviation model N and the method of estimating the noise deviation model using the model estimation images F will be described below.

As shown in FIG. 1, the image generation unit 17 is provided with a reconstruction processing unit 27, a count number calculation unit 29, a standard deviation calculation unit 31, and a noise reduction processing unit 33. The reconstruction processing unit 27 generates a radiographic image G of the subject M by performing reconstruction processing on the coincidence count data collected by the data acquisition unit 13. The radiographic image G is a PET image in a state in which noise reduction processing has not yet been performed.

The count number calculation unit 29 calculates the value of the count number corresponding to the radiographic image G generated by the reconstruction processing unit 27. In Example 1, the count number calculation unit 29 calculates the average of the counts (the number of LORs) inside the area in which the subject M is reflected in the radiographic image G as a count number.

The standard deviation calculation unit 31 calculates the value of the noise standard deviation corresponding to the radiographic image G by using the estimated noise deviation model and the value of the count number calculated by the count number calculation unit 29. The noise reduction processing unit 33 performs noise reduction processing by NLM filter processing on the radiographic image G, using the value of the noise standard deviation calculated by the standard deviation calculation unit 31. When the radiographic image G is subjected to noise reduction processing by the noise reduction processing unit 33, a noise-reduced image H is generated. The noise-reduced image H corresponds to a PET image in the state in which noise reduction processing has been performed.

### Description of Operation

Here, the operation of the PET apparatus 1 according to Example 1 will be described. FIG. 3 is a flowchart describing a series of processes to acquire PET images of a subject M using the PET apparatus 1. In Example 1, the processes of Step S1 and Step S2 are performed as preliminary stage to perform PET imaging of the subject M.

### Step S1 (Acquisition of Model Estimation Image)

As a preliminary stage to acquire PET images of a subject M, a model estimation image group L is first acquired. The model estimation image group L is an image group consisting of a plurality of PET images used to estimate the noise deviation model P. As one example, the model estimation image group L is a PET image group of phantoms F. The model estimation image group L corresponds to function calculation radiographic images in this embodiment.

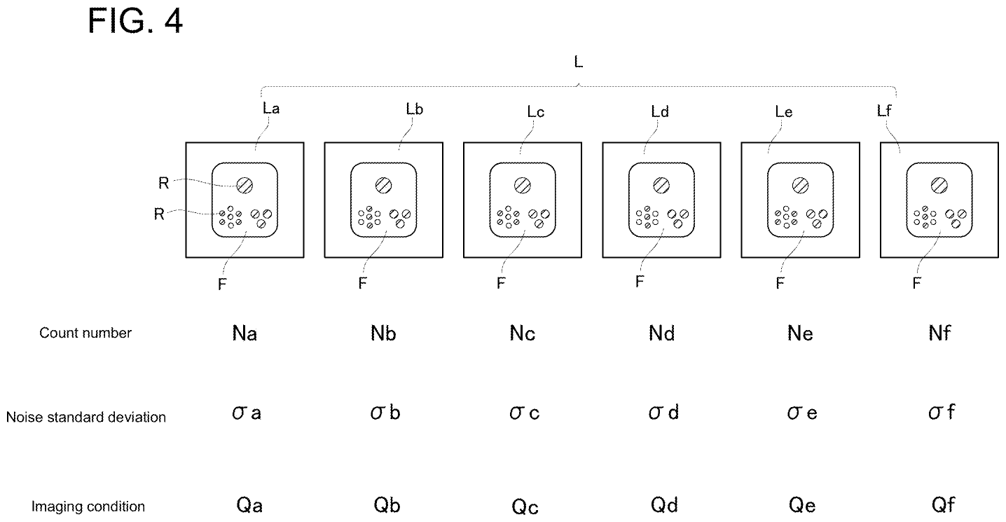

In Example 1, the model estimation image group L is composed of six PET images La to Lf as shown in FIG. 4. The PET images La to Lf are model estimation images used for estimating the basic noise deviation model Pa. The PET images La to Lf are generated under imaging conditions different from each other, and the subject is a phantom F into which a radiopharmaceutical agent R has been injected. As an example of the imaging condition, the imaging time of the PET images, the concentration of the radiopharmaceutical agent R, or the amount of the radiopharmaceutical agent R can be exemplified. When the imaging conditions are different, even in the case of generating PET images using the same phantom F, the value of the count number in the PET image and the value of the appropriate noise standard deviation becomes different. Note that, as shown in FIG. 4, the imaging conditions for the PET images La to Lf are defined as the imaging conditions Qa to Qf, respectively.

As an example of a means for acquiring the model estimation image group L, it may be acquired by capturing images using the PET apparatus 1. As another example, image data captured in advance using an apparatus other than the PET apparatus 1 may be acquired by transferring the image data to the PET apparatus 1 by means of communication means, etc., not shown in the figure. The acquired model estimation image group L is stored in the storage unit 23.

For each of the PET images La to Lf, the value of the count number corresponding to each image and the value of the noise standard deviation σ corresponding to each image have been calculated in advance. As an example, “Na” has been calculated in advance for the PET image La as the value of the count number, and aa has been calculated in advance as an appropriate value of the noise standard deviation for the NLM filter processing for PET image La. Similarly, for each of the PET images Lb to Lf, the count numbers Nb to Nf and the noise standard deviations σb to σf have been calculated in advance. The information on the count numbers Na to Nf and the information on the noise standard deviations σa to σf are associated with each other and stored in the storage unit 23.

Note that the calculation processing to calculate the count numbers Na to Nf and the noise standard deviations σa to σf for each of the PET images La to Lf may be performed using the PET apparatus 1. As an example, the count numbers Na to Nf can be calculated from each of the PET images La to Lf by using the count number calculation unit 29, which will be described below. The calculation processing may be performed by another device, and the data of the count numbers Na to Nf and the noise standard deviations σa to σf may be transmitted to the PET apparatus 1.

The method of calculating the value of the count number for each of the model estimation image groups L may be determined as appropriate. In Example 1, the average count number in the area (in this case, the internal area of the phantom F) within the subject in each of the PET images La to Lf is calculated as the value of the count number corresponding to the image. As a specific example of the calculation method, a subject mask image is generated for each of the PET images La to Lf, and the count number Na to Nf corresponding to the PET images La to Lf respectively is calculated by calculating the count number in the mask area.

A conventional method may be used, as needed, to calculate the noise standard deviation αa to σf for each of the PET images La to Lf. Since the noise standard deviations σa to σf are calculated in advance before imaging the subject M, the processes for capturing PET images of the subject M are not prolonged due to the processes for calculating the noise standard deviations σa to σf. The process of Step S1 is completed by acquiring the data of the model estimation image L and the data of the count number corresponding to each of the model estimation images L and the noise standard deviation.

### Step S2 (Acquisition of Basic Noise Deviation Model)

After acquiring the data of the model estimation image group L, a basic noise deviation model is acquired. In Example 1, the model estimation unit 25 acquires the basic noise deviation model Pa as the noise deviation model P by performing calculations using data, such as, e.g., PET images La to Lf. The method of acquiring the basic noise deviation model Pa in Example 1 is described below.

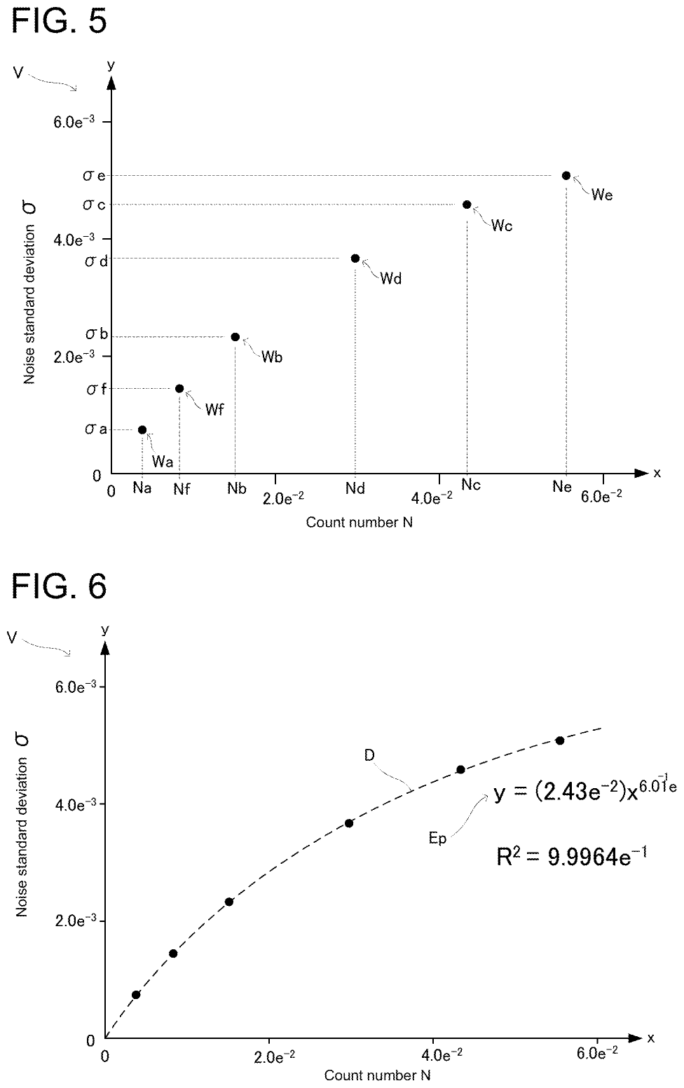

The model estimation unit 25 first reads out the data of the count numbers Na to Nf and the data of the noise standard deviations σa to σf from the storage unit 23. Next, the model estimation unit 25 uses the data of the count numbers Na to Nf and the noise standard deviations σa to σf to generate a scatter diagram V as shown in FIG. 5. The scatter diagram V is a two-dimensional plot diagram in which the count numbers N correspond to the x-axis and the noise standard deviations σ correspond to the y-axis.

In the scatter diagram V, the coordinates of the count number and the noise standard deviation corresponding to each of the PET images La to Lf, which are model estimation images, are plotted. Specifically, as a coordinate corresponding to the PET image La, the coordinate Wa is plotted in the scatter diagram V in which the count number Na corresponding to the PET image La is the x-component and the noise standard deviation σa corresponding to the PET image La is the y-component. Similarly, as the coordinate corresponding to the PET image Lb, the coordinate Wb (Nb, ab) is plotted, and as the coordinates corresponding to the PET images Lc to Lf, the coordinates We to Wf are plotted in the scatter diagram V.

When the scatter diagram V is generated in which the coordinates Wa to Wf corresponding to the PET images La to Lf respectively are plotted, the model estimation unit estimates the basic noise deviation model Pa using the scatter diagram V. The basic noise deviation model Pa is a function in which the count number N and the basic noise standard deviation at correspond to each other and a function satisfying the following Formula (1).

σₜ=α₁*N^{α2}+α₃ (1)

In the above-described Formula (1), “a1” is a first count model coefficient, “a2” is a second count model coefficient, and “a3” is a third count model coefficient. The model estimation unit 25 estimates the basic noise deviation model Pa by estimating appropriate values as the first count model coefficient a1, the second count model coefficient a2, and the third count model coefficient a3.

The specific example of the method for estimating the basic noise deviation model Pa is as follows. First, a curve conforming to each of the coordinates Wa to Wf is calculated as an approximate curve D. The approximate curve D is represented as a function Ep to find the value of y corresponding to the noise standard deviation with the count number as the variable x. As a specific example, in the case in which the approximate curve D is calculated using the scatter diagram V shown in FIG. 5, the approximate curve D conforming to each of the coordinates Wa to Wf corresponds to a function Ep expressed as y=(2.43e⁻²)×^{6.01e-1} as shown in FIG. 6. In this case, the first count model coefficient a1 corresponds to 2.43e⁻², which is the coefficient of x. The second count model coefficient a2 corresponds to 6.01e⁻¹, which is the power exponent of x. The third count model coefficient a3 corresponds to the y-intercept of the function Ep. Since the y-intercept in the function Ep is 0, the model estimation unit 25 estimates the third count model coefficient a3 to be 0.

As described above, the model estimation unit 25 calculates the function Ep by estimating appropriate values as the first count model coefficients a1, the second count model coefficients a2, and the third count model coefficients a3. The model estimation unit 25 acquires the calculated function Ep as the basic noise deviation model Pa.

The basic noise deviation model Pa is a model showing the relation between the count number N and the basic noise standard deviation at, which is calculated using the first model estimation images La to Lf acquired under mutually different imaging conditions. In other words, by using the relation between the mutually different count numbers Na to Nf and the noise standard deviations σa to σf appropriate for each of the count numbers Na to Nf, a basic noise deviation model Pa in which the relation between the count number N and the basic noise standard deviation at is modeled is calculated. Therefore, the basic noise deviation model Pa can quickly and accurately identify, for any given count number N, the value of the basic noise standard deviation at appropriate for the given count number N.

The basic noise deviation model Pa estimated by the model estimation unit 25 is stored in the storage unit 23. Note that in Example 1, the basic noise deviation model Pa is used as it is as the noise deviation model P. In other words, in Example 1, the basic noise deviation model Pa is used as the noise deviation model P without any special correction. The process of Step S2 is completed when the noise deviation model P is acquired by the model estimation unit 25. In the PET apparatus 1, the noise deviation model P is acquired and stored in the storage unit 23 in advance as a preliminary stage to image the subject M.

### Step S3 (Imaging of Subject)

After becoming a state in which the noise deviation model P is stored in the storage unit 23, the PET imaging of the subject M is performed using the PET apparatus 1. In other words, a radiopharmaceutical agent labeled with a positron emitting radioisotope is administered to the subject M. The subject M to which the radiopharmaceutical agent has been administered is then placed on the top board 2, and the top board 2 is moved to an arbitrary position inside the opening 4 of the gantry 5. Note that the imaging condition for the first PET imaging is set to Qy.

The γ-rays emitted from the subject M are uniformly emitted in all directions. Each radiation detector 11 of the detection unit 7 detects two γ-rays emitted from the subject M in opposite directions by 180°, and the radiation detector 11 that detected the γ-rays outputs an electrical signal (detection signal). The data acquisition unit 13 counts simultaneously as a pair of γ-rays when the time difference between the γ-rays detected by the two radiation detectors 11 is within a preset time. Then, the LOR data connecting the two-detector pair in which two γ-rays emitted in opposite directions by 180° are detected is collected. The LOR data (coincidence data) collected by the data acquisition unit 13 is transmitted to the reconstruction processing unit 27 provided by the image processing apparatus 15.

### Step S4 (Reconstruction Processing)

When the data acquisition unit 13 transmits the coincidence data to the image processing apparatus 15, the reconstruction processing in Step S4 is initiated. The reconstruction processing unit 27 generates a radiographic image G by performing reconstruction processing on the coincidence data collected by the data acquisition unit 13. The radiographic image G is a PET image showing the distribution of the radiopharmaceutical agent inside the subject M. However, in Step S4, the radiographic image G is in a state in which the noise reduction processing using the NLM filter has not yet been performed.

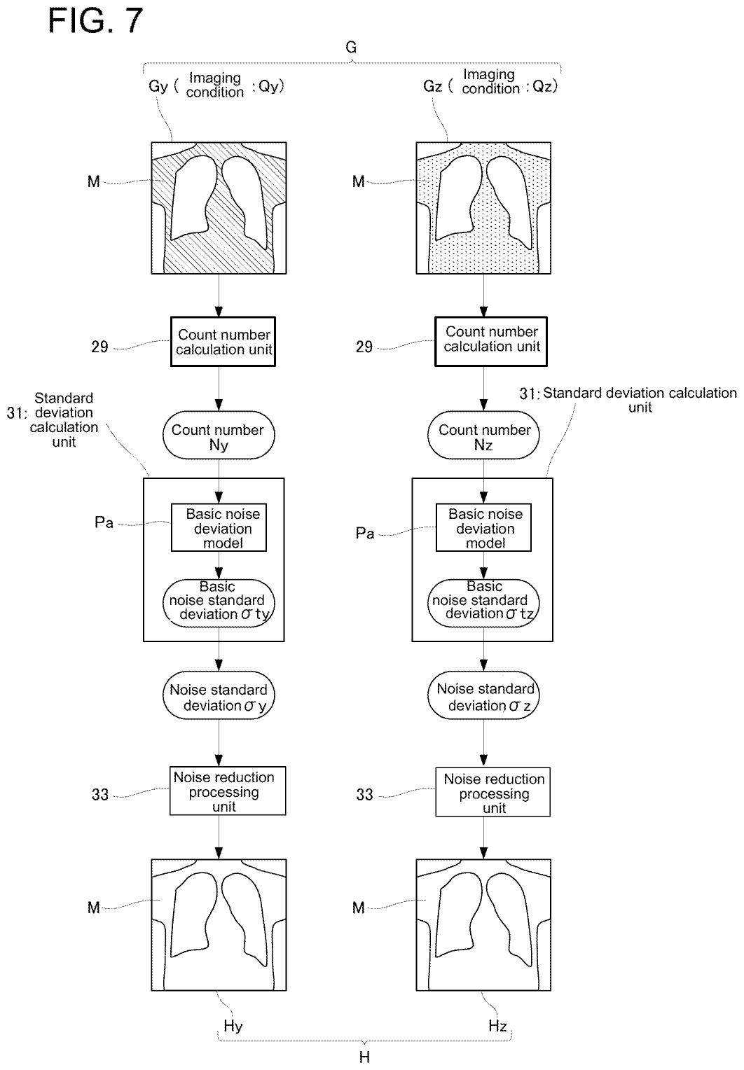

Note that among the radiographic images G, the radiographic image G produced by PET imaging under the imaging condition Qy is labeled as a radiographic image Gy as shown in FIG. 7 to distinguish it from the radiographic images G captured under other imaging conditions (see the upper left portion of FIG. 7).

The technique used for the reconstruction processing of the radiographic image G may be chosen as desired and may be an analytical reconstruction technique, such as, e.g., an FBP (Filtered Back Projection) method. Further, a sequential approximate reconstruction method (e.g., an OSEM (Ordered Subset Expectation Maximization) method and an MLEM (Maximum Likelihood Expectation Maximization) method) may be used. The radiographic image G of the subject M generated by the reconstruction processing is transmitted from the reconstruction processing unit 27 to the count number calculation unit 29. The process in Step S4 corresponds to the reconstruction step in this embodiment.

### Step S5 (Calculation of Count Number)

When the reconstructed radiographic image G is transmitted to the count number calculation unit 29, the count number is calculated for the radiographic image G acquired for the subject M. In other words, the count number calculation unit 29 calculates the count number in the radiographic image G of the subject M. The calculation method of the count number is the same as the count number calculation method performed for the model estimation image L. In Example 1, the average of the counts within the area in which the subject M is reflected is calculated as the count number. As shown in FIG. 7, the count number calculated for the radiographic image Gy is assigned by the reference symbol Ny and set to a count number Ny. The information on the count number calculated by the count number calculation unit 29 for the radiographic image G is transmitted from the count number calculation unit 29 to the standard deviation calculation unit 31. The radiographic image G of the subject M corresponds to the “radiographic image of the subject” in this embodiment.

### Step S6 (Calculation of Noise Standard Deviation)

The standard deviation calculation unit 31 calculates the noise standard deviation using the information on the count number calculated by the count number calculation unit 29 and the noise deviation model P acquired in advance. First, the standard deviation calculation unit 31 reads out the noise deviation model P stored in the storage unit 23. In Example 1, as the noise deviation model P, the basic noise deviation model Pa shown in Formula (1) is read out.

After reading out the noise deviation model P, the standard deviation calculation unit 31 calculates the noise standard deviation suitable for the radiographic image G of the subject M by substituting the count number acquired for the radiographic image G of the subject into the noise deviation model P. Specifically, by substituting the count number Ny calculated for the radiographic image Gy into the noise deviation model P, the value of the basic noise standard deviation at suitable for the radiographic image Gy acquired under the imaging condition Qy is calculated. As shown in FIG. 7, the basic noise standard deviation at acquired as the value suitable for the radiographic image Gy is assigned by a reference symbol σty and referred to as a “basic noise standard deviation σty.”

The basic noise deviation model Pa read out as the noise deviation model P is a function capable of obtaining the basic noise standard deviation at with the count number N as a variable, as shown in Formula (1). Therefore, by substituting the value of the count number Ny calculated for the radiographic image Gy into the term of the variable N (count number N) in Formula (1), the value of the basic noise standard deviation σty is quickly specified as the value of the basic noise standard deviation at appropriate for the radiographic image Gy.

In Example 1, the basic noise standard deviation at is used as it is as the noise standard deviation σ in the NLM filter processing in Step S7. In other words, in Example 1, the formula σ=σt is established. That is, in Example 1, the standard deviation calculation unit 31 calculates the value (basic noise standard deviation σty) calculated as the basic noise standard deviation at suitable for the radiographic image Gy as the noise standard deviation σ (noise standard deviation σy) suitable for the radiographic image Gy. The information on the noise standard deviation σy (basic noise standard deviation σty) calculated as the noise standard deviation σ suitable for the radiographic image Gy is transmitted from the standard deviation calculation unit 31 to the noise reduction processing unit 33.

### Step S7 (Noise Reduction Processing)

When the information on the noise standard deviation σ suitable for the radiographic image G of the subject M is transmitted to the noise reduction processing unit 33, the noise reduction processing by the NLM filter processing is performed on the radiographic image G. The user sets three parameters, i.e., the size of the support window, the size of the template window, and the standard deviation h of the deviation evaluation function.

The noise reduction processing unit 33 performs the NLM filter processing on the radiographic image Gy using the information on the noise standard deviation σ (here, the basic noise standard deviation σty) calculated by the standard deviation calculation unit 31 and the three parameters set by the user. The noise reduction processing unit 33 performs the NLM filter processing to generate the noise-reduced image Hy from the radiographic image Gy (see the lower left of FIG. 7). The noise-reduced image Hy is a PET image in which noise has been reduced from the radiographic image Gy by the NLM filter processing. The noise-reduced image Hy is displayed on the display unit 21, and the user performs diagnosis on the subject M using the noise-reduced image Hy. With the above-described steps, a series of PET imaging under the imaging condition Qy is completed.

Note that in the case of performing the PET imaging of the subject M under the imaging condition different from the imaging condition Qy again, the process returns to Step S3 and the processes of Steps S3 to S7 are performed again. In other words, under the imaging condition Qz different from the imaging condition Qy, the PET imaging of the subject M is performed using the PET apparatus 1 to generate a radiographic image G (Steps S3 and S4) again. As shown in the upper right column of FIG. 7, the radiographic image G acquired under the imaging condition Qz is displayed as a radiographic image Gz to distinguish it from the radiographic image Gy acquired under the imaging condition Qy. The data of the radiographic image Gz is transmitted to the count number calculation unit 29.

The count number calculation unit 29 calculates the count number in the radiographic image Gz. That is, the count number calculation unit 29 scans the area in the radiographic image Gz in which the subject M is reflected and calculates the average count number inside the area as the count number Nz of the radiographic image Gz. If the imaging conditions differs, the count number differs in the radiographic image G even if the same subject M is used. Therefore, the count number Ny of the radiographic image Gy acquired under the imaging condition Qy and the count number Nz of the radiographic image Gz acquired under the imaging condition Qz are different in value. The data of the count number Nz is transmitted to the standard deviation calculation unit 31.

The standard deviation calculation unit 31 reads out the noise standard deviation model P (basic noise deviation model Pa in Example 1) from the storage unit 23 and substitutes the value of the count number Nz into the term of the count number N in the noise standard deviation model P, thereby calculating the noise standard deviation value appropriate for the radiographic image Gz. The basic noise deviation model Pa is a model (function) capable of calculating an appropriate basic noise standard deviation at corresponding to the count number N regardless of the value of the count number N. Therefore, by substituting the count number Nz into the term of the variable N (count number N), the appropriate basic noise standard deviation at corresponding to the radiographic image Gz acquired under the imaging condition Qz can be quickly calculated.

As shown in FIG. 7, the basic noise standard deviation at acquired as the value corresponding to the radiographic image Gz is assigned by the reference symbol σz and referred to as a “basic noise standard deviation σtz.” The information on the basic noise standard deviation σtz is transmitted from the standard deviation calculation unit 31 to the noise reduction processing unit 33 as the noise standard deviation σ suitable for the radiographic image Gz (noise standard deviation σz).

The noise reduction processing unit 33 performs the NLM filter processing on the radiographic image Gy using the information on the basic noise standard deviation σz calculated by the standard deviation calculation unit 31 and three parameters set by the user. The noise reduction processing unit 33 performs the NLM filter processing to generate a noise-reduced image Hz from the radiographic image Gz (see the lower right of FIG. 7). The noise-reduced image Hz is displayed on the display unit 21, and the user performs diagnosis of the subject M under the imaging conditions Qz using the noise-reduced image Hz. Hereafter, in the case of performing diagnoses under different imaging conditions, the processes from Step S3 to Step S7 are repeated as necessary to complete the PET imaging of the subject M.

### Example 2

Next, Example 2 of the present invention will be described. Note that the same configuration as that of the PET apparatus 1 described in Example 1 is assigned by the same reference symbol, and the details of the different configurations are described in detail. In other words, the image processing apparatus according to Example 2 is assigned by the reference symbol 15A to distinguish it from the image processing apparatus 15 according to Example 1.

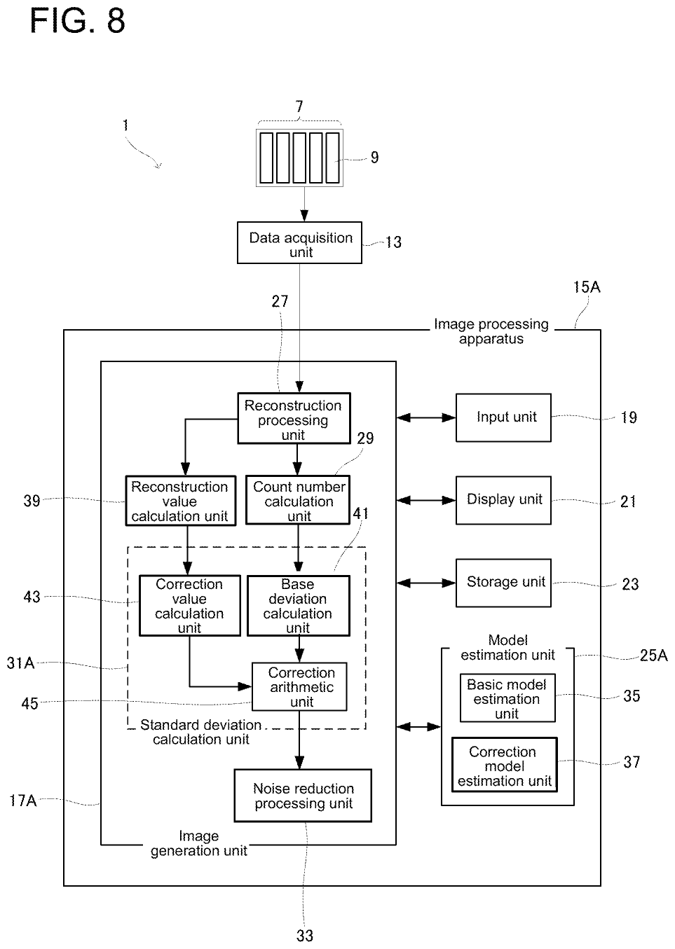

The image processing apparatus 15A according to Example 2 differs from the image processing apparatus 15 according to Example 1 in that it is provided with a basic model estimation unit 35, a correction model estimation unit 37, and a reconstruction value calculation unit 39, as shown in FIG. 8. The basic model estimation unit 35 and the correction model estimation unit 37 are provided on the model estimation unit 25A according to Example 2. The reconstruction value calculation unit 39 is provided on the image generation unit 17A according to Example 2.

The basic model estimation unit 35 estimates the basic noise deviation model Pa using the model estimation image group L in the same manner as in the model estimation unit 25 according to Example 1. The correction model estimation unit 37 estimates a correction noise deviation model Pb using the model estimation image group L. The correction noise deviation model Pb is a model for calculating the standard deviation correction value f according to the reconstruction processing condition in the model estimation image group L and is a function (model) in which a prescribed parameter in the reconstruction processing and an optimal standard deviation correction value fin the prescribed parameter correspond to each other. In Example 2, the iteration number is used as the predetermined parameter in the reconstruction processing. The iteration number is the number of the iteration calculation in the calculation of the reconstruction processing.

The reconstruction value calculation unit 39 is provided at the latter stage of the reconstruction processing unit 27 to calculate a predetermined parameter value in the reconstruction processing performed on the radiographic image G generated by the reconstruction processing unit 27. In Example 2, the reconstruction value calculation unit 39 calculates the value of the iteration number i in the radiographic image G.

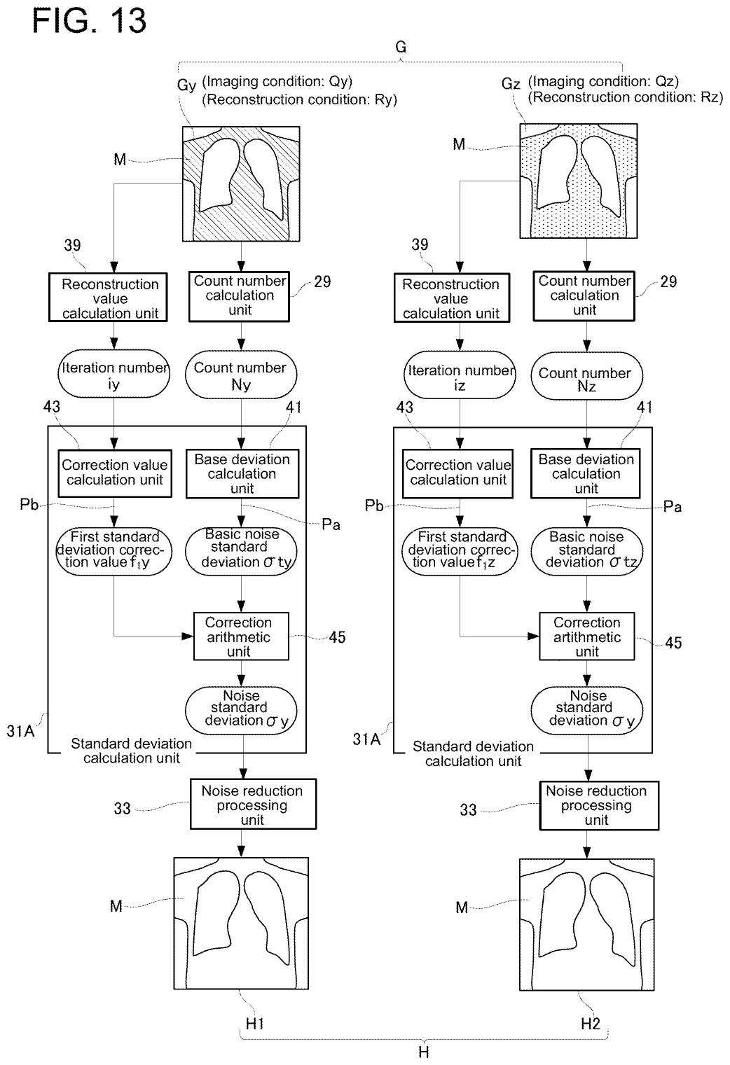

The standard deviation calculation unit 31A according to Example 2 is provided with a basic noise standard deviation calculation unit 41, a correction value calculation unit 43, and a correction arithmetic unit 45, as shown in FIG. 8 and FIG. 13. The basic noise standard deviation calculation unit 41 calculates the basic noise standard deviation at in the radiographic image G by using the value of the count number calculated for the radiographic image G and the basic noise deviation model Pa acquired by the basic model estimation unit 35.

The correction value calculation unit 43 calculates the standard deviation correction value f for the radiographic image G by using the predetermined parameter value calculated for the radiographic image G by the reconstruction value calculation unit 39 and the correction noise standard deviation model acquired by the correction model estimation unit 37. The standard deviation correction value f for a radiographic image G means the standard deviation correction value f used to correct the basic noise standard deviation at calculated for the radiographic image G. In Example 2, the first standard deviation correction value f1 is calculated as the standard deviation correction value f, as described below. The first standard deviation correction value f1 is a standard deviation correction value f calculated based on the iteration number i. The correction arithmetic unit 45 performs a calculation to correct the basic noise standard deviation at with the first standard deviation correction value f1 to calculate a suitable value of the noise standard deviation σ in the NLM filter processing for the radiographic image G.

### Description of Operation in Example 2

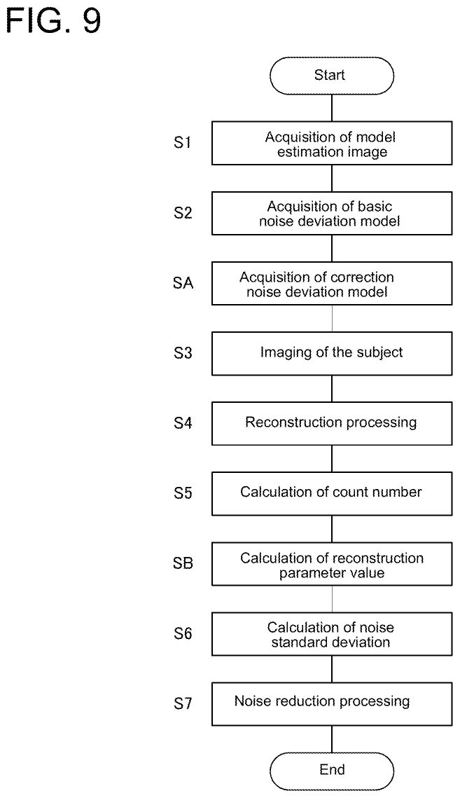

Here, the operation of the PET apparatus 1 according to Example 2 is described. FIG. 9 is a flowchart describing a series of processes to acquire PET images of a subject M using the PET apparatus 1 according to Example 2. In Example 2, as a preliminary stage for performing the PET imaging of the subject M, Step SA is performed in addition to Steps S1 and S2. Furthermore, in Example 2, Step SB is performed between Step S5 and Step S6. The operation of the PET apparatus 1 in Example 2 differs from the operation of the PET apparatus 1 in Example 1 in that it further includes the processes of Step SA and Step SB.

### Step S1 (Acquisition of Model Estimation Image)

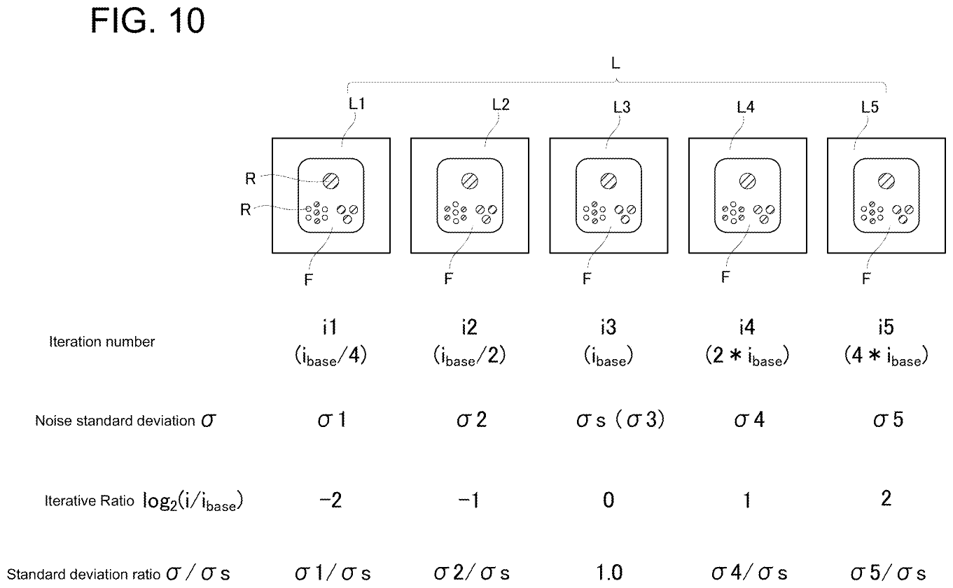

As a preliminary stage for acquiring PET images of the subject M, a model estimation image group L is first acquired. In Example 2, as the model estimation image group L, PET images L1 to L5 shown in FIG. 10 are used, in addition to the PET images La to Lf shown in FIG. 4. The PET images La to Lf are model estimation images used for estimating the basic noise deviation model Pa as in Example 1. The PET images La to Lf are an image group consisting of a plurality of PET images generated under mutually different imaging conditions.

The PET images L1 to L5 are model estimation images used for estimating the correction noise deviation model Pb. For each of the PET images L1 to L5, the value of the iteration number i and the value of the noise standard deviation σ corresponding to each image are calculated in advance. As an example, as shown in FIG. 10, “i1” is has been calculated in advance for the PET image L1 as the value of the iteration number i, and “σ1” has been calculated in advance as the value of the noise standard deviation suitable for the NLM filter processing for the PET image L1. Similarly, for each of the PET images L2 to L5, the iteration number i2 to i5 and the noise standard deviations σ2 to σ5 have been calculated in advance.

Unlike the PET images La to Lf, the PET images L1 to L5 are generated under the same imaging condition Qi. However, the PET images L1 to L5 are different in the parameter value of the iteration number in the reconstruction processing. That is, the iteration numbers i1 to i5 in the PET images L1 to L5 are mutually different values. The PET images L1 to L5 may be images captured using the PET apparatus 1, or images captured using other PET apparatuses. Each of the model estimation image groups L is stored in the storage unit 23.

Further, as a predetermined constant, the standard iteration number i_{base} is determined, and the reference standard deviation as is also determined. The reference standard deviation as is a value of the noise standard deviation σ suitable for the NLM filter processing for a PET image generated under the imaging condition Qi and the reference iteration number i_{base}. As shown in FIG. 10, in Example 2, the iteration number i3 in the PET image L3 is defined as the reference iteration number i_{base}, and the noise standard deviation σ3 in the PET image L3 is defined as the reference standard deviation σs. Further, in Example 2, as shown in FIG. 10 as an example, the values of the iteration numbers i1, i2, i4, and i5 are assumed to be ¼ of i_{base}, ½ of i_{base}, 2 times of i_{base}, and 4 times of i_{base}, respectively.

The information on the iteration numbers i1 to i5 and the information on the noise standard deviations σ1 to σ5 are associated with each other and stored in the storage unit 23. Further, the information on the count numbers Na to Nf and the information on the noise standard deviations σa to σf are associated with each other and stored in the storage unit 23, as in Example 1.

### Step S2 (Acquisition of Basic Noise Deviation Model)

After acquiring the data of the model estimation image group L, in the basic model estimation unit 35 of the model estimation unit 25A, the calculation to acquire the basic noise deviation model Pa is performed. The method of acquiring the basic noise deviation model Pa by the basic model estimation unit 35 in Example 2 is the same as the method of acquiring the basic noise deviation model Pa by the model estimation unit 25 in Example 1, and therefore a part of the description will be omitted.

When Step S2 is initiated, the basic model estimation unit 35 generates a scatter diagram V in which the coordinates Wa to Wf are plotted, using the data of the count numbers Na to Nf and the data of the noise standard deviations σa to σf (see FIG. 5). When a scatter diagram V is generated, the basic model estimation unit 35 estimates the basic noise deviation model Pa using the scatter diagram V. That is, for the function satisfying Formula (1) described above, the values of the first count model coefficient a1, the second count model coefficient a2, and the third count model coefficient a3 appropriate for each of the coordinates Wa to Wf are estimated. By the estimation of the model coefficients, a function Ep corresponding to the basic noise deviation model Pa is acquired. The basic noise deviation model Pa is transmitted to the storage unit 23 and stored therein.

### Step SA (Acquisition of Correction Noise Deviation Model)

In Example 2, after acquiring the basic noise deviation model Pa, the correction noise deviation model Pb is further acquired. In other words, the calculation to acquire the correction noise deviation model Pb is performed by the correction model estimation unit 37 in the model estimation unit 25A. The method of acquiring the correction noise deviation model Pb in Example 2 is described below.

The correction model estimation unit 37 first reads out the data of the iteration numbers i1 to i5 and the data of the noise standard deviations σ1 to σ5 from the storage unit 23. Next, the correction model estimation unit 37 calculates the iteration number ratio for each of the PET images L1 to L5, which are model estimation images, using the iteration numbers i1 to i5 and the reference iteration number i_{base} (iteration number i3 in this Example).

As shown in FIG. 10 to FIG. 12, the iteration number ratio is calculated as a value of “log₂(i/i_{base}).” Here, the value of the iteration number corresponding to the PET image to be calculated is substituted into the i term. As an example, when determining the iteration number ratio of the PET image L1, the iteration number i1 of the PET image L1 corresponds to ¼ of the reference iteration number i_{base}. Therefore, as shown in FIG. 10, the iteration number ratio of the PET image L1 is “−2.” Similarly, the values of the iteration number ratios for the PET images L2 to L5 are “−1,” “0,” “1,” and “2” in this order.

The correction model estimation unit 37 calculates the standard deviation ratio for each of the PET images L1 to L5, using the values of the noise standard deviations σ1 to σ5 and the reference standard deviation σs. The standard deviation ratio is calculated as the value of “σ/σs.” Here, the value of the noise standard deviation corresponding to the PET image to be calculated is substituted into the term of σ.

As an example, when determining the standard deviation ratio of the PET image L1, the value of the noise standard deviation corresponding to the PET image L1 is σ1, so the standard deviation ratio is “σ1/σs.” Similarly, the standard deviation ratios for the PET images L2 to L5 are “σ2/σs,” “1.0 (σs/σs),” “σ4/σs,” and “σ5/σs” in this order.

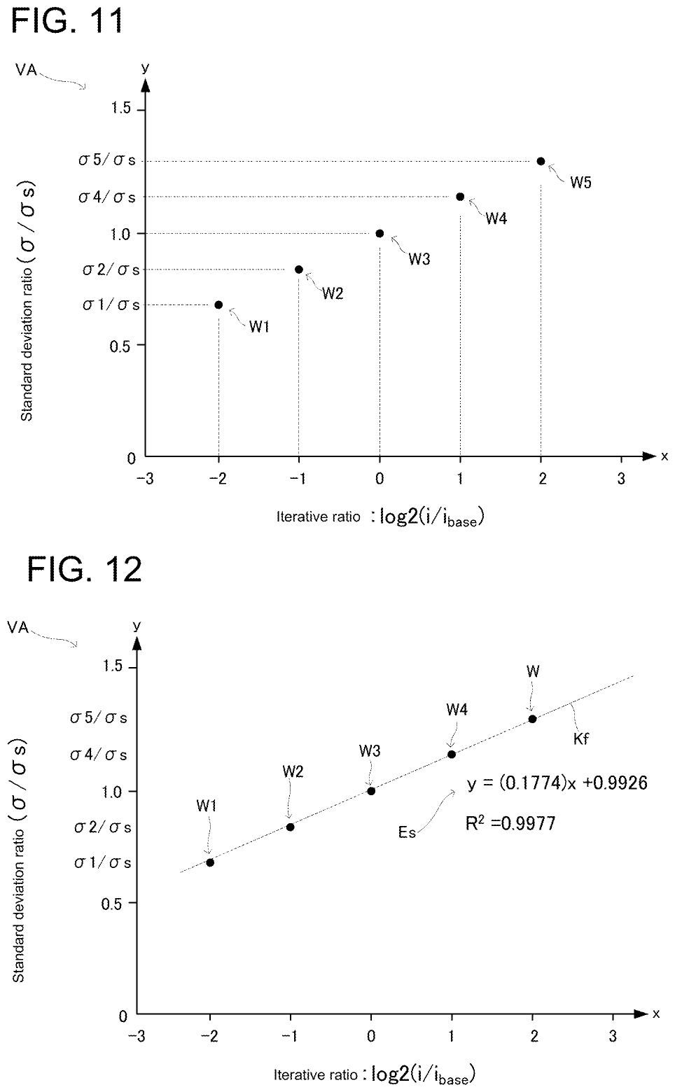

Next, the correction model estimation unit 37 generates a scatter diagram VA as shown in FIG. 11, using the data of the iteration number ratio and the data of the standard deviation ratio. The scatter diagram VA is a two-dimensional plot diagram in which the value of “log₂(i/i_{base}),” which is the iteration number ratio, corresponds to the x-axis, and the value of “σ/σs,” which is the standard deviation ratio, corresponds to the y-axis.

In the scatter diagram VA, the coordinates of the iteration number ratio and the standard deviation ratio corresponding to each of the PET images L1 to L5, which are model estimation images, are plotted. Specifically, as the coordinate corresponding to the PET image L1, the coordinate W1 in which “−2”, which is the iteration number ratio corresponding to the PET image L1, is the x-component, and “a1/as”, which is the standard deviation ratio corresponding to the PET image L1, is the y-component, is plotted in the scatter diagram V. Similarly, as the coordinate corresponding to the PET image L2, the coordinate W2 (−1, σ2/σs) is plotted in the scatter diagram VA, and as the coordinates corresponding to the PET images L3 to L5, the coordinates W3 to W5 are plotted in the scatter diagram VA.

When the scatter diagram VA in which the coordinates W1 to W5 corresponding to the PET images L1 to L5 respectively are plotted is generated, the correction model estimation unit 37 estimates the correction noise deviation model Pb using the scatter diagram VA. In Example 2, the correction noise deviation model Pb is a function in which the iteration number i and the first standard deviation correction value f1 correspond to each other and a function that satisfies the following Formula (2).

$${f}_{1} = {b}_{1} * {log}_{2} ( \frac{i}{{i}^{base}} ) + {b}_{2} \qquad ( 2 )$$

In Formula (2) described above, “b1” is a first iteration model coefficient, and “b2” is a second iteration model coefficient. The correction model estimation unit 37 estimates the correction noise deviation model Pb by estimating appropriate values as the first iterative model coefficient b1 and the second iterative model coefficient b2. The correction noise deviation model Pb corresponds to the first correction function in this embodiment.

Note that the first standard deviation correction value f1 is a numerical value calculated using the iteration number i of the standard deviation correction value f that corrects the basic noise standard deviation at, and corresponds to the standard deviation ratio σ/σs. In other words, in the case of acquiring PET images, even if the imaging conditions are the same, if the reconstruction conditions differ, the value of the noise standard deviation appropriate for the PET image will change. As an example, comparing the PET image L3 and the PET image L4, although the imaging conditions are the same for both images, the iteration number i4 of the PET image L4 is twice as large as the iteration number i3 of the PET image L3. As a result, the noise standard deviation suitable for the PET image L4 increases by a factor of (σ4/σs) as compared with the noise standard deviation suitable for the PET image L4. As described above, when the iteration number of the PET image changes, it is necessary to correct the basic noise standard deviation at according to the amount of change in the iteration number.

The specific example of the method for estimating the correction noise deviation model Pb is as follows. First, a curve conforming to each of the coordinates W1 to W5 is calculated as an approximate curve Kf. The approximate curve Kf is expressed as a function Es with the iteration number ratio as the variable x. In the function Es, with the iteration number ratio as the variable x, the value of y corresponding to the standard deviation ratio is obtained. When the approximate curve Kf is calculated using the scatter diagram VA shown in FIG. 11 as a concrete example, as shown in FIG. 12, the approximate curve Kf conforming to each of the coordinates W1 to W5 corresponds to the function Es expressed by “y=(0.1774)x+0.9926.” In this case, the first iterative model coefficient b1 corresponds to “0.1774,” which is the coefficient of x. The second iterative model coefficient b2 corresponds to “0.9926,” which is the y-intercept of the function Es.

As described above, the correction model estimation unit 37 calculates the function Es by estimating appropriate values as the first iteration model coefficients b 1 and the second iteration model coefficients b2. Then, the correction model estimation unit 37 acquires the calculated function Es as the correction noise deviation model Pb.

The correction noise deviation model Pb is a model showing the relation between the iteration number i and the first standard deviation correction value f1, which is calculated using the PET images L1 to L5 different from each other in the reconstruction processing condition. In other words, by using the relation between the values of the mutually different iteration number ratios and the standard deviation ratio appropriate for each of the iteration number ratios, a correction noise deviation model Pb is calculated in which the relation between the iteration number ratio and the first standard deviation correction value f1 is modeled. In “log₂(i/i_{base}),” which is the iteration number ratio, the reference iteration number i_{base} is constant. Therefore, by substituting any iteration number i into the correction noise standard deviation model Pb, the first standard deviation correction value f1 corresponding to the substituted iteration number i can be calculated quickly and accurately.

The correction noise deviation model Pb estimated by the correction model estimation unit 37 is stored in the storage unit 23. Note that in Example 2, the basic noise deviation model Pa and the correction noise deviation model Pb are used as the noise deviation model P, as described below. In other words, in Example 2, the basic noise deviation model Pa is used as the noise deviation model P by being corrected by the correction noise deviation model Pb. The process of Step SA is completed when the correction noise deviation model Pb is acquired by the correction model estimation unit 37. In the PET apparatus 1 according to Example 2, as a preliminary stage for imaging the subject M, the basic noise deviation model Pa and the correction noise deviation model Pb are acquired and stored in the storage unit 23 in advance.

### Step S3 (Imaging of Subject)

After becoming a state in which the basic noise deviation model Pa and the correction noise deviation model Pb are stored in the storage unit 23, the PET imaging of the subject M is performed using the PET apparatus 1. The process of Step S3 in Example 2 is the same as that in Example 1, so the detailed description is omitted. Note that the imaging condition for the first PET imaging is set to Qy. The coincidence data collected by the data acquisition unit 13 is transmitted to the reconstruction processing unit 27 provided on the image processing apparatus 15.

### Step S4 (Reconstruction Processing)

When the data acquisition unit 13 transmits the coincidence data to the image processing apparatus 15, the reconstruction processing in Step S4 is initiated. The process in Step S4 in Example 2 is also the same as that in Example 1, so the detailed description is omitted. The reconstruction processing unit 27 generates a radiographic image G by performing reconstruction processing on the coincidence data collected by the data acquisition unit 13. Note that the condition in the reconstruction processing of the radiographic image Gy is denoted as the reconstruction condition Ry. The value of the iteration number i used in the reconstruction condition Ry is denoted as the iteration number iy (see the upper left portion of FIG. 13). The radiographic image G of the subject M generated by the reconstruction processing is transmitted from the reconstruction processing unit 27 to the count number calculation unit 29 and the reconstruction value calculation unit 39.

### Step S5 (Calculation of Count Number)

When the reconstructed radiographic image G is transmitted to the count number calculation unit 29, the count number is calculated for the radiographic image G acquired for the subject M. The process of Step S5 in Example 2 is also the same as that in Example 1, so the detailed description is omitted. In other words, the count number calculation unit 29 calculates the count number in the radiographic image G of the subject M. That is, as shown in FIG. 13, the count number Ny is calculated for the radiographic image Gy. The information on the count number calculated by the count number calculation unit 29 for the radiographic image G is transmitted from the count number calculation unit 29 to the standard deviation calculation unit 31A.

### Step SB (Calculation of Reconstruction Parameter Value)

In Example 2, in parallel with the process in which the count number calculation unit 29 calculates the count number of the radiographic image G, the process of calculating the reconstruction parameter value in the radiographic image G is performed. The reconstruction parameter value means a predetermined parameter value in the reconstruction processing for generating the radiographic image G, and in Example 2, it corresponds to the iteration number i. The calculation of the reconstruction parameter value is performed in the reconstruction value calculation unit 39. That is, the reconstruction value calculation unit 39 calculates the iteration number i used in the reconstruction processing of the radiographic image Gy. Since the iteration number iy is used as a parameter in the reconstruction processing of the radiographic image Gy, the reconstruction value calculation unit 39 calculates the data of the iteration number iy and transmits it to the standard deviation calculation unit 31A.

### Step S6 (Calculation of Noise Standard Deviation)

The standard deviation calculation unit 31A calculates the value of the noise standard deviation σ appropriate for the NLM filter processing for the radiographic image G, using the information on the count number calculated by the count number calculation unit 29 and the noise deviation model P acquired in advance. First, the standard deviation calculation unit 31A reads out the basic noise deviation model Pa and the correction noise deviation model Pb stored in the storage unit 23.

In Example 2, Step S6 in which the standard deviation calculation unit 31A calculates the value of the noise standard deviation σ is roughly divided into three steps. The first step is a step in which the basic noise standard deviation calculation unit 41 calculates the basic noise standard deviation σt using the basic noise deviation model Pa and the count number N. The second step is a step in which the correction value calculation unit 43 calculates the standard deviation correction value f using the correction noise deviation model Pb and the parameter value (here, the iteration number i) of the reconstruction processing. The third step is the step in which the correction arithmetic unit 45 corrects the basic noise standard deviation σt with the standard deviation correction value f and calculates the value of the noise standard deviation σ.

First, the first step in Step S6 according to Example 2 is described. The basic noise standard deviation calculation unit 41 receives the information on the basic noise deviation model Pa and the information on the count number of the radiographic images G. The basic noise standard deviation calculation unit 41 calculates the basic noise standard deviation σt corresponding to the radiographic image G of the subject M by substituting the count number acquired for the radiographic image G of the subject M into the basic noise deviation model Pa.

Specifically, the value of the count number Ny calculated for the radiographic image Gy is substituted into the term of the count number N, which is a variable, in the function of the basic noise deviation model Pa shown in Formula (1). In the function of the basic noise deviation model Pa, the first count model coefficient a1, the second count model coefficient a2, and the third count model coefficient a3 are all constants estimated by the basic model estimation unit 35. Therefore, by substituting the value of the count number Ny identified by the count number calculation unit 29 into the basic noise deviation model Pa shown in Formula (1), the value of the basic noise standard deviation σty can be quickly determined as the value of the basic noise standard deviation σt.

Next, the second step of Step S6 according to Example 2 is described. The correction value calculation unit 43 receives the information on the correction noise deviation model Pb and the information on the iteration number i of the radiographic image G. The correction value calculation unit 43 then calculates the standard deviation correction value f (first standard deviation correction value f1 in Example 2) corresponding to the radiographic image G by substituting the iteration number i acquired for the radiographic image G of the subject M into the correction noise deviation model Pb.

Specifically, the value of the iteration number iy calculated for the radiographic image Gy is substituted into the term of the iteration number i, which is a variable, in the function of the correction noise deviation model Pb shown in Formula (2). In the function of the correction noise deviation model Pb, the first iteration model coefficient b 1 and the second iteration model coefficient b2 are both constants estimated by the correction model estimation unit 37. Therefore, by substituting the value of the iteration number iy identified by the reconstruction value calculation unit 39 into the correction noise deviation model Pb shown in Formula (2), an appropriate value as the first standard deviation correction value f1 corresponding to the basic noise standard deviation σty is identified. The first standard deviation correction value f₁ used for the radiographic image Gy is referred to as “the first standard deviation correction value fly” as shown in FIG. 13.

Finally, the third step in Step S6 according to Example 2 will be described. The correction arithmetic unit 45 calculates the noise standard deviation σ appropriate for the NLM filter processing for the radiographic image G by correcting the basic noise standard deviation σt using the first standard deviation correction value f₁. In Example 2, the noise deviation model P is a function corresponding to the multiplication of the basic noise deviation model Pa shown in Formula (1) and the correction noise deviation model Pb shown in Formula (2). In other words, the appropriate noise standard deviation σ for the radiographic image G can be obtained by the following Formula (3) using the basic noise standard deviation σt and the first standard deviation correction value f₁.

σ=σₜ*f₁ (3)

In other words, in Example 2, as the noise standard deviation σ in the NLM filter processing performed in Step S7, the value obtained by multiplying the basic noise standard deviation σt by the first standard deviation correction value f₁ is used. The correction arithmetic unit 45 calculates the product of the basic noise standard deviation σty corresponding to the radiographic image Gy and the first standard deviation correction value f_{1y} as the value of the noise standard deviation σ (noise standard deviation σy) suitable for the radiographic image Gy. The information on the noise standard deviation σy calculated as the information on the noise standard deviation σ suitable for the radiographic image Gy is transmitted from the standard deviation calculation unit 31A to the noise reduction processing unit 33.

### Step S7 (Noise Reduction Processing)

When the information of the noise standard deviation σ suitable for the radiographic image G of the subject M is transmitted to the noise reduction processing unit 33, the noise reduction processing by NLM filter processing is performed on the radiographic image G. The user sets three parameters, i.e., the size of the support window, the size of the template window, and the standard deviation h of the deviation evaluation function.

The noise reduction processing unit 33 performs NLM filter processing on the radiographic image Gy using the information on the noise standard deviation σ (here, the noise standard deviation σy) calculated by the standard deviation calculation unit 31A and the three parameters set by the user. The noise reduction processing unit 33 performs NLM filter processing to generate a noise-reduced image Hy from the radiographic image Gy (see the lower left of FIG. 13). The noise-reduced image Hy is displayed on the display unit 21, and the user performs diagnosis on the subject M using the noise-reduced image Hy. With the above-described process, a series of PET capturing under the imaging condition Qy is completed.

Note that in the case of capturing PET images of the subject M again under the imaging condition different from the imaging condition Qy and under the reconstruction condition different from the reconstruction condition Ry, the process returns to Step S3 to perform Steps S3 to S7 again. In Example 2, the “reconstruction condition different from the reconstruction condition Ry” means a reconstruction condition in which the parameter of the iteration number i is different from the reconstruction condition Ry. In other words, under the imaging condition Qz, which is different from the imaging condition Qy, the PET apparatus 1 is used to collect the coincidence count data by performing PET imaging of the subject M (Step S3).

Then, reconstruction processing is performed under the reconstruction condition Rz different from the reconstruction condition Ry, and the radiographic image G is generated again (Step S4). In the reconstruction condition Ry, the reconstruction processing is performed with the iteration number iy as a parameter, while in the reconstruction condition Rz, the reconstruction processing is performed with the iteration number iz as a parameter. As shown in the upper right column of FIG. 7, the radiographic image G acquired under the imaging condition Qz and the reconstruction condition Rz is displayed as the radiographic image Gz to distinguish it from the radiographic image Gy. The data of the radiographic image Gz is transmitted to the count number calculation unit 29 and the reconstruction value calculation unit 39.

The count number calculation unit 29 calculates the count number Nz of the radiographic image Gz (Step S5). The reconstruction value calculation unit 39 calculates the iteration number iz of the radiographic image Gz (Step SB). The standard deviation calculation unit 31A calculates the value σz of the noise standard deviation appropriate for the radiographic image Gz, using the count number Nz, the basic noise deviation model Pa, the iteration number iz, and the correction noise deviation model Pb (Step S6). That is, the basic noise standard deviation calculation unit 41 calculates the basic noise standard deviation σtz by substituting the value of the count number Nz into the term N in the basic noise deviation model Pa shown in Formula (1).

The correction value calculation unit 43 calculates the first standard deviation correction value f_{1z} by substituting the value of the iteration number iz into the term i in the correction noise deviation model Pb shown in Formula (2). The correction arithmetic unit 45 performs an arithmetic operation of substituting the value of the basic noise standard deviation σtz into the at term in the Formula (5) and substituting the value of the first standard deviation correction value f_{1z} into the term f₁ in the Formula (5). Through this arithmetic operation, the basic noise standard deviation σ_{tz} is corrected by the first standard deviation correction value f_{1z}, and the value of the noise standard deviation σz is calculated.

Finally, the noise reduction processing unit 33 performs NLM filter processing on the radiographic image Gz using the noise standard deviation σz and the three parameters set by the user. The noise in the radiographic image Gz is reduced by the NLM filter processing, and a noise-reduced image Hz is generated (Step S7). Hereafter, when it is necessary to perform diagnosis under different imaging condition or reconstruction condition, the processes from Step S3 to Step S7 are repeated as appropriate, and the PET imaging of the subject M is completed.

### Example 3

Next, Example 3 of the present invention will be described. The configuration of the PET apparatus 1 according to Example 3 is basically the same as that of Example 2 shown in FIG. 8. However, the operation of each configuration in Example 3 differs from that in Example 2 mainly in the following points.

First, in Example 2, the iteration number i is used as a predetermined parameter in the reconstruction processing. On the other hand, in Example 3, a subset number s is used as a predetermined parameter in the reconstruction processing. The subset number is the subset number divided in the calculation processing of the reconstruction processing.

Second, the correction model estimation unit 37 estimates a correction noise deviation model Pc as a model for calculating the standard deviation correction value f. Unlike the correction noise deviation model Pb used in Example 2, the correction noise deviation model Pc is a function in which the subset number s and the standard deviation correction value f correspond. Note that the standard deviation correction value fin Example 3 is the “second standard deviation correction value f2.” The second standard deviation correction value f2 is the standard deviation correction value f calculated based on the subset number s.

Third, the reconstruction value calculation unit 39 calculates the subset number s for the radiographic image G of the subject M. Fourth, the standard deviation calculation unit 31A calculates the value of the noise standard deviation σ suitable for the NLM filter processing for the radiographic image G of the subject M by using the count number N, the basic noise deviation model Pa, the subset number s, and the correction noise deviation model Pc.

### Description of Operation According to Example 3

Here, the operation of the PET apparatus 1 according to Example 3 will be described. The operation of Example 3 is basically the same as the flowchart of Example 2 shown in FIG. 9. In other words, unlike Example 1, in Example 3, the processes in Steps SA and SB are performed. For this reason, the detailed description of the operations common to Example 2 will be omitted, and the characteristic operations of Example 3 will be described.

### Step S1 (Acquisition of Model Estimation Image)

As a preliminary stage of acquiring PET images of the subject M, a model estimation image group L is first acquired. In Example 3, PET images L6 to L10 are used as the model estimation image group L in addition to the PET images La to Lf shown in FIG. 4. The PET images La to Lf are radiographic images used for estimating the basic noise deviation model Pa, as in Example 1. The PET images La to Lf are an image group consisting of a plurality of PET images generated under mutually different imaging conditions.

The PET images L6 to L10 are radiographic images used for estimating the correction noise deviation model Pc. For each of the PET images L6 to L10, the value of the subset number s and the value of the noise standard deviation σ corresponding to each image are calculated in advance. As one example, for the PET image L6, s6 has been calculated in advance as the value of the subset number s, and a6 has been calculated in advance as a noise standard deviation value appropriate for NLM filter processing for the PET image L6. Similarly, for each of the PET images L7 to L10, the subset number s7 to s10 and the noise standard deviations σ7 to σ10 have been calculated in advance.

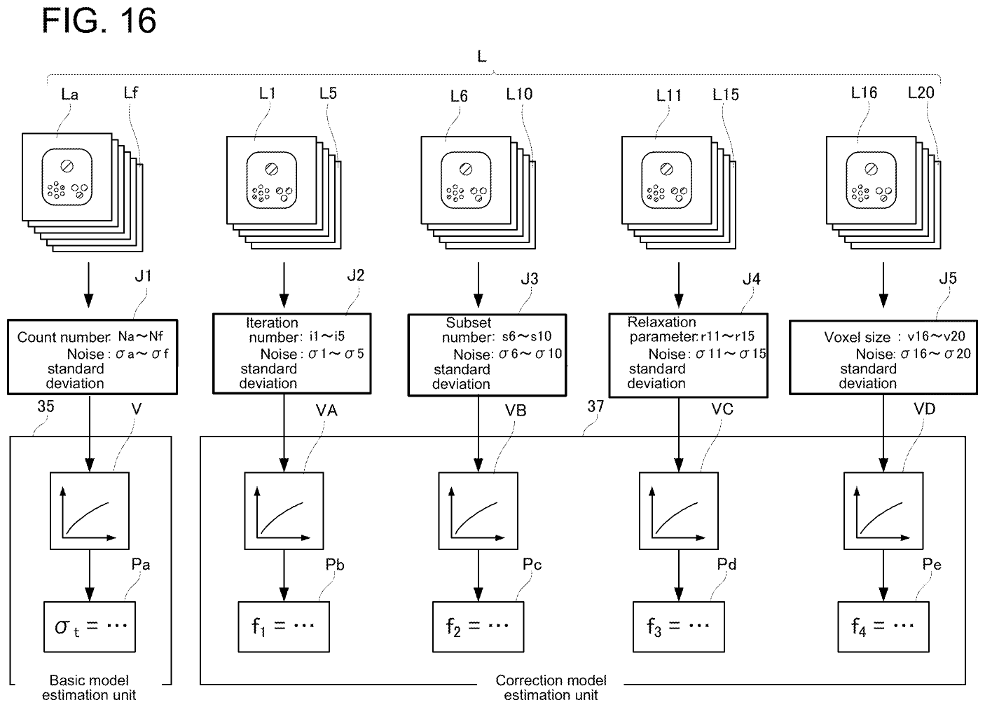

The PET images L6 to L10 differ from the PET images La to Lf and are generated under the same imaging condition Qs. However, the PET images L6 to L10 are different in the parameter value of the subset number in the reconstruction processing. That is, as shown in FIG. 16, when the parameter values of the subset numbers s used in the reconstruction processing of the PET images L6 to L10 are s6 to s10, respectively, the subset numbers s6 to s10 are mutually different values.

Further, as the predefined reference subset model, the predefined reference subset number s_{base} is determined, and the standard standard deviation σs is also determined. The reference standard deviation σs is the value of the noise standard deviation σ suitable for NLM filter processing for the PET images generated under the imaging condition Qs and the reference subset number s_{base}. As an example, the subset number s8 in the PET image L8 may be defined as the standard subset number s_{base}, and the noise standard deviation σ8 in the PET image L8 may be defined as the standard standard standard deviation σs.

### Step S2 (Acquisition of Basic Noise Deviation Model)

After acquiring the data of the model estimation image group L, the basic model estimation unit 35 acquires the basic noise deviation model Pa as in Example 2. That is, the basic model estimation unit 35 generates a scatter diagram V with the coordinates Wa to Wf plotted using the data of count numbers Na to Nf and the data of noise standard deviations σa to σf (see FIG. 5). When the scatter diagram V is generated, the basic model estimation unit 35 estimates the basic noise deviation model Pa using the scatter diagram V. In other words, for the function satisfying the above-described Formula (1), by estimating the values of the first count model coefficient a1, the second count model coefficient a2, and the third count model coefficient a3 suitable for each of the coordinates Wa to Wf, the function Ep with the count number N as a variable can be identified as the basic noise deviation model Pa. The basic noise deviation model Pa is transmitted to the storage unit 23 for storage.

### Step SA (Acquisition of Correction Noise Deviation Model)

In Example 3, after acquiring the basic noise deviation model Pa, the correction noise deviation model Pc is further acquired by the correction model estimation unit 37. The method of acquiring the correction noise deviation model Pc in Example 3 will be described below.

The correction model estimation unit 37 first reads out the data of the subset numbers s6 to s10 and the data of the noise standard deviations σ6 to σ10 from the storage unit 23. Next, the correction model estimation unit 37 calculates the subset number ratio for each of the PET images L6 to L10 and the model estimation images, using the subset numbers s6 to s10 and the reference subset number s_{base}. The subset number ratio is calculated as a value of “log₂(s/s_{base}).” As an example, the iteration number ratio of the PET image L6 is “log₂(s6/s_{base}).”

Furthermore, the correction model estimation unit 37 calculates the standard deviation ratio for each of the PET images L1 to L5 using the noise standard deviation σ6 to σ10 and the standard standard deviation σs. The standard deviation ratio is calculated as the value of “σ/σs.” Here, the value of the noise standard deviation corresponding to the PET image to be calculated is substituted into the term of σ. As an example, the standard deviation ratio of the PET image L7 is “σ7/σs.”

Next, the correction model estimation unit 37 generates a scatter diagram VB using the data on the subset number ratio and the data on the standard deviation ratio. The scatter diagram VB is a two-dimensional plot diagram in which the value of “log₂(s/s_{base}),” which is the subset number ratio, corresponds to the x-axis, and the value of “σ/σs,” which is the standard deviation ratio, corresponds to the y-axis. The configuration of the scatter diagram VB is similar to the configuration of the scatter diagram VA shown in FIG. 11, so the illustration of the scatter diagram VB is omitted.

In the scatter diagram VB, the coordinates W6 to W10 of the subset number ratio and the standard deviation ratio corresponding to each of the PET images L6 to L10, which are the model estimation images, are plotted. As a specific example, as the coordinates corresponding to the PET image L6, the coordinate W6 in which “log₂(s6/s_{base})”, which is the subset number ratio corresponding to the PET image L6, is the x-component and “σ6/σs,” which is the standard deviation ratio corresponding to the PET image L6, is the y-component, is plotted on the scatter diagram VB.

When the scatter diagram VB in which the coordinates W6 to W10 are plotted is generated, the correction model estimation unit 37 estimates the correction noise deviation model Pc using the scatter diagram VB. In Example 3, the correction noise deviation model Pc is a function in which the subset number i and the second standard deviation correction value f2 correspond to each other and is a function satisfying the following Formula (4).

$${f}_{2} = {c}_{1} * {log}_{2} ( \frac{s}{{s}^{base}} ) + {c}_{2} \qquad ( 4 )$$

In Formula (4) described above, “c₁” is a first subset model coefficient, and “c₂” is a second subset model coefficient. The correction model estimation unit 37 estimates the correction noise deviation model Pc by estimating appropriate values as the first subset model coefficient c₁ and the second subset model coefficient c₂. The correction noise deviation model Pc corresponds to the second correction function in this embodiment.

Note that the second standard deviation correction value f₂ is a numerical value calculated using the subset number s out of the standard deviation correction value f that corrects the basic noise standard deviation σt, and corresponds to the standard deviation ratio σ/σs. In other words, when PET images are acquired, even if the imaging condition is the same, if the parameters of the subset numbers in the reconstruction conditions differ, the value of the noise standard deviation appropriate for the PET image will change. Therefore, when the parameter of the subset number in the reconstruction processing of PET images changes, it is necessary to correct the basic noise standard deviation σt according to the amount of change in the subset number.

The specific example of the method for estimating the correction noise deviation model Pc is as follows. First, an approximate curve conforming to each of the coordinates W6 to W10 is calculated. The approximate curve is expressed as a function with the subset number ratio as the variable x. In this function, the value of y corresponding to the standard deviation ratio, i.e., the second standard deviation correction value f₂, is obtained with the subset number ratio as the variable x.

The correction model estimation unit 37 acquires the correction noise deviation model Pc by estimating appropriate values as the first iterative model coefficient b₁ and the second iterative model coefficient b₂, based on a function representing an approximate curve conforming to each of the coordinates W6 to W10.

The correction noise deviation model Pc is a model representing the relation between the subset number s and the second standard deviation correction value f₂, calculated using the PET images L6 to L10, which are different in the reconstruction processing condition, respectively. In other words, by using the relation between the value of the subset number ratio different from each other and the standard deviation ratio appropriate for each of the subset number ratios, a correction noise deviation model Pc in which the relation between the subset number ratio and the second standard deviation correction value f₂ is modeled is calculated. In “log₂(s/s_{base}),” which is the subset number ratio, the reference subset number s_{base} is constant. Therefore, by substituting an arbitrary subset number s into the correction noise deviation model Pc, the second standard deviation correction value f₂ according to the substituted subset number s can be calculated quickly and accurately. The correction noise deviation model Pc estimated by the correction model estimation unit 37 is stored in the storage unit 23.

### Step S3 (Imaging of Subject)

After acquiring the basic noise deviation model Pa and the correction noise deviation model Pc, the PET imaging of the subject M is performed using the PET apparatus 1. The process of Step S3 in Example 3 is the same as in Example 1, so the detailed description will be omitted. Note that the imaging condition for the first PET imaging is set to Qy. The coincidence data collected by the data acquisition unit 13 is transmitted to the reconstruction processing unit 27 provided by the image processing apparatus 15.

### Step S4 (Reconstruction Processing)

When the data acquisition unit 13 transmits the coincidence data to the image processing apparatus 15, the reconstruction processing in Step S4 is initiated. The process in Step S4 in Example 3 is also the same as in Example 1. In other words, the reconstruction processing unit 27 performs reconstruction processing on the coincidence data to generate a radiographic image Gy. Note that the condition in the reconstruction processing of the radiographic image Gy is referred to as the reconstruction condition Ry. The value of the subset number s used in the reconstruction condition Ry is referred to as the subset number sy. The radiographic image G of the subject M generated by the reconstruction processing is transmitted from the reconstruction processing unit 27 to the count number calculation unit 29 and the reconstruction value calculation unit 39.

### Step S5 (Calculation of Count Number)

When the reconstructed radiographic image G is transmitted to the count number calculation unit 29, the count number is calculated for the radiographic image G acquired for the subject M. The process of Step S5 in Example 3 is also the same as in Example 1. That is, the count number calculation unit 29 calculates the count number in the radiographic image G of the subject M. In other words, as shown in FIG. 13, the count number Ny is calculated for the radiographic image Gy. The information on the count number calculated by the count number calculation unit 29 for the radiographic image G is transmitted from the count number calculation unit 29 to the standard deviation calculation unit 31A.

### Step SB (Calculation of Reconstruction Parameter Value)

In parallel with the process in which the count number calculation unit 29 calculates the count number of radiographic images G, the process of calculating the reconstruction parameter values in the radiographic images G is performed. In Example 3, the reconstruction parameter value corresponds to the subset number s. That is, the reconstruction value calculation unit 39 calculates the subset number s used in the reconstruction processing of the radiographic image G. Since the subset number sy is used as a parameter in the reconstruction processing of the radiographic image Gy, the reconstruction value calculation unit 39 calculates the data of the subset number sy and transmits it to the standard deviation calculation unit 31A.

### Step S6 (Calculation of Noise Standard Deviation)

The standard deviation calculation unit 31A calculates the value of the noise standard deviation σ appropriate for the NLM filter processing for the radiographic image G, using the information on the count number, etc., calculated by the count number calculation unit 29. First, the standard deviation calculation unit 31A reads out the basic noise deviation model Pa and the correction noise deviation model Pc stored in the storage unit 23. As in Example 2, Step S6 in Example 3 is divided into three major steps.

The first step in Step S6 of Example 3 will be described. The basic noise standard deviation calculation unit 41 receives the information on the basic noise deviation model Pa and the information on the count number of the radiographic image G. The basic noise standard deviation calculation unit 41 then calculates the basic noise standard deviation σt corresponding to the radiographic image G of the subject M by substituting the value of the count number acquired for the radiographic image G of the subject M into the basic noise deviation model Pa. Specifically, the value of the basic noise standard deviation σty is calculated as the value of the basic noise standard deviation σt in the radiographic image Gy by substituting the value of the count number Ny calculated for the radiographic image Gy into the term of the count number N, which is a variable in Formula (1).

The second step of Step S6 of Example 3 will be described. The correction value calculation unit 43 receives the information on the correction noise deviation model Pc and the information on the subset number s of the radiographic image G. The correction value calculation unit 43 then calculates the standard deviation correction value f (the second standard deviation correction value f₂ in Example 3) corresponding to the radiographic image G by substituting the subset number s acquired for the radiographic image G of the subject M into the corrected noise deviation model Pc.

Specifically, the value of the subset number sy calculated for the radiographic image Gy is substituted into the term of the subset number s, which is a variable, in the function of the correction noise deviation model Pc shown in Formula (4). In the function of the correction noise deviation model Pc, the first subset model coefficient c₁ and the second subset model coefficient c₂ are both constants estimated by the correction model estimation unit 37. Therefore, by substituting the value of the subset number sy identified by the reconstruction value calculation unit 39 into the correction noise deviation model Pc shown in Formula (4), an appropriate value is identified as the second standard deviation correction value f₂ corresponding to the basic noise standard deviation σty. The second standard deviation correction value f₂ used for the radiographic image Gy is referred to as a “second standard deviation correction value f_{2y}.”

The third step of Step S6 in Example 3 will be described. The correction arithmetic unit 45 calculates the noise standard deviation σ appropriate for the NLM filter processing for the radiographic image G by correcting the basic noise standard deviation σt using the second standard deviation correction value f₂. In Example 3, the noise deviation model P is a function corresponding to the multiplication of the basic noise deviation model Pa expressed by Formula (1) and the correction noise deviation model Pc expressed by Formula (4). In other words, the appropriate noise standard deviation σ for the radiographic image G can be acquired by the following Formula (5) using the basic noise standard deviation σt and the second standard deviation correction value f₂.

σ=σₜ*f₂ (5)

In other words, in Example 3, as the noise standard deviation σ in the NLM filter processing performed in Step S7, the value obtained by multiplying the basic noise standard deviation σt by the second standard deviation correction value f₂ is used. The correction arithmetic unit 45 calculates the product of the basic noise standard deviation σty corresponding to the radiographic image Gy and the second standard deviation correction value f_{2y} as the value of the noise standard deviation σ (noise standard deviation σy) suitable for the radiographic image Gy. The information on the noise standard deviation σy calculated as the information on the noise standard deviation σ suitable for the radiographic image Gy is transmitted from the standard deviation calculation unit 31A to the noise reduction processing unit 33.

### Step S7 (Noise Reduction Processing)

When the information on the noise standard deviation σ suitable for the radiographic image G of the subject M is transmitted to the noise reduction processing unit 33, the noise reduction processing unit 33 performs the NLM filter processing using the information on the noise standard deviation σ (here, the noise standard deviation σy) calculated by the standard deviation calculation unit 31A and the three parameters set by the user. By performing NLM filter processing by the noise reduction processing unit 33, a noise-reduced image Hy is generated from the radiographic image Gy. With the above-described steps, a series of PET imaging under the imaging condition Qy and the reconstruction condition Ry is completed. Hereafter, in a case where it is necessary to perform diagnosis under different imaging conditions or reconstruction conditions, the processes from Step S3 to Step S7 are repeated as necessary to complete the PET imaging of the subject M.

### Example 4

Next, Example 4 of the present invention will be described. The configuration of the PET apparatus 1 according to Example 4 is basically the same as that of Example 2 shown in FIG. 8. However, the operation of each configuration in Example 4 differs from that of Example 2 mainly in the following points.

First, in Example 2, the iteration number i is used as the predetermined parameter in the reconstruction processing, while in Example 4, the relaxation parameter r is used as the predetermined parameter in the reconstruction processing. Second, the correction model estimation unit 37 of Example 4 estimates a correction noise deviation model Pd as a calculation model for the standard deviation correction value f. Unlike the correction noise deviation model Pb used in Example 2, the correction noise deviation model Pd used in Example 4 is a function in which the relaxation parameter r and the standard deviation correction value f correspond to each other. Note that the standard deviation correction value f in Example 4 is referred to as the “third standard deviation correction value f₃.”

Third, the reconstruction value calculation unit 39 calculates the relaxation parameter d for the radiographic image G of the subject M. Fourth, the standard deviation calculation unit 31A calculates the value of the noise standard deviation σ suitable for the NLM filter processing for the radiographic image G of the subject M by using the count number N, the basic noise deviation model Pa, the relaxation parameter d, and the correction noise deviation model Pd.

### Description of Operation of Example 4

Here, the operation of the PET apparatus 1 according to Example 4 will be described. The operation of Example 3 is basically the same as the flowchart of Example 2 shown in FIG. 9. In other words, in Example 3, unlike Example 1, the processes in Steps SA and SB are performed.

### Step S1 (Acquisition of Model Estimation Image)

As a preliminary stage of acquiring PET images of the subject M, a model estimation image group L is initially acquired. In Example 4, in addition to the PET images La to Lf shown in FIG. 4, the PET images L11 to L15 are used as the model estimation image group L. The PET images La to Lf are radiographic images used for estimating the basic noise deviation model Pa, as in Example 1. Further, the PET images La to Lf are an image group consisting of a plurality of PET images generated under different imaging conditions.

The PET images L11 to L15 are radiographic images used for estimating the correction noise deviation model Pd. For each of the PET images L11 to L15, the relaxation parameter d and the value of the noise standard deviation σ corresponding to each image have been calculated in advance. As an example, “r11” has been calculated in advance for the PET image L11 as the relaxation parameter r, and “σ11” has been calculated in advance as a noise standard deviation value appropriate for NLM filter processing for the PET image L11. Similarly, for each of the PET images L12 to L15, the relaxation parameters r12 to r15 and the noise standard deviations σ12 to σ15 have been calculated in advance.

The PET images L11 to L15 differ from the PET images La to Lf and are generated under the same imaging condition Qr. However, the PET images L11 to L15 are different in the relaxation parameter in the reconstruction processing. That is, the relaxation parameters r11 to r15 used in the process of reconstructing the PET images L11 to L15 are different values.

Further, as the predefined constants, the reference relaxation parameter r_{base} is determined, and the standard standard standard deviation σs is also determined. The reference standard deviation σs is a value of the noise standard deviation σ suitable for the NLM filter processing for the PET images generated under the imaging condition Qr and the reference relaxation parameter r_{base}. As an example, the relaxation parameter r13 in the PET image L13 may be defined as the reference relaxation parameter r_{base}, and the noise standard deviation σ13 in the PET image L13 may be defined as the reference standard deviation σs.

### Step S2 (Acquisition of Basic Noise Deviation Model)

After acquiring the data of the model estimation image group L, the basic model estimation unit 35 acquires the basic noise deviation model Pa as in Example 2. That is, the basic model estimation unit 35 generates a scatter diagram V as shown in FIG. 5. And, the basic model estimation unit 35 estimates the basic noise deviation model Pa using the scatter diagram V. In other words, for the function satisfying the above-described Formula (1), by estimating the values of the first count model coefficient a1, the second count model coefficient a2, and the third count model coefficient a3 conforming to each of the coordinates Wa to Wf, a function Ep with the count number N as a variable can be identified as the basic noise deviation model Pa. The basic noise deviation model Pa is transmitted to the storage unit 23 for storage.

### Step SA (Acquisition of Correction Noise Deviation Model)

In Example 4, after acquiring the basic noise deviation model Pa, a correction noise deviation model Pd is further acquired by the correction model estimation unit 37. In Example 4, the method for acquiring the correction noise deviation model Pd will be described below.

The correction model estimation unit 37 initially reads out the data of the relaxation parameters r11 to r15 and the data of the noise standard deviation σ11 to σ15 from the storage unit 23. Next, the correction model estimation unit 37 calculates the relaxation parameter ratio for each of the PET images L11 to L15, which are model estimation images, using the relaxation parameters r11 to r15 and the reference relaxation parameter r_{base}. The relaxation parameter ratio is calculated as a value of “log₂(r/r_{base}).” As an example, the relaxation parameter ratio of the PET image L11 is “log₂(r11/r_{base}).”

Furthermore, the correction model estimation unit 37 calculates the standard deviation ratio for each of the PET images L11 to L15 using the values of the noise standard deviation σ11 to σ15 and the reference standard deviation σs. The standard deviation ratio is calculated as the value of “σ/σs.” Here, the value of the noise standard deviation corresponding to the PET image to be calculated is substituted into the term of σ. As an example, the standard deviation ratio of the PET image L12 is “σ12/σs.”

Next, the correction model estimation unit 37 generates a scatter diagram VC, using the data for the relaxation parameter ratios and the data for the standard deviation ratio. The scatter diagram VC is a two-dimensional plot diagram in which the value of “log₂(r/r_{base}),” which is the relaxation parameter ratio, corresponds to the x-axis, and the value of “σ/σs,” which is the standard deviation ratio, corresponds to the y-axis. The configuration of the scatter diagram VC is similar in configuration to the scatter diagram VA shown in FIG. 11, so the scatter diagram VC is not shown in FIG. 11.

In the scatter diagram VC, the coordinates W11 to W15 of the relaxation parameter ratios and the standard deviation ratios, corresponding to each of the PET images L11 to L15, are plotted. As a specific example, as the coordinate corresponding to the PET image L11, the coordinate W11 in which “log₂(r11/r_{base}),” which is the relaxation parameter ratio corresponding to the PET image L11, is an x-component and “σ11/σs,” which is the standard deviation ratio corresponding to the PET image L11, is a y-component, is plotted on the scatter diagram VC.

When the scatter diagram VC with the coordinates W11 to W15 plotted is generated, the correction model estimation unit 37 estimates the correction noise deviation model Pd using the scatter diagram VC. In Example 4, the correction noise deviation model Pd is a function in which the relaxation parameter r and the third standard deviation correction value f₃ correspond to each other and a function satisfying the following Formula (6).

$${f}_{3} = {d}_{1} * {log}_{2} ( \frac{r}{{r}^{base}} ) + {d}_{2} \qquad ( 6 )$$

In Formula (6) described above, “d1” refers to a first relaxation parameter model coefficient, and “d2” refers to a second relaxation parameter model coefficient. The correction model estimation unit 37 estimates the correction noise deviation model Pd by estimating appropriate values as the first relaxation parameter model coefficients d1 and the second relaxation parameter model coefficient d2. The correction noise deviation model Pd corresponds to the third correction function in this embodiment.

Note that the third standard deviation correction value f₃ is a numerical value calculated using the relaxation parameter r among the standard deviation correction values f that correct the basic noise standard deviation σt and corresponds to the standard deviation ratio σ/σs. In other words, in the case of acquiring PET images, even if the imaging conditions are the same, if the relaxation parameters in the reconstruction conditions differ, the value of the noise standard deviation appropriate for the PET image will change. For this reason, when the relaxation parameter in the reconstruction processing of a PET image changes, it is necessary to correct the basic noise standard deviation σt according to the amount of change in the relaxation parameter.

A specific example of the method for model estimation of the correction noise deviation model Pd is as follows. First, an approximate curve conforming to each of the coordinates W11 to W15 is calculated. The approximate curve is expressed as a function with the relaxation parameter ratio as the variable x. In this function, the value of “y” corresponding to the standard deviation ratio, i.e., the third standard deviation correction value f₃, is obtained with the relaxation parameter ratio as the variable x.

The correction model estimation unit 37 acquires the correction noise deviation model Pd by estimating appropriate values as the first relaxation parameter model coefficient d1 and the second relaxation parameter model coefficient d2, based on a function representing an approximate curve conforming to each of the coordinates W11 to W15.

The correction noise deviation model Pd is a model indicating the relation between the relaxation parameter r and the third standard deviation correction value f₃ calculated using the PET images L11 to L15, which are different from each other in the relaxation parameters. That is, by using the relation between the relaxation parameter ratios different from each other and the standard deviation ratio appropriate for each of the relaxation parameter ratios, a correction noise deviation model Pd in which the relation between the relaxation parameter ratios and the third standard deviation correction value f₃ is modeled is calculated. In the relaxation parameter ratio “log₂(r/r_{base}),” the reference relaxation parameter r_{base} is constant. Therefore, by substituting any relaxation parameter r into the correction noise standard deviation model Pd, the third standard deviation correction value f₃ corresponding to the substituted relaxation parameter r can be calculated quickly and accurately. The correction noise deviation model Pd estimated by the correction model estimation unit 37 is stored in the storage unit 23.

### Step S3 (Imaging of Subject)

After acquiring the basic noise deviation model Pa and the correction noise deviation model Pd, the PET imaging of the subject M is performed using the PET apparatus 1. The process of Step S3 in Example 3 is the same as that in Example 1, so the detailed description will be omitted. Note that the capturing condition in the first PET imaging is set to Qy. The coincidence data collected by the data acquisition unit 13 is transmitted to the reconstruction processing unit 27 provided by the image processing apparatus 15.

### Step S4 (Reconstruction Processing)

When the coincidence data collected by the data acquisition unit 13 is transmitted to the image processing apparatus 15A, the reconstruction processing in Step S4 is initiated. The process of Step S4 in Example 3 is also the same as in Example 1. In other words, the reconstruction processing unit 27 performs reconstruction processing on the coincidence data to generate a radiographic image Gy. Note that the condition in the reconstruction condition in the reconstruction processing of the radiographic image Gy is set to the reconstruction condition Ry. The value of the relaxation parameter r used in the reconstruction condition Ry is set to a relaxation parameter ry. The radiographic image G of the subject M generated by the reconstruction processing is transmitted from the reconstruction processing unit 27 to the count number calculation unit 29 and the reconstruction value calculation unit 39.

### Step S5 (Calculation of Count Number)

When the reconstructed radiographic image G is transmitted to the count number calculation unit 29, the count number is calculated for the radiographic image G obtained for the subject M. The process in Step S5 in Example 4 is also the same as that in Example 1. That is, the count number calculation unit 29 calculates the count number in the radiographic image G of the subject M. In other words, as shown in FIG. 13, the count number Ny is calculated for the radiographic image Gy. The information on the count number calculated by the count number calculation unit 29 for the radiographic image G is transmitted from the count number calculation unit 29 to the standard deviation calculation unit 31A.

### Step SB (Calculation of Reconstruction Parameter Value)

In parallel with the process in which the count number calculation unit 29 calculates the count number of the radiographic image G, the process of calculating the reconstruction parameter values in the radiographic image G is performed. In Example 4, the reconstruction parameter value corresponds to the relaxation parameter r. That is, the reconstruction value calculation unit 39 calculates the relaxation parameter r used in the reconstruction processing of the radiographic image G. Since the relaxation parameter ry is used as a parameter in the reconstruction processing of the radiographic image Gy, the reconstruction value calculation unit 39 calculates the data of the relaxation parameter ry and transmits it to the standard deviation calculation unit 31A.

### Step S6 (Calculation of Noise Standard Deviation)

The standard deviation calculation unit 31A calculates the value of the noise standard deviation σ appropriate for the NLM filter processing for the radiographic image G, using the information, etc., on the count number calculation unit 29. First, the standard deviation calculation unit 31A reads out the basic noise deviation model Pa and the correction noise deviation model Pd stored in the storage unit 23. As in Example 2, Step S6 in Example 3 is divided into three major steps.

The first step in Step S6 according to Example 4 will be described. The basic noise standard deviation calculation unit 41 receives the information on the basic noise deviation model Pa and the information on the count number of the radiographic image G. Then, the basic noise standard deviation calculation unit 41 calculates the basic noise standard deviation σt corresponding to the radiographic image G of the subject M by substituting the count number obtained for the radiographic image G of the subject M into the basic noise deviation model Pa. Specifically, the value of the basic noise standard deviation σty is calculated as the value of the basic noise standard deviation σt of the radiographic image Gy by substituting the value of the count number Ny calculated for the radiographic image Gy into the term of the count number N, which is a valve in Formula (1).

The second step of Step S6 in Example 4 will be described. The correction value calculation unit 43 receives the information of the correction noise deviation model Pd and the information on the relaxation parameter r of the radiographic image G. And, the correction value calculation unit 43 calculates the standard deviation correction value f corresponding to the radiographic image G of the subject M by substituting the relaxation parameter r acquired for the radiographic image G of the subject M into the correction noise deviation model Pd. In Example 4, the third standard deviation correction value f₃ is calculated as the standard deviation correction value f.

Specifically, the value of the relaxation parameter ry calculated for the radiographic image Gy is substituted into the term of the relaxation parameter r, which is a variable, in the function of the correction noise deviation model Pd shown in Formula (6). In the function of the correction noise deviation model Pd, the first relaxation parameter model coefficient d1 and the second relaxation parameter model coefficient d2 are both constants estimated by the correction model estimation unit 37. Therefore, by substituting the value of the relaxation parameter ry identified by the reconstruction value calculation unit 39 into the correction noise deviation model Pd shown in Formula (6), a value appropriate as the third standard deviation correction value f₃ corresponding to the basic noise standard deviation σty is identified. The third standard deviation correction value f₃ used for the radiographic image Gy is set to a “third standard deviation correction value f_{3y}.”

The third step of Step S6 in Example 4 will be described. The correction arithmetic unit 45 calculates the appropriate noise standard deviation σ appropriate for the NLM filter processing for the radiographic image G by correcting the basic noise standard deviation σt using the third standard deviation correction value f₃. In Example 4, the noise deviation model P is a function corresponding to the product of the basic noise deviation model Pa shown in Formula (1) and the correction noise deviation model Pd shown in Formula (6). In other words, the noise standard deviation σ appropriate for the radiographic image G can be acquired by the following Formula (7) using the basic noise standard deviation σt and the third standard deviation correction value f₃.

σ=σₜ*f₃ (7)

In other words, in Example 4, the value obtained by multiplying the basic noise standard deviation σt by the third standard deviation correction value f₃ is used as the noise standard deviation σ in the NLM filter processing performed in Step S7. The correction arithmetic unit 45 calculates the product of the basic noise standard deviation σty corresponding to the radiographic image Gy and the third standard deviation correction value f_{3y} as the value of the noise standard deviation σ (noise standard deviation σy) suitable for the radiographic image Gy. The information on the noise standard deviation σy calculated as the information on the noise standard deviation σ suitable for the radiographic image Gy is transmitted from the standard deviation calculation unit 31A to the noise reduction processing unit 33.

### Step S7 (Noise Reduction Processing)

When the information on the noise standard deviation σ suitable for the radiographic image G of the subject M is transmitted to the noise reduction processing unit 33, the noise reduction processing unit 33 performs the NLM filter processing using the information on the noise standard deviation σ (here, the noise standard deviation σy) calculated by the standard deviation calculation unit 31A and the three parameters set by the user. The noise reduction processing is performed by the NLM filter processing unit 33 to generate the noise-reduced image Hy from the radiographic image Gy. With the above-process, a series of imaging under the imaging condition Qy and the reconstruction condition Ry is completed. Hereafter, in a case where a diagnosis under different imaging or reconstruction conditions is required, the processes from Step S3 to Step S7 are repeated as necessary, and the PET imaging of the subject M is completed.

### Example 5

Next, Example 5 of the present invention will be described. The configuration of the PET apparatus 1 according to Example 5 is basically the same as that in Example 2 shown in FIG. 8. However, the operation of each configuration in Example 5 differs from that in Example 2 mainly in the following points.

First, in Example 2, the iteration number i is used as a predetermined parameter in the reconstruction processing, while in Example 5, the voxel size v is used as a predetermined parameter in the reconstruction processing. Second, the correction model estimation unit 37 in Example 4 estimates a correction noise deviation model Pe as a calculation model for the standard deviation correction value f. Unlike the correction noise deviation model Pb used in Example 2, the correction noise deviation model Pe used in Example 5 is a function in which the voxel size v and the standard deviation correction value f correspond to each other. Note that the standard deviation correction value fin Example 5 is referred to as a “fourth standard deviation correction value f₄.”

Third, the reconstruction value calculation unit 39 calculates the voxel size v for the radiographic image G of the subject M. Fourth, the standard deviation calculation unit 31A calculates the value of the noise standard deviation σ suitable for the NLM filter processing for the radiographic image G of the subject M by using the count number N, the basic noise deviation model Pa, the voxel size v, and the correction noise deviation model Pe.

### Description of Operation in Example 5

Here, the description of the operation of the PET apparatus 1 according to Example 5 will be described. The operation in Example 5 is basically the same as the flowchart of Example 2 shown in FIG. 9. In that is, in Example 5, unlike Example 1, the processes of Step SA and Step SB are performed.

### Step S1 (Acquisition of Model Estimation Image)

As a preliminary step to acquire the PET images of the subject M, the model estimation image group L is initially acquired. In Example 5, as the model estimation image group L, the PET images L16 to L20 are used in addition to the PET images La to Lf shown in FIG. 4. The PET images La to Lf are an image group consisting of a plurality of PET images generated under different imaging conditions, as in Example 1.

The PET images L16 to L20 are radiographic images used for estimating the correction noise deviation model Pe. For each of the PET images L16 to L20, the voxel size v corresponding to each image and the value of the noise standard deviation σ have been calculated in advance. As an example, v16 has been calculated in advance for the PET image L16 as the voxel size v, and σ16 has been calculated in advance as a value of the noise standard deviation appropriate for the NLM filter processing for the PET image L16. In the same manner, voxel sizes v17 to v20 and noise standard deviations σ17 to σ20 have been calculated in advance for each of the PET images L17 to L20.

The PET images L16 to L20 are different from the PET images La to Lf and generated under the same imaging condition Qv. However, the PET images L16 to L20 are different in the parameter value of the voxel size in the reconstruction processing. That is, the parametric values of the voxel sizes v16 to v20 used in the reconstruction processing of the PET images L16 to L20 are different values.

Further, as the predetermined constant, the reference voxel size v_{base} is determined, and the reference standard deviation σs is also determined. The reference standard deviation σs is a value of the noise standard deviation σ suitable for NLM filter processing for the PET images generated under the imaging conditions Qv and the reference voxel size v_{base}. As an example, the voxel size v18 in the PET image L18 may be defined as the reference voxel size v_{base}, and the noise standard deviation σ18 in the PET image L18 may be defined as the reference standard deviation σs.

### Step S2 (Acquisition of Basic Noise Deviation Model)

After acquiring the data of the model estimation image group L, the basic model estimation unit 35 acquires the basic noise deviation model Pa in the same manner as in Example 2. That is, the basic model estimation unit 35 generates a scatter diagram V as shown in FIG. 5. And the basic model estimation unit 35 estimates the basic noise deviation model Pa using the scatter diagram V. In other words, for a function satisfying the above-described Formula (1), by estimating the values of the first count model coefficient a1, the second count model coefficient a2, and the third count model coefficient a3 conforming to each of the coordinates Wa to Wf, the function Ep with the count number N as a variable can be identified as the basic noise deviation model Pa. The basic noise deviation model Pa is transmitted to the storage unit 23 for storage.

### Step SA (Acquisition of Correction Noise Deviation Model)

In Example 5, after acquiring the basic noise deviation model Pa, a correction noise deviation model Pe is further acquired by the correction model estimation unit 37. The method of acquiring the correction noise deviation model Pe in Example 5 will be described below.

The correction model estimation unit 37 initially reads out the data of the voxel sizes v16 to v20 and the data of the noise standard deviations σ16 to σ20 from the storage unit 23. Next, the correction model estimation unit 37 calculates the voxel size ratio for each of the PET images L16 to L20, which are model estimation images, using the voxel sizes v16 to v20 and the reference voxel size v_{base}. The voxel size ratio is calculated as the value of “v/v_{base}.” As an example, the voxel size ratio of the PET image L16 is “v16/v_{base}.”

Furthermore, the correction model estimation unit 37 calculates the standard deviation ratio for each of the PET images L16 to L20 using the values of the noise standard deviation σ16 to σ20 and the reference standard deviation σs. The standard deviation ratio is calculated as the value of “σ/σs.” Here, the value of the noise standard deviation corresponding to the PET image to be calculated is substituted into the term of σ. As an example, the standard deviation ratio of the PET image L17 is “σ17/σs.”

Next, the correction model estimation unit 37 generates a scatter diagram VD using the data of the voxel size ratio and the data of the standard deviation ratio. The scatter diagram VD is a two-dimensional plot diagram in which the value of “v/v_{base},” which is the voxel size ratio, corresponds to the x-axis, and the value of “σ/σs,” which is the standard deviation ratio, corresponds to the y-axis. Since the configuration of the scatter diagram VD is similar to the configuration of the scatter diagram VA shown in FIG. 11, the illustration of the scatter diagram VD is omitted.

In the scatter diagram VD, the coordinates W16 to W20 of the voxel size ratio and the standard deviation ratio corresponding to each of the PET images 116 to 120 are plotted. As a specific example, the coordinate W16 is plotted on the scatter diagram VD as the coordinate corresponding to the PET image L16. The coordinate W16 has the voxel size ratio “v16/v_{base}” corresponding to the PET image L16 as the x-component and the standard deviation ratio “σ16/σs” corresponding to the PET image L16 as the y-component. In the same manner, the coordinates W17 to W20 are plotted in the scatter diagram VD as the coordinates corresponding to the PET images L17 to L20.

When the scatter diagram VD with coordinates W16 to W20 plotted is generated, the correction model estimation unit 37 estimates the correction noise deviation model Pe using the scatter diagram VD. In Example 5, the correction noise deviation model Pe is a function in which the voxel size v and the fourth standard deviation correction value f₄ correspond to each other and is a function satisfying the following Formula (8).

$${f}_{4} = {e}_{1} * {( \frac{v}{{v}^{b a s e}} )}^{e 2} + e 3 \qquad ( 8 )$$

In Formula (8) described above, “e1” is the first voxel size model coefficient, “e2” is the second voxel size model coefficient, and “e3” is the third voxel size model coefficient. The correction model estimation unit 37 estimates the correction noise deviation model Pe by estimating values appropriate as the first voxel size model coefficient e₁, the second voxel size model coefficient e₂, and the third voxel size model coefficient e₃. The correction noise deviation model Pe corresponds to the fourth correction function in this embodiment.

Note that the fourth standard deviation correction value f₄ is a numerical value calculated using the voxel size v among the standard deviation correction values f for correcting the basic noise standard deviation σt. That is, in the case of acquiring PET images, even if the imaging conditions are the same, if the voxel size parameter values in the reconstruction conditions differ, the value of the noise standard deviation appropriate for the PET image changes. For this reason, when the parameter value of the voxel size v in the reconstruction processing of the PET image changes, it is necessary to correct the basic noise standard deviation σt according to the change amount of the voxel size v.

The specific example of the method for estimating the correction noise deviation model Pe is as follows. First, an approximate curve conforming to each of the coordinates W16 to W20 is calculated. The approximate curve is expressed as a function in which the voxel size ratio is the variable x. In this function, the voxel size ratio is used as the variable x, and the y value corresponding to the standard deviation ratio, i.e., the fourth standard deviation correction value f₄, is obtained.

The correction model estimation unit 37 acquires the correction noise deviation model Pe by estimating appropriate values as the first voxel size model coefficient e₁, the second voxel size model coefficient e₂, and the third voxel size model coefficient e₃, based on a function representing an approximation curve conforming to each of the coordinates W16 to W20.

The correction noise deviation model Pe is a model indicating the relation between the voxel size v and the fourth standard deviation correction value f₄, which is calculated using the PET images L16 to L20 each different in the voxel size v value. In other words, by using the relation between the voxel size ratio different from each other and the standard deviation ratio appropriate for each of the voxel size ratios, a correction noise deviation model Pe in which the relation between the voxel size ratio and the fourth standard standard deviation correction value f₄ is modeled is calculated. In “v/v_{base},” which is a voxel size ratio, the reference voxel size v_{base} is a constant.

For this reason, by substituting the value of any voxel size v into the correction noise deviation model Pe, the fourth standard deviation correction value f₄ corresponding to the substituted voxel size v can be calculated quickly and precisely. The correction noise deviation model Pe estimated by the correction model estimation unit 37 is stored in the storage unit 23.

### Step S3 (Imaging of Subject)

After acquiring the basic noise deviation model Pa and the correction noise deviation model Pe, the PET apparatus 1 performs PET imaging of the subject M using the PET apparatus 1. The process of Step S3 in Example 3 is the same as that in Example 1, so the detailed description will be omitted. Note that the imaging condition for the first PET imaging is Qy. The coincidence data collected by the data acquisition unit 13 is transmitted to the reconstruction processing unit 27 provided on the image processing apparatus 15.

### Step S4 (Reconstruction Processing)

When the coincidence data collected by the data acquisition unit 13 is transmitted to the image processing apparatus 15A, the reconstruction processing in step S4 is initiated. The process of Step S4 in Example 5 is also the same as in Example 1. That is, the reconstruction processing unit 27 generates a radiographic image G by performing reconstruction processing on the coincidence data. Note that the condition in the reconstruction processing of the radiographic image Gy is referred to as the reconstruction condition Ry. The voxel size vy is then referred to as the value of the voxel size v used in the reconstruction condition Ry. The radiographic image G of the subject M generated by the reconstruction processing is transmitted from the reconstruction processing unit 27 to the count number calculation unit 29 and the reconstruction value calculation unit 39.

### Step S5 (Calculation of Count Number)

When the reconstructed radiographic image G is transmitted to the count number calculation unit 29, the count number is calculated for the radiographic image G acquired for the subject M. The process of Step S5 in Example 3 is also the same as in Example 1. That is, the count number calculation unit 29 calculates the count number in the radiographic image G of the subject M. That is, as shown in FIG. 13, the count number Ny is calculated for the radiographic image Gy. The information on the count number calculated by the count number calculation unit 29 for the radiographic image G is transmitted from the count number calculation unit 29 to the standard deviation calculation unit 31A.

### Step SB (Calculation of Reconstruction Parameter Values)

In parallel to the process in which the count number calculation unit 29 calculates the count number of the radiographic image G, the process of calculating the reconstruction parameter values in the radiographic image G is performed. In Example 4, the reconstruction parameter value corresponds to the voxel size v. That is, the reconstruction value calculation unit 39 calculates the parameter value of the voxel size v used in the reconstruction processing of the radiographic image G. Since the voxel size vy is used as a parameter in the reconstruction processing of the radiographic image Gy, the reconstruction value calculation unit 39 calculates the data of the voxel size vy and transmits it to the standard deviation calculation unit 31A.

### Step S6 (Calculation of Noise Standard Deviation)

The standard deviation calculation unit 31A calculates the value of the noise standard deviation σ appropriate for the NLM filter processing for the radiographic image G using the information, etc., on the count number calculation unit 29. First, the standard deviation calculation unit 31A reads out the basic noise deviation model Pa and the correction noise deviation model Pe stored in the storage unit 23. In the same manner as in Example 2, Step S6 for Example 5 is divided into three major steps.

The first step of Step S6 in Example 5 will be described. The basic noise standard deviation calculation unit 41 receives the information on the basic noise deviation model Pa and the information on the count number of the radiographic image G. The basic noise standard deviation calculation unit 41 then calculates the basic noise standard deviation σt corresponding to the radiographic image G of the subject M, by substituting the count number acquired for the radiographic image G of the subject M for the basic noise deviation model Pa. Specifically, the value of the basic noise standard deviation σty is calculated as the value of the basic noise standard deviation σt of the radiographic image Gy by substituting the value of the count number Ny calculated for the radiographic image Gy into the term of the count number N, which is a variable in Formula (1).

The second step of Step S6 in Example 5 will be described. The correction value calculation unit 43 receives the information on the correction noise deviation model Pe and the information on the voxel size v in the radiographic image G. The correction value calculation unit 43 then calculates the standard deviation correction value f corresponding to the radiographic image G of the subject M by substituting the voxel size v acquired for the radiographic image G into the correction noise deviation model Pe. In Example 5, a fourth standard deviation correction value f₄ is calculated as the standard deviation correction value f for correcting the basic noise standard deviation σt.

Specifically, the value of the voxel size vy calculated for the radiographic image Gy is substituted into the term of the voxel size v, which is a variable, in the function of the correction noise deviation model Pe shown in Formula (8). In the function of the correction noise deviation model Pe, the first voxel size model coefficient e₁, the second voxel size model coefficient e₂, and the third voxel size model coefficient e₃ are all constants estimated by the correction model estimation unit 37. For this reason, by substituting the value of the voxel size vy identified by the reconstruction value calculation unit 39 into the correction noise deviation model Pe shown in Formula (8), an appropriate value as the fourth standard deviation correction value f₄, corresponding to the basic noise standard deviation σty, is identified. The fourth standard deviation correction value f₄ used for the radiographic image Gy is referred to as a “fourth standard deviation correction value f_{4y}.”

The third step of Step S6 in Example 5 will be described. The correction arithmetic unit 45 calculates the noise standard deviation σ appropriate for the NLM filter processing for the radiographic image G by correcting the basic noise standard deviation σt using the fourth standard deviation correction value f₄. In Example 5, the noise deviation model P is a function corresponding to the product of the basic noise deviation model Pa shown in Formula (1) and the correction noise deviation model Pe shown in Formula (6). That is, the noise standard deviation σ appropriate for the radiographic image G can be obtained by the following Formula (9), using the basic noise standard deviation σt and the fourth standard deviation correction value f₄.

σ=σₜ*f₄ (9)

That is, in Example 5, the value obtained by multiplying the basic noise standard deviation σt by the fourth standard deviation correction value f₄ is used as the noise standard deviation σ in the NLM filter processing performed in Step S7. The correction arithmetic unit 45 calculates the product of the basic noise standard deviation σty corresponding to the radiographic image Gy and the fourth standard deviation correction value f4y as the value of the noise standard deviation σ (noise standard deviation σy) suitable for the radiographic image Gy. The information on the noise standard deviation σy calculated as the information on the noise standard deviation σ suitable for the radiographic image Gy is transmitted from the standard deviation calculation unit 31A to the noise reduction processing unit 33.

### Step S7 (Noise Reduction Processing)

When the information on the noise standard deviation σ suitable for the radiographic image G of the subject M is transmitted to the noise reduction processing unit 33, the noise reduction processing unit 33 performs the NLM filter processing using the information on the noise standard deviation σ (here, the noise standard deviation σy) calculated by the standard deviation calculation unit 31A and the three parameters set by the user. The noise-reduced image Hy is generated from the radiographic image Gy by performing the NLM filter processing by the noise reduction processing unit 33. With the above-described process, a series of PET imaging under the imaging condition Qy and the reconstruction condition Ry is completed. Hereafter, in a case where diagnosis under different imaging or configuration conditions is required, the processes from Step S3 to Step S7 are repeated as appropriate, and the PET imaging of the subject M is completed.

### Example 6

Next, Example 6 of the present invention will be described. Example 6 has basically the characteristics of a combination of each of Examples 2 to 5. The configuration of the PET apparatus 1 in Example 6 is basically the same as that in Example 2 shown in FIG. 8. However, the operation of each configuration in Example 6 differs from that in Example 2 mainly in the following points.

First, in Example 2, only the iteration number i is used as a predetermined parameter in the reconstruction processing, while in Example 6, the iteration number i, the subset number s, the relaxation parameter r, and the voxel size v are used as predetermined parameters in the reconstruction processing.

Second, the model estimated by the correction model estimation unit 37 is different. The correction model estimation unit 37 according to Example 2 estimates only the correction noise deviation model Pb as the model for calculating the standard deviation correction value f. On the other hand, the correction model estimation unit 37 in Example 6 estimates the correction noise deviation models Pb to Pe as calculation models for the standard deviation correction value f. That is, the correction model estimation unit 37 according to Example 6 performs an operation in which each of Examples 2 to 5 are combined.

Third, the parameters calculated by the reconstruction value calculation unit 39 are different from each other. The reconstruction value calculation unit 39 in Example 2 calculates only the iteration number i for the radiographic image G of the subject M. On the other hand, the reconstruction value calculation unit 39 in Example 6 calculates the iteration number i, the subset number s, the relaxation parameter r, and the voxel size v for the radiographic image G of the subject M.

Fourth, the contents of the information used by the standard deviation calculation unit 31A to calculate the noise standard deviation σ are different. The standard deviation calculation unit 31A in Example 6 calculates a value of the noise standard deviation suitable for NLM filter processing for a radiographic image G of a subject M by using the count number N, the iteration number i, the subset number s, the relaxation parameter r, the voxel size v, the basic noise deviation model Pa, and the correction noise deviation models Pb to Pe.

### Description of Operation in Example 6

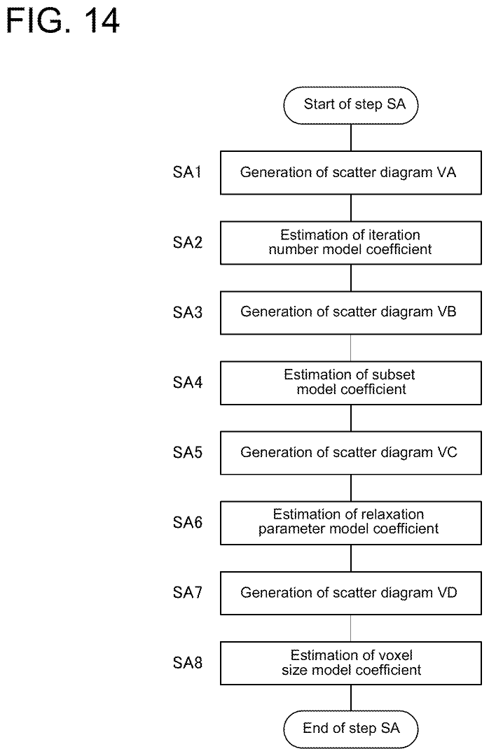

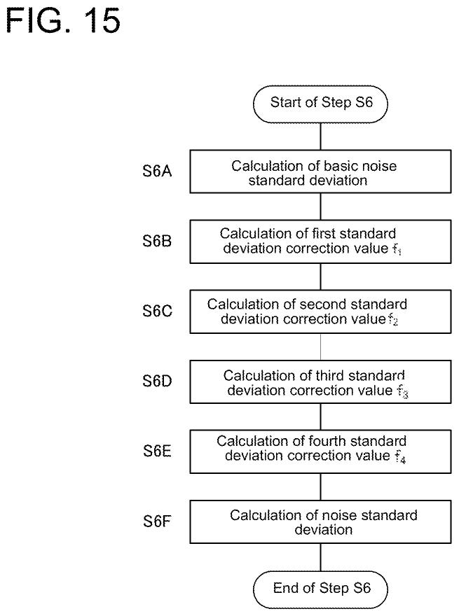

Here, the operation of the PET apparatus 1 in Example 6 will be described. The operation in Example 6 is basically the same as the flowchart of Example 2 shown in FIG. 9. That is, in Example 6, unlike Example 1, the processes in Steps SA and SB are performed. Note that FIG. 14 is a flowchart further describing the details of Step SA in Example 6. FIG. 15 is a flowchart further describing the details of Step S6 in Example 6.

### Step S1 (Acquisition of Model Estimation Image)

As the preliminary stage for acquiring PET images of the subject M, a model estimation image group L is initially acquired. As shown in FIG. 16, in Example 6, as the model estimation image group L, the PET images La to Lf, the PET images L1 to L5, the PET images L6 to L10, the PET images L11 to L15, and the PET images L16 to L20 are used.

The PET images La to Lf are model estimation images used for estimating the basic noise deviation model Pa. The PET images La to Lf used in Example 6 have the same characteristics as those of the PET images La to Lf used in Examples 1 to 5, so the detailed description will be omitted. That is, the PET images La to Lf each have different imaging conditions, and the count numbers Na to Nf and the noise standard deviations σa to σf have been calculated in advance for each image (see reference symbol J1 in FIG. 16).

Each of the PET images L1 to L5 is a model estimation image used for estimating the correction noise deviation model Pb. The PET images L1 to L5 used in Example 6 will be omitted from the detailed description since they have the same characteristics as those of the PET images L1 to L5 used in Example 2. That is, the PET images L1 to L5 each have different parameters for the iteration number in the reconstruction processing, and the iteration number i1 to i5 and the noise standard deviation σ1 to σ5 have been calculated in advance for each image (see reference symbol J2 in FIG. 16).

Each of the PET images L6 to L10 is a model estimation image used for estimating the correction noise deviation model Pc. The PET images L6 to L10 used in Example 6 will be described in detail since they have the same characteristics as those of PET images L6 to L10 used in Example 3. That is, the PET images L6 to L10 each have different parameters for the subset number in the reconstruction processing, and the subset number s6 to s10 and the noise standard deviation σ6 to σ10 have been calculated in advance for each image (see reference symbol J3 in FIG. 16).

Each of the PET images L11 to L15 is a model estimation image used for estimating the correction noise deviation model Pd. The PET images L11 to L15 used in Example 6 will be omitted from the detailed description since they have the same characteristics as those of the PET images L11 to L15 used in Example 4. That is, the PET images L11 to L15 each have different relaxation parameters in the reconstruction processing, and the relaxation parameters r11 to r15 and the noise standard deviations σ11 to σ15 have been calculated in advance for each image (see reference symbol J4 in FIG. 16).

Each of the PET images L16 to L20 is a model estimation image used for estimating the correction noise deviation model Pe. The PET images L16 to L20 used in Example 6 have the same features as those of the PET images L16 to L20 used in Example 5, and therefore, the detailed description thereof will be omitted. That is, the PET images L16 to L20 are each different in the parameter value of the voxel size in the reconstruction processing, and the voxel sizes v16 to v20 and the noise standard deviations σ16 to σ20 have been calculated in advance for each image (see reference symbol J5 in FIG. 16). The image data of the model estimation image group L is acquired in advance using the PET apparatus 1 or the like and stored in the storage unit 23.

### Step S2 (Acquisition of Basic Noise Deviation Model)

After acquiring the data of the model estimation image group L, the basic model estimation unit 35 acquires the basic noise deviation model Pa in the same manner as in Example 2. That is, unlike the basic model estimation unit 35 generates the scatter diagram V as shown in FIG. 5. The basic model estimation unit 35 then estimates the basic noise deviation model Pa using the scatter diagram V as shown in FIG. 16. That is, for a function satisfying the above-described Formula (1), by estimating the values of the first count model coefficient a₁, the second count model coefficient a₂, and the third count model coefficient a₃ conforming to each of the coordinates Wa to Wf, the function Ep with the count number N as a variable can be identified as the basic noise deviation model Pa. The basic noise deviation model Pa is transmitted to the storage unit 23 for storage.

### Step SA (Acquisition of Correction Noise Deviation Model)

In Example 6, after acquiring the basic noise deviation model Pa, the correction noise deviation models Pb to Pe are further acquired by the correction model estimation unit 37. Step SA in Example 6 will be described in detail using the flowchart shown in FIG. 14, dividing it into Steps SA1 to SA8.

### Step SA1 (Generation of Scatter Diagram VA)

When Step SA is initiated, the correction model estimation unit 37 generates the scatter diagram VA to be used for estimating the correction noise deviation model Pb. The process for generating the scatter diagram VA is the same as that in Example 2. That is, the correction model estimation unit 37 reads out the data of the iteration numbers i1 to i5 and the noise standard deviation σ1 to σ5 from the storage unit 23. Next, the correction model estimation unit 37 calculates the iteration number ratio “log₂(i/i_{base})” for each of the PET images L1 to L5 using the iteration number i1 to i5 data and the reference iteration number i_{base}. Further, the correction model estimation unit 37 calculates the standard deviation ratio “σ/σs” for each of the PET images L1 to L5 using the values of the noise standard deviations σ1 to σ5 and the reference standard deviation σs.

Next, the correction model estimation unit 37 generates a scatter diagram VA using the data of the iteration number ratio and the data of the standard deviation ratio. The scatter diagram VA has the characteristics already described in Example 2. That is, the scatter diagram VA is a two-dimensional plot diagram in which the value of “log₂(i/i_{base}),” which is the iteration number ratio, corresponds to the x-axis, and the value of “σ/σs,” which is the standard deviation ratio, corresponds to the y-axis, as shown in FIG. 11. In the scatter diagram VA, the coordinates W1 to W5 corresponding to the respective PET images L1 to L5 are plotted. The coordinates W1 to W5 are the coordinates in which the iteration number ratio is the x-component and the standard deviation ratio is the y-component. As an example, the coordinate W1 corresponding to the PET image L1 has the iteration number ratio “log₂(i1/i_{base})” as the x-component and the standard deviation ratio “σ1/σs” as the y-component.

### Step SA2 (Estimation of Iteration Number Model Coefficients)

When the scatter diagram VA in which the coordinates W1 to W5 are plotted is generated, the correction model estimation unit 37 estimates the iteration number model coefficients using the scatter diagram VA. In other words, the correction model estimation unit 37 estimates the correction noise deviation model Pb using the scatter diagram VA, as shown in FIG. 16. Note that in Example 6, in the same manner as in Example 2, the correction noise deviation model Pb is a function in which the iteration number i and the first standard deviation correction value f₁ correspond, and is expressed by Formula (2) as described above. In other words, the correction noise standard deviation model Pb is a function capable of calculating the first standard deviation correction value f₁ by specifying the value of the iteration number i.

The correction model estimation unit 37 calculates a function indicating an approximate curve conforming to each of the coordinates W1 to W5, and estimates appropriate values as the first iteration number model coefficients b1 and the second iteration number model coefficients b2 based on the function. By estimating the first iteration number model coefficients b1 and the second iteration number model coefficients b2, the specific configuration of the correction noise deviation model Pb is estimated. As described above, for the function satisfying the above-described Formula (2), the correction model estimation unit 37 estimates the values of the first iteration number model coefficient b1 and the second iteration number model coefficient b2 and acquires the correction noise deviation model Pb. The estimated correction noise deviation model Pb is transmitted to the storage unit 23 for storage. Note that the processes of Step SA1 and Step SA2 are common to the process of Step SA in Example 2.

### Step SA3 (Generation of Scatter Diagram VB)

The correction model estimation unit 37 further generates a scatter diagram VB to be used for estimating the correction noise deviation model Pc. The process of generating the scatter diagram VB is the same as that in Example 3. That is, the correction model estimation unit 37 reads out the data of the subset numbers s6 to s10 and the data of the noise standard deviations σ6 to σ10 from the storage unit 23. Next, the correction model estimation unit 37 calculates the subset number ratio “log₂(s/s_{base})” for each of the PET images L6 to L10 using the data of subset numbers s6 to s10 and the reference subset number s_{base}. Further, the correction model estimation unit 37 calculates the standard deviation ratio “σ/σs” for each of the PET images L6 to L10 using the noise standard deviation σ6 to σ10 and the standard standard deviation σs.

Next, the correction model estimation unit 37 generates a scatter diagram VB using the data of the subset number ratio and the data of the standard deviation ratio. The scatter diagram VB has the features already described in Example 3. That is, the scatter diagram VB is a two-dimensional plot diagram in which the value of “log₂(s/s_{base}),” which is the subset number ratio, corresponds to the x-axis, and the value of “σ/σs,” which is the standard deviation ratio, corresponds to the y-axis. In the scatter diagram VB, the coordinates W6 to W10 corresponding to the respective PET images L6 to L10 are plotted. The coordinates W6 to W10 are the coordinates in which the subset number ratio is the x-component and the standard deviation ratio is the y-component. As an example, the coordinate W6 corresponding to the PET image L6 has the subset number ratio “log₂(s6/s_{base})” as the x-component and the standard deviation ratio “σ6/σs” as the y-component.

### Step SA4 (Estimation of Subset Model Coefficient)

When the scatter diagram VB with the coordinates W6 to W10 plotted is generated, the correction model estimation unit 37 uses the scatter diagram VB to estimate the subset model coefficient. In other words, the correction model estimation unit 37 estimates the correction noise deviation model Pc using the scatter diagram VB, as shown in FIG. 16. Note that in Example 6, the correction noise deviation model Pc is a function in which the subset number s and the second standard deviation correction value f₂ correspond, in the same manner as in Example 3, and is expressed by Formula (4) described above. In other words, the correction noise deviation model Pc is a function capable of calculating the second standard deviation correction value f₂ by identifying the value of the subset number s.

The correction model estimation unit 37 calculates a function indicating an approximate curve conforming to each of the coordinates W6 to W10 and estimates appropriate values as the first subset model coefficients c₁ and the second subset model coefficients c₂ based on the function. By estimating the first subset model coefficients c₁ and the second subset model coefficients c₂, the specific configuration of the correction noise deviation model Pc is estimated. As described above, for the function satisfying the above-described Formula (4), the correction model estimation unit 37 estimates the first subset model coefficients c₁ and the second subset model coefficients c₂ suitable for each of the coordinates W6 to W10, and acquires the correction noise deviation model Pc. The estimated correction noise deviation model Pc is transmitted to the storage unit 23 for storage. Note that the processes in Steps SA3 and SA4 are common to the process in Step SA in Example 3.

### Step SA5 (Generation of Scatter Diagram VC)

The correction model estimation unit 37 further generates a scatter diagram VC used for estimating the correction noise deviation model Pd. The process for generating the scatter diagram VC is the same as that in Example 4. That is, the correction model estimation unit 37 reads out the data of the relaxation parameters r11 to r15 and the data of the noise standard deviation σ11 to σ15 from the storage unit 23. Next, the correction model estimation unit 37 calculates the relaxation parameter ratio “log₂(r/r_{base})” for each of the PET images L11 to L15 using the data of relaxation parameters r11 to r16 and the reference relaxation parameter r_{base}. Further, the correction model estimation unit 37 calculates the standard deviation ratio “σ/σs” for each of the PET images L11 to L15 using the noise standard deviations σ11 to σ15 and the reference standard deviation σs.

Next, the correction model estimation unit 37 generates a scatter diagram VC using the data of the relaxation parameter ratios and the data of the standard deviation ratios. The scatter diagram VC has the characteristics already described in Example 4. That is, the scatter diagram VC is a two-dimensional plot diagram in which the value of “log₂(r/r_{base}),” which is the relaxation parameter ratio, corresponds to the x-axis, and the value of “σ/σs,” which is the standard deviation ratio, corresponds to the y-axis. In the scatter diagram VC, the coordinates W11 to W15 are plotted for each of the PET images L11 to L16. The coordinates W11 to W15 are the coordinates in which the relaxation parameter ratio is the x-component and the standard deviation ratio is the y-component. As an example, the coordinate W11 corresponding to the PET image L11 has the relaxation parameter ratio “log₂(r11/r_{base})” as the x-component and the standard deviation ratio “σ11/σs” as the y-component.

### Step SA6 (Estimation of Relaxation Parameter Model Coefficients)

When the scatter diagram VC with the coordinates W11 to W15 plotted is generated, the correction model estimation unit 37 uses the scatter diagram VC to estimate the relaxation parameter model coefficients. In other words, the correction model estimation unit 37 uses the scatter diagram VC to estimate the correction noise deviation model Pd, as shown in FIG. 16. Note that in Example 6, the correction noise deviation model Pd is a function in which the relaxation parameter r and the third standard deviation correction value f₃ correspond, in the same manner as in Example 4, and is expressed by Formula (6) described above. In other words, the correction noise standard deviation model Pd is a function capable of calculating the third standard deviation correction value f₃ by specifying the value of the relaxation parameter r.

The correction model estimation unit 37 calculates a function indicating an approximate curve conforming to each of the coordinates W11 to W15 and estimates appropriate values as the first relaxation parameter model coefficient d1 and the second relaxation parameter model coefficient d2 based on the function. By estimating the first relaxation parameter model coefficient d1 and the second relaxation parameter model coefficient d2, the specific configuration of the correction noise deviation model Pd is estimated.

As described above, the correction model estimation unit 37 estimates the first relaxation parameter model coefficients d1 and the second relaxation parameter model coefficients d2 conforming to each of the coordinates W11 to W15 for the functions satisfying the above-described Formula (6), and acquires the correction noise deviation model Pd. The estimated correction noise deviation model Pd is transmitted to the storage unit 23 for storage. Note that the processes in steps SA5 and SA6 are common to the process in step SA in Example 4.

### Step SA7 (Generation of Scatter Diagram VD)

The correction model estimation unit 37 further generates a scatter diagram VD used for estimating the correction noise deviation model Pe. The process for generating the scatter diagram VD is the same as that in Example 5. That is, the correction model estimation unit 37 reads out the data of the voxel size v16 to v20 and the data of the noise standard deviation σ16 to σ20 from the storage unit 23. Next, the correction model estimation unit 37 uses the voxel size v16 to v20 data and the reference voxel size v_{base} to calculate the voxel size ratio “v/v_{base}” for each of the PET images L16 to L20. Further, the correction model estimation unit 37 uses the noise standard deviations σ16 to σ20 and the standard standard deviation σs to calculate the standard deviation ratio “σ/σs” for each of the PET images L11 to L15.

Next, the correction model estimation unit 37 generates a scatter diagram VD using the voxel size ratio data and the standard deviation ratio data. The scatter diagram VD has the characteristics already described in Example 5. That is, the scatter diagram VD is a two-dimensional plot diagram in which the value of “v/v_{base},” which is the voxel size ratio, corresponds to the x-axis, and the value of “σ/σs,” which is the standard deviation ratio, corresponds to the y-axis. In the scatter diagram VD, the coordinates W16 to W20 corresponding to each of the PET images L16 to L20 are plotted. The coordinates W16 to W20 are the coordinates in which the voxel size ratio is the x-component and the standard deviation ratio is the y-component. As an example, the coordinate W16 corresponding to the PET image L16 has the relaxation parameter ratio “v16/v_{base}” as the x-component and the standard deviation ratio “σ16/σs” as the y-component.

### Step SA8 (Estimation of Voxel Size Model Coefficient)

When the scatter diagram VD in which the coordinates W16 to W20 are plotted is generated, the correction model estimation unit 37 estimates the voxel size model coefficient using the scatter diagram VD. In other words, the correction model estimation unit 37 estimates the correction noise deviation model Pe using the scatter diagram VD, as shown in FIG. 16. Note that in Example 6, the correction noise deviation model Pe is, in the same manner as in Example 5, a function in which the voxel size v corresponds to the fourth standard deviation correction value f₄, and is expressed by Formula (8) described above. In other words, the correction noise standard deviation model Pe is a function capable of calculating the fourth standard deviation correction value f₄ by specifying the value of the voxel size v.

The correction model estimation unit 37 calculates a function indicating an approximate curve conforming to each of the coordinates W16 to W20, and estimates appropriate values as the first voxel size model coefficient e₁, the second voxel size model coefficient e₂, and the third voxel size model coefficient e₃ based on the function. By estimating the first voxel size model coefficient e₁, the second voxel size model coefficient e₂, and the third voxel size model coefficient e₃, the specific configuration of the correction noise deviation model Pe is estimated.

As described above, the correction model estimation unit 37 estimates the first voxel size model coefficients e₁, the second voxel size model coefficients e₂, and the third voxel size model coefficients e₃ conforming to each of the coordinates W16 to W20 for the functions satisfying Formula (8) described above, and acquires the correction noise deviation model Pe. The estimated correction noise deviation model Pe is transmitted to the storage unit 23 for storage. Note that the processes of Step SA7 and Step SA8 are common to the process of Step SA in Example 5.

When each of the correction noise deviation models Pb to Pe is acquired, Step SA according to Example 6 is completed. Note that in Step SA in Example 6, the order in which the steps of Step SA1 and Step SA2, the steps of Step SA3 and Step SA4, the steps of Step SA5 and Step SA6, and the steps of Step SA7 and Step SA8 are performed is not limited to this, and may be changed as needed.

### Step S3 (Imaging of Subject)

After acquiring the basic noise deviation model Pa and the correction noise deviation models Pb to Pe, PET imaging of the subject M is performed using the PET apparatus 1. The process of Step S3 in Example 6 is the same as that in Examples 1 to 5, so the detailed description will be omitted. Note that the imaging condition for the first PET imaging is set to Qy. The coincidence data collected by the data acquisition unit 13 is transmitted to the reconstruction processing unit 27 equipped with the image processing apparatus 15A.

### Step S4 (Reconstruction Processing)

When the coincidence data collected by the data acquisition unit 13 is transmitted to the image processing apparatus 15A, the reconstruction processing according to Step S4 is initiated. The process of Step S4 in Example 6 is also the same as that in Examples 1 to 5. That is, the reconstruction processing unit 27 performs reconstruction processing on the coincidence data to generate a radiographic image G.

Note that the reconstruction condition Ry is set as the condition in the reconstruction processing of the radiographic image Gy. Here, the value of the iteration number i used in the reconstruction condition Ry is set to the iteration number iy. The value of the subset number s used in the reconstruction condition Ry is set to the subset number sy. The relaxation parameter r used in the reconstruction condition Ry is set to the relaxation parameter ry. The value of the voxel size v used in the reconstruction condition Ry is set to the voxel size vy. The radiographic image G of the subject M generated by the reconstruction processing is transmitted from the reconstruction processing unit 27 to the count number calculation unit 29 and the reconstruction value calculation unit 39.

### Step S5 (Calculation of Count Number)

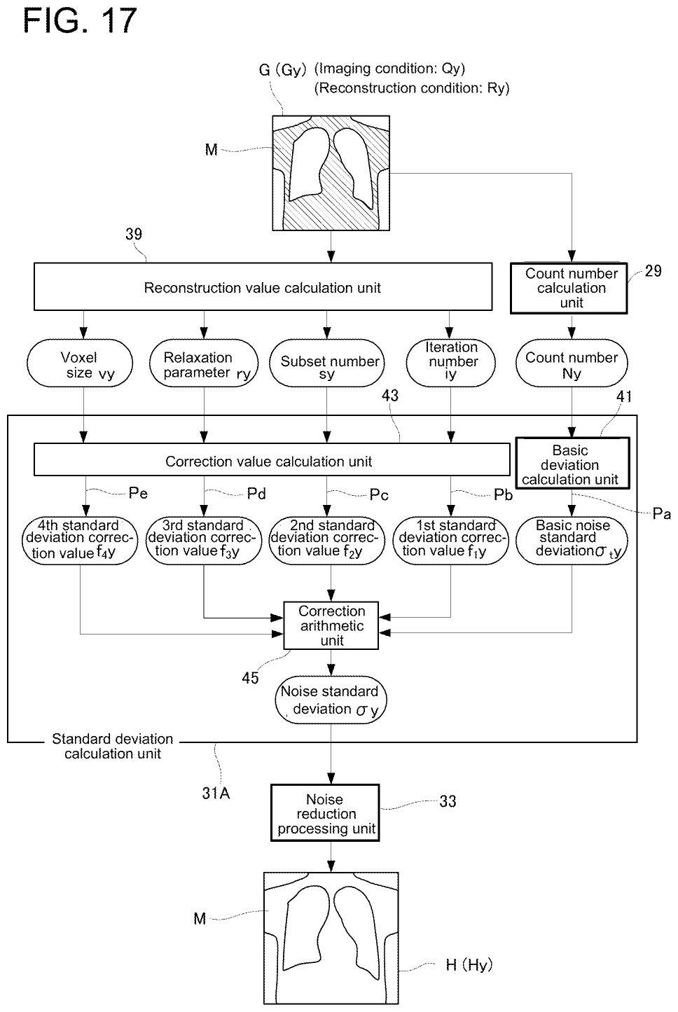

When the reconstructed radiographic image G is transmitted to the count number calculation unit 29, the count number is calculated for the radiographic image G acquired for the subject M. The process of Step S5 in Example 6 is also the same as that in Examples 1 to 5. That is, the count number calculation unit 29 calculates the count number in the radiographic image G of the subject M. That is, as shown in FIG. 17, the count number Ny is calculated for the radiographic image Gy. The information on the count number calculated by the count number calculation unit 29 for the radiographic image G is transmitted from the count number calculation unit 29 to the standard deviation calculation unit 31A.

### Step SB (Calculation of Reconstruction Parameter Values)

In parallel with the process in which the count number calculation unit 29 calculates the count number of radiographic images G, the process of calculating the reconstruction parameter values in the radiographic image G is performed. In Example 6, the reconstruction parameter values correspond to four parameters, i.e., the iteration number i, the subset number s, the relaxation parameter r, and the voxel size v.

That is, the reconstruction value calculation unit 39 calculates the parameter values of the iteration number i, the subset number s, the relaxation parameter r, and the voxel size v used in the reconstruction processing of the radiographic image G. The iteration number iy, the subset number sy, the relaxation parameter ry, and the voxel size vy are used as parameters in the reconstruction processing of the radiographic image Gy. Therefore, as shown in FIG. 17, the reconstruction value calculation unit 39 calculates the data of the iteration number iy, the subset number sy, the relaxation parameter ry, and the voxel size vy, and transmits them to the standard deviation calculation unit 31A.

### Step S6 (Calculation of Noise Standard Deviation)

When Step S6 is initiated, the standard deviation calculation unit 31A calculates the value of the noise standard deviation σ appropriate for the NLM filter processing for the radiographic image G. Step S6 in Example 6 will be described in detail using the flowchart shown in FIG. 15 by dividing it into Steps S6A to S6F.

### Step S6A (Calculation of Basic Noise Standard Deviation at)

First, in the basic noise standard deviation calculation unit 41 of the standard deviation calculation unit 31A, an operation of calculating the basic noise standard deviation σt is performed. That is, the basic noise standard deviation calculation unit 41 receives the information on the basic noise deviation model Pa and the information on the count number of the radiographic image G. The basic noise standard deviation calculation unit 41 then calculates the basic noise standard deviation σt corresponding to the radiographic image G of the subject M by substituting the count number acquired for the radiographic image G of the subject M into the basic noise deviation model Pa. Specifically, as shown in FIG. 17, the value of the basic noise standard deviation σty is calculated as the value of the basic noise standard deviation σt of the radiographic image Gy by substituting the value of the count number Ny calculated for the radiographic image Gy into the term of the count number N, which is a variable in Formula (1). The data of the basic noise standard deviation σty is transmitted to the correction arithmetic unit 45.

### Step S6B (Calculation of First Standard Deviation Correction Value f₁)

Second, in the correction value calculation unit 43 of the standard deviation calculation unit 31A, an operation for calculating the first standard deviation correction value f₁ is performed. That is, the correction value calculation unit 43 receives the information on the correction noise deviation model Pb and the information on the iteration number i of the radiographic image G. The correction value calculation unit 43 then calculates the first standard deviation correction value f₁ corresponding to the radiographic image G of the subject M by substituting the iteration number i acquired for the radiographic image G of the subject M into the correction noise deviation model Pb.

Specifically, as shown in FIG. 17, the value of the iteration number iy calculated for the radiographic image Gy is substituted into the term of the iteration number i, which is a variable, in the function of the correction noise deviation model Pb, which is shown in Formula (2). In the function of the correction noise deviation model Pb, the first iteration number model coefficient b1 and the second iteration number model coefficient b2 are both constants estimated by the correction model estimation unit 37. Therefore, by substituting the value of iteration number iy identified by the reconstruction value calculation unit 39 into the correction noise deviation model Pb shown in Formula (2), an appropriate value is identified as the first standard deviation correction value f₁ corresponding to the basic noise standard deviation σty. The first standard deviation correction value f₁ used for the radiographic image Gy is set to “first standard deviation correction value fly. The data of the first standard deviation correction value fly is transmitted to the correction arithmetic unit 45.

### Step S6C (Calculation of Second Standard Deviation Correction Value f₂)

Third, in the correction value calculation unit 43, an operation for calculating the second standard deviation correction value f₂ is performed. That is, the correction value calculation unit 43 receives information on the correction noise deviation model Pc and the information on the subset number s of radiographic images G. The correction value calculation unit 43 then calculates the second standard deviation correction value f₂ corresponding to the radiographic image G by substituting the subset number s acquired for the radiographic image G of the subject M into the correction noise deviation model Pc.

Specifically, as shown in FIG. 17, the value of the subset number sy calculated for the radiographic image Gy is substituted into the term of the subset number s, which is a variable, in the function of the correction noise deviation model Pc shown in Formula (4). In the function of the correction noise deviation model Pc, the first subset model coefficient c₁ and the second subset model coefficient c₂ are both constants estimated by the correction model estimation unit 37. For this reason, by substituting the value of the subset number sy identified by the reconstruction value calculation unit 39 into the correction noise deviation model Pc shown in Formula (4), an appropriate value is identified as the second standard deviation correction value f₂ corresponding to the basic noise standard deviation σty. The second standard deviation correction value f₂ used for the radiographic image Gy is set to “second standard deviation correction value f_{2y}.” The data of the second standard deviation correction value f_{2y} is transmitted to the correction arithmetic unit 45.

### Step S6D (Calculation of Third Standard Deviation Correction Value f₃)

Fourth, in the correction value calculation unit 43, an operation for calculating the third standard deviation correction value f₃ is performed. That is, the correction value calculation unit 43 receives the information of the correction noise deviation model Pd and the information on the relaxation parameter r of the radiographic image G. The correction value calculation unit 43 then calculates the third standard deviation correction value f₃ corresponding to the radiographic image G of the subject M by substituting the relaxation parameter r acquired for the radiographic image G into the correction noise deviation model Pd.

Specifically, as shown in FIG. 17, the value of the relaxation parameter ry calculated for the radiographic image Gy is substituted into the term of the relaxation parameter r, which is a variable, in the function of the correction noise deviation model Pd shown in Formula (6). In the function of the correction noise deviation model Pd, the first relaxation parameter model coefficient d₁ and the second relaxation parameter model coefficient d₂ are both constants estimated by the correction model estimation unit 37.

For this reason, by substituting the value of the relaxation parameter ry identified by the reconstruction value calculation unit 39 into the correction noise deviation model Pd shown in Formula (6), an appropriate value as the third standard deviation correction value f₃ corresponding to the basic noise standard deviation σty can be identified. The third standard deviation correction value f₃ used for the radiographic image Gy is set to “third standard deviation correction value fay. The data of the third standard deviation correction value fay is transmitted to the correction arithmetic unit 45.

### Step S6E (Calculation of Fourth Standard Deviation Correction Value f₄)

Fifth, an operation for calculating the fourth the standard deviation correction value f₄ is performed in the correction value calculation unit 43. That is, the correction value calculation unit 43 receives the information of the correction noise deviation model Pe and the information on the voxel size v of the radiographic image G. The correction value calculation unit 43 then calculates the fourth standard deviation correction value f₄ corresponding to the radiographic image G by substituting the voxel size v acquired for the radiographic image G of the subject M into the correction noise deviation model Pe.

Specifically, as shown in FIG. 17, the value of the voxel size vy calculated for the radiographic image Gy is substituted into the term of the variable voxel size v in the function of the correction noise deviation model Pe shown in Formula (8). In the function of the correction noise deviation model Pe, the first voxel size model coefficient e₁, the second voxel size model coefficient e₂, and the third voxel size model coefficient e₃ are all constants estimated by the correction model estimation unit 37.

Therefore, by substituting the voxel size vy value identified by the reconstruction value calculation unit 39 into the correction noise deviation model Pe shown in Formula (8), an appropriate value is identified as the fourth standard deviation correction value f₄ corresponding to the basic noise standard deviation σty. The fourth standard deviation correction value f₄ used for the radiographic image Gy is referred to as “fourth standard deviation correction value f_{4y}. The data of the fourth standard deviation correction value f_{4y} is transmitted to the correction arithmetic unit 45.

### Step S6F (Calculation of Noise Standard Deviation σ)

Sixth, the noise standard deviation σ is calculated in the correction arithmetic unit 45 of the standard deviation calculation unit 31A. That is, by correcting the basic noise standard deviation σt using the first standard deviation correction value f₁, the second standard deviation correction value f₂, the third standard deviation correction value f₃, and the fourth standard deviation correction value f₄, the correction arithmetic unit 45 calculates the appropriate noise standard deviation σ for the NLM filter processing for the radiographic image G.

In Example 6, the noise deviation model P is a function corresponding to the product of the basic noise deviation model Pa shown in Formula (1), the corrected noise deviation model Pb shown in Formula (2), the corrected noise deviation model Pc shown in Formula (4), the correction noise deviation model Pd shown in Formula (6), and the correction noise deviation model Pe as shown in Formula (8). That is, the noise standard deviation σ appropriate for the radiographic image G can be obtained by the following Formula (10) using the basic noise standard deviation σt, the first standard deviation correction value f₁, the second standard deviation correction value f₂, the third standard deviation correction value f₃, and the fourth standard deviation correction value f₄.

σ=σₜ*f₁*f₂*f₃*f₄ (10)

That is, in Example 6, the value obtained by multiplying the basic noise standard deviation σt, the first standard deviation correction value f₁, the second standard deviation correction value f₂, the third standard deviation correction value f₃, and the fourth standard deviation correction value f₄ is used as the noise standard deviation σ in the NLM filter processing performed in Step S7. The correction arithmetic unit 45 calculates the product of the basic noise standard deviation σty, the first standard deviation correction value f1y, the second standard deviation correction value f_{2y}, the third standard deviation correction value f_{3y}, and the fourth standard deviation correction value f_{4y} as the value of the noise standard deviation σ (noise standard deviation σy) suitable for the radiographic image Gy.

The information on the noise standard deviation σy calculated as the information on the noise standard deviation σ suitable for the radiographic image Gy is transmitted from the standard deviation calculation unit 31A to the noise reduction processing unit 33. The process of Step S6 is completed when the noise standard deviation σ is calculated. Note that the order of performing Steps S6A to S6E may be changed as needed.

### Step S7 (Noise Reduction Process)

When the information of the noise standard deviation σ suitable for the radiographic image G of the subject M is transmitted to the noise reduction processing unit 33, the noise reduction processing unit 33 uses the information on the noise standard deviation σ (here, the noise standard deviation σy) calculated by the standard deviation calculation unit 31A and the three parameters set by the user to perform NLM filter processing for the radiographic image Gy. As shown in FIG. 17, a noise-reduced image Hy is generated from the radiographic image Gy by performing the NLM filter processing by the noise reduction processing unit 33. With the above-described process, a series of PET imaging with the imaging condition Qy and the reconstruction condition Ry is completed.

Hereafter, in cases where diagnosis under different imaging conditions or different configuration conditions is required, the processes from Step S3 to Step S7 are repeated as appropriate to complete the PET imaging of the subject M.

### Effects of Configuration of Embodiment

### (Item 1)

An image processing method according to this embodiment is an image processing method comprising:
a reconstruction step of reconstructing a radiographic image of a subject by performing reconstruction processing on radiological data of the subject;
a count number calculation step of calculating a count number in a subject area in the radiographic image of the subject;
a standard deviation calculation step of calculating a noise standard deviation in the radiographic image of the subject from a relation between the count number in each of a plurality of function calculation radiographic images acquired in advance and the noise standard deviation, by substituting the count number in the subject area into a basic noise deviation function acquired in advance as a function in which a value of the count number and a value of the noise standard deviation correspond to each other; and
a noise reduction processing step of performing NLM filter processing on the radiographic image of the subject, using the noise standard deviation calculated in the standard deviation calculation step.

According to the image processing method described in the above-described Item 1, a basic noise deviation function, which is a function in which the value of the count number and the value of the noise standard deviation correspond to each other, is acquired in advance. The basic noise deviation function is obtained from the relation between the count number in each of the previously acquired function calculation radiographic images and the basic noise standard deviation. After reconstructing the radiographic image of the subject in the reconstruction step, the count number in the subject area in the radiographic image of the subject is calculated in the count number calculation step.

In the standard deviation calculation step, the noise standard deviation in the radiographic image of the subject is calculated by substituting the count number in the subject area in question into the basic noise deviation function. Since the basic noise deviation function is a function in which the value of the count number and the noise standard deviation correspond, the noise standard deviation value appropriate for the radiographic image of the subject can be quickly calculated by substituting the count number in the subject area into the basic noise standard deviation function. Since the value of the noise standard deviation can be specified by a simple operation of substituting the count number into the basic noise deviation function acquired in advance, the time required to specify the noise standard deviation can be greatly reduced, and the burden on the user can be reduced.

In the noise reduction processing step, the NLM filter processing is performed using the noise standard deviation calculated in the standard deviation calculation step. Since a parameter of the noise standard deviation appropriate for NLM filter processing is obtained in the standard deviation calculation step, the accuracy of the NLM filter processing in the noise reduction processing step can be improved.

Further, in the conventional NLM filter processing, the parameter of the appropriate noise standard deviation differs according to the count number of the radiographic image. When the imaging conditions of the radiographic images differ, the count number of the radiographic image also differs. For this reason, conventionally, each time an radiographic image is generated by changing the imaging condition, it was necessary to specify the parameter of the noise standard deviation according to the changed imaging condition by trial and error.

On the other hand, in the image processing method according to this embodiment, the noise standard deviation is calculated by substituting the count number of the radiographic image into the basic noise deviation function. Since the basic noise deviation function is a function in which the value of the count number and the value of the noise standard deviation correspond, even if the count number is changed, the value of the noise standard deviation according to the changed count number can be quickly calculated by substituting the new count number into the basic noise deviation function.

Therefore, even in cases where radiographic imaging is performed while frequently changing the capturing conditions, the operation of identifying the parameter of the noise standard deviation by trial and error becomes unnecessary each time the capturing condition is changed. As a result, in cases where noise reduction processing using NLM filter processing is performed while frequently changing the imaging condition, the time required for noise reduction processing can be further shortened, further reducing the burden on the user.

### (Item 2)

Further, in the image processing method as recited in the above-described Item 2,
a basic noise standard deviation σt in the basic noise deviation function is calculated by a following Formula (1)

σₜ=a₁*N^{a}^{₂}+a₃ (1)

using the count number N in the subject area, and a first count model coefficient a₁, a second count model coefficient a₂, and a third count model coefficient a₃, the first count model coefficient a₁, the second count model coefficient a₂, and the third count model coefficient a₃ being obtained from a relation between the count number in each of the plurality of function calculation radiographic images acquired in advance and the noise standard deviation, and
the noise standard deviation σ in the noise reduction processing step satisfies a condition of σ=σt.

According to the image processing method as recited in the above-described Item 2, the basic noise standard deviation σt is calculated using the basic noise deviation function expressed in Formula (1). The basic noise deviation function is a function with the count number N as a variable, and the slope of the term of the count number N, the order of the term of the count number N, and the y-intercept are specified by the first count model coefficient a₁, the second count model coefficient a₂, and the third count model coefficient a₃. Therefore, by using Formula (1), even if the count number and the noise standard deviation in each function calculation radiographic image are any value, the basic noise deviation function can be determined appropriately.

The basic noise standard deviation σt and the noise standard deviation σ satisfy the condition of σ=σt. Further, since each of the first count model coefficient a₁, the second count model coefficient a₂, and the third count model coefficient a₃ are obtained as constants, the basic noise standard deviation is determined by substituting the value of the count in the radiographic image of the subject into the term for the count number N. Since the basic noise standard deviation and the noise standard deviation are equal, the value of the noise standard deviation suitable for NLM filter processing for the radiographic image of the subject is determined by determining the basic noise standard deviation. Therefore, the calculation required to calculate the noise standard deviation can be simplified and shortened.

### (Item 3)

Further, in the image processing method as recited in the above-described Item 1, the standard deviation calculation step comprises:
a basic noise standard deviation calculation step of calculating a basic noise standard deviation in the radiographic image of the subject by substituting the count number in the subject area into the basic noise deviation function acquired in advance as a function in which a value of the count number and a value of the basic noise standard deviation correspond to each other;
a correction value calculation step of calculating a standard deviation correction value in the radiographic image of the subject by substituting a parameter value of the reconstitution processing in the reconstitution step into a standard deviation correction function acquired in advance as a function in which the parameter value of the reconstruction processing and the standard deviation correction value correspond to each other; and
a correction arithmetic step of calculating the noise standard deviation in the radiographic image of the subject calculated in the basic noise standard deviation calculation step by correcting the basic noise standard deviation in the radiographic image of the subject by using the standard deviation correction value in the radiographic image of the subject calculated in the correction value calculation step.

According to the image processing method as recited in the above-described Item 3, the value obtained by correcting the basic noise standard deviation is calculated as the noise standard deviation. That is, in addition to the basic noise deviation function, a standard deviation correction function is acquired in advance. The standard deviation correction function is a function in which the parameter values of the reconstruction processing and the standard deviation correction value correspond to each other.

In the correction value calculation step, by substituting the parameter values of the reconstruction processing to be performed on the radiographic image of the subject into the standard deviation correction function, the standard deviation correction value in the radiographic image of the subject is calculated. In the correction value calculation step, by correcting the basic noise standard deviation with the standard deviation correction value, the noise standard deviation in the radiographic image of the subject is calculated.

In this configuration, not only the count number, which varies with the imaging condition, but also the parameter values of the reconstruction processing, which vary with the reconstruction processing condition, are included as a factor in calculating the noise standard deviation. Therefore, not only when the imaging condition of a radiographic image changes, but also when the reconstruction processing condition of the radiographic image changes, the value of the noise standard deviation appropriate for the radiographic image generated under the changed reconstruction processing condition can be calculated quickly. Therefore, even in cases where the reconstruction processing condition is frequently changed, the NLM filter processing with high accuracy can be performed quickly.

### (Item 4)

Further, in the image processing method as recited in the above-described Item 3,
the standard deviation correction function includes a first correction function acquired in advance as a function in which an iteration number in the reconstruction processing and a first standard deviation correction value correspond to each other,
the correction value calculation step calculates the first standard deviation correction value in the radiographic image of the subject by substituting the iteration number in the reconstruction processing into the first correction function, and
the correction arithmetic step calculates the noise standard deviation in the radiographic image of the subject by correcting the basic noise standard deviation in the radiographic image of the subject calculated in the basic noise standard deviation calculation step using the first standard deviation correction value in the radiographic image of the subject.

According to the image processing method as recited in the above-described Item 4, the standard deviation correction function acquired in advance includes a first correction function. The first correction function is a function in which the iteration number in the reconstruction processing and the first standard deviation correction value correspond to each other. In this case, the basic noise standard deviation is corrected according to the value of the iteration number in the reconstruction processing, and the noise standard deviation is calculated. Therefore, even in cases where the iteration number in the reconstruction processing of the radiographic image of the subject changes, the noise standard deviation value appropriate for the NLM filter processing corresponding to the iteration number after the change is calculated. That is, even in the case of generating a new radiographic image by changing the iteration number in the reconstruction processing, the NLM filter processing for the new radiographic image can be performed quickly and accurately.

### (Item 5)

Further, in the image processing method as recited in the above-described Item 4,
the basic noise standard deviation σt in the basic noise deviation function is calculated by the following Formula (1)

σₜ=a₁*N^{a}^{₂}+a₃ (1)

using the count number N in the subject area, and a first count model coefficient a₁, a second count model coefficient a₂, and a third count model coefficient a₃, the first count model coefficient a₁, the second count model coefficient a₂, and the third count model coefficient a₃ being acquired from a relation between the count value in each of the plurality of radiographic images acquired in advance and the noise standard deviation,
the first standard deviation correction value f₁ is calculated from the following Formula (2)

$${f}_{1} = {b}_{1} * {log}_{2} ( \frac{i}{{i}^{base}} ) + {b}_{2} \qquad ( 2 )$$

using an iteration number i in the reconstruction processing for radiographic data of the subject, a reference iteration number i_{base} determined in advance, a first iteration number model coefficient b₁, and a second iteration number model coefficient b₂, the first iteration number model coefficient b₁ and the second iteration number model coefficient b₂ being acquired from a relation between the iteration number in the reconstruction processing of the plurality of function calculation radiographic images acquired in advance and the first standard deviation correction value, and
the noise standard deviation σ in the noise reduction processing step satisfies a condition expressed by the following Formula (3).

σ=σₜ*f₁ (3)

According to the image processing method as recited in Item 5, the basic noise standard deviation σt is calculated using the basic noise deviation function expressed in Formula (1). The basic noise deviation function is a function with the count number N as a variable, and the slope of the term of the count number N, the order of the term of the count number N, and the y-intercept are specified by the first count model coefficient a₁, the second count model coefficient a₂, and the third count model coefficient a₃. Therefore, by using Formula (1), the basic noise deviation function can be determined appropriately even if the count number and the noise standard deviation in each of the function calculation radiographic images are any value. By substituting the value of the count number in the radiographic image of the subject into the term of the count number N in the basic noise deviation function, the basic noise standard deviation σt can be quickly determined.

The first standard deviation correction value f1 is calculated using the first correction function expressed in Formula (2). The first correction function is a function with the iteration number i as a variable, and the slope of the term including the iteration number i and the y-intercept are specified by the first and second iteration number model coefficients b₁ and b₂. Therefore, by using Formula (2), the first standard deviation correction value can be determined appropriately even if the iteration number and the noise standard deviation in each function calculation radiographic image are any value. By substituting the value of the iteration number in the radiographic image of the subject into the term of the iteration number i in the first correction function, the first standard deviation correction value f1 can be quickly determined.

The value of noise standard deviation σ is calculated by Formula (3) using the basic noise standard deviation σt and the first standard deviation correction value f₁. Therefore, by determining the basic noise standard deviation σt and the first standard deviation correction value f₁, the value of the noise standard deviation σ suitable for the NLM filter processing for the radiographic image of the subject is determined. Therefore, the calculation required to calculate the noise standard deviation can be simplified and shortened.

### (Item 6)

Further, in the image processing method as recited in the above-described Item 3,
the standard deviation correction function includes a second correction function acquired in advance as a function in which the subset number in the reconstruction processing and a second standard deviation correction value correspond to each other,
the correction value calculation step calculates a second standard deviation correction value in the radiographic image of the subject by substituting a subset number in the reconstruction processing into the second correction function, and
the correction arithmetic step calculates the noise standard deviation in the radiographic image of the subject by correcting the basic noise standard deviation in the radiographic image of the subject calculated in the basic noise standard deviation calculation step, using the second standard deviation correction value in the radiographic image of the subject.

According to the image processing method as recited in the above-described Item 6, the standard deviation correction function acquired in advance includes a second correction function. The second correction function is a function in which the subset number in the reconstruction processing and the second standard deviation correction value correspond to each other. In this case, the basic noise standard deviation is corrected according to the value of the subset number in the reconstruction processing, and the noise standard deviation is calculated. Accordingly, even in cases where the subset number in the reconstruction processing of the radiographic image of the subject changes, the value of the noise standard deviation appropriate for the NLM filter processing corresponding to the subset number after such change is calculated. That is, even in cases where a radiographic image is newly generated by changing the subset number in the reconstruction processing, the NLM filter processing for the new radiographic image can be performed quickly and accurately.

### (Item 7)

Further, in the image processing method as recited in the above-described Item 6,
the basic noise standard deviation σt in the basic noise deviation function is calculated by the following Formula (1)

σₜ=a₁*N^{a}^{₂}+a₃ (1)

using the count number N in the subject area, a first count model coefficient a₁, a second count model coefficient a₂, and a third count model coefficient a₃, the first count model coefficient a₁, the second count model coefficient a₂, and the third count model coefficient a₃ being acquired in advance from a relation between the count number in each of the plurality of function calculation radiographic images acquired in advance and the noise standard deviation,
the second standard deviation correction value f₂ is calculated by the following Formula (4)

$${f}_{2} = {c}_{1} * {log}_{2} ( \frac{s}{{s}^{base}} ) + {c}_{2} \qquad ( 4 )$$

using the subset number s in the reconstruction processing for radiographic data of the subject, a reference subset number s_{base} determined in advance, a first subset model coefficient c₁, and a second subset model coefficient c₂, the first subset model coefficient c₁ and the second subset model coefficient c₂ being acquired from a relation between the subset number in the reconstruction processing for the plurality of function calculation radiographic images acquired in advance and the second standard model coefficient, and
wherein the noise standard deviation σ in the noise reduction step satisfies a condition expressed by the following Formula (5).

σ=σₜ*f₂ (5)

According to the image processing method as recited in the above-described Item 7, the basic noise standard deviation σt is calculated using the basic noise deviation function expressed by Formula (1). The basic noise deviation function is a function with the count number N as a variable, and the slope of the term of the count number N, the order of the term of the count number N, and the y-intercept are specified by the first count model coefficient a₁, the second count model coefficient a₂, and the third count model coefficient a₃. For this reason, by using Formula (1), the basic noise deviation function can be determined appropriately even if the count number and the noise standard deviation in each of the function calculation radiographic images are any value. By substituting the value of the count number in the radiographic image of the subject into the term of the count number N in the basic noise deviation function, the basic noise standard deviation σt can be quickly determined.

The second standard deviation correction value f₂ is calculated using the second correction function expressed by Formula (4). The second correction function is a function with the subset number s as a variable, and the slope of the term containing the subset number s and the y-intercept are specified by the first and second subset model coefficients c₁ and c₂. Therefore, by using Formula (4), the second standard deviation correction value can be determined appropriately even if the subset number and the noise standard deviation in each of the function calculation radiographic images are any value. By substituting the value of the subset number in the radiographic image of the subject into the term for the subset number s in the second correction function, the second standard deviation correction value f₂ can be quickly determined.

The value of the noise standard deviation σ is calculated by Formula (7) using the basic noise standard deviation σt and the second standard deviation correction value f₂. Therefore, by determining the basic noise standard deviation σt and the second standard deviation correction value f₂, the noise standard deviation σ suitable for the NLM filter processing for the radiographic image of the subject is determined. Therefore, the calculation required to calculate the noise standard deviation can be simplified and shortened.

### (Item 8)

Further, in the image processing method as recited in the above-described Item 3,
the standard deviation correction function includes a third correction function acquired in advance as a function in which a relaxation parameter in the reconstruction processing and a third standard deviation correction value correspond to each other,
the correction value calculation step calculates a third standard deviation correction value in the radiographic image of the subject by substituting the relaxation parameter in the reconstruction processing into the third correction function, and
the correction arithmetic step calculates the noise standard deviation in the radiographic image of the subject by correcting the basic noise standard deviation in the radiographic image of the subject calculated in the basic noise standard deviation calculation step, using the third standard deviation correction value in the radiographic image of the subject.

According to the image processing method as recited in the above-described Item 8, the standard deviation correction function acquired in advance includes a third correction function. The third correction function is a function in which the relaxation parameter in the reconstruction processing and the third standard deviation correction value correspond to each other. In this case, the basic noise standard deviation is corrected according to the relaxation parameter in the reconstruction processing, and the noise standard deviation is calculated. Therefore, even in cases where the relaxation parameter in the reconstruction processing of the radiographic image of the subject is changed, the noise standard deviation value appropriate for the NLM filter processing corresponding to the relaxation parameter after said change is calculated. That is, even in cases where a radiographic image is newly generated by changing the relaxation parameter in the reconstruction processing, the NLM filter processing for the new radiographic image can be performed quickly and precisely.

### (Item 9)

In the image processing method as recited in the above-described Item 8, the basic noise standard deviation σt in the basic noise deviation function is calculated by the following Formula (1)

σₜ=a₁*N^{a}^{₂}+a₃ (1)

using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of function calculation radiographic images acquired in advance and the noise standard deviation,
the third standard deviation correction value f₃ is calculated by the following Formula (6)

$${f}_{3} = {d}_{1} * {log}_{2} ( \frac{r}{{r}^{base}} ) + {d}_{2} \qquad ( 6 )$$

using the relaxation parameter r in the reconstruction processing for the radiographic data of the subject, a reference relaxation parameter r_{base} predetermined in advance, a first relaxation parameter model coefficient d₁, and a second relaxation parameter model coefficient d₂, the first relaxation parameter model coefficient d₁ and the second relaxation parameter model coefficient d₂ being acquired in advance from a relation between the relaxation parameter in the reconstruction processing for the plurality of function calculation radiographic images acquired in advance and the third standard deviation correction value, and
the noise standard deviation σ in the noise reduction processing step satisfies a condition expressed by the following Formula (7).

σ=σₜ*f₃ (7)

According to the image processing method as recited in the above-described in Item 9, the basic noise standard deviation σt is calculated using the basic noise deviation function expressed by Formula (1). The basic noise deviation function is a function with the count number N as a variable, and the slope of the term of the count number N, the order of the term of the count number N, and the y-intercept are specified by the first count model coefficient a₁, the second count model coefficient a₂, and the third count model coefficient a₃. Therefore, by using Formula (1), the basic noise deviation function can be determined appropriately even if the count number and the noise standard deviation in each of the function calculation radiographic images are any value. By substituting the value of the count number in the radiographic image of the subject into the term of the count number N in the basic noise deviation function, the basic noise standard deviation σt can be quickly determined.

The third standard deviation correction value f₃ is calculated using the third correction function expressed by Formula (6). The third correction function is a function with the relaxation parameter r as a variable, and the slope of the term including the relaxation parameter r and the y-intercept are specified by the first relaxation parameter model coefficient d₁ and the second relaxation parameter model coefficient d₂. Therefore, by using Formula (6), the third standard deviation correction value can be determined appropriately even if the relaxation parameter and the noise standard deviation in each function calculation radiographic image are any value. Then, by substituting the relaxation parameter of the radiographic image of the subject into the term of the relaxation parameter r in the third correction function, the third standard deviation correction value f₃ can be quickly determined.

The value of the noise standard deviation σ is calculated by Formula (7) using the basic noise standard deviation σt and the third standard deviation correction value f₃. Therefore, when the basic noise standard deviation σt and the third standard deviation correction value f₃ are determined, the value of the noise standard deviation σ suitable for the NLM filter processing for the radiographic image of the subject is determined. Therefore, the calculation required to calculate the noise standard deviation can be simplified and shortened.

### (Item 10)

Further, in the image processing method as recited in the above-described Item 3,
the standard deviation correction function includes a fourth correction function acquired in advance as a function in which a voxel size in the reconstruction processing and a fourth standard deviation correction value corresponds to each other,
the correction value calculation step calculates a fourth standard deviation correction value in the radiographic image of the subject by substituting the voxel size in the reconstruction processing into the fourth correction function, and
the correction arithmetic step calculates the noise standard deviation in the radiographic image of the subject by correcting the basic noise standard deviation in the radiographic image of the subject calculated in the basic noise standard deviation calculation step, using the fourth standard deviation correction value in the radiographic image of the subject.

According to the image processing method as recited in the above-described Item 10, the standard deviation correction function acquired in advance includes a fourth correction function. The fourth correction function is a function in which the voxel size in the reconstruction processing and the fourth standard deviation correction value correspond to each other. In this case, the basic noise standard deviation is corrected according to the voxel size in the reconstruction processing, and the noise standard deviation is calculated. For this reason, even in cases where the voxel size in the reconstruction processing of the radiographic image of the subject changes, the value of the noise standard deviation appropriate for the NLM filter processing corresponding to the voxel size after such change can be calculated. That is, even in cases where a radiographic image is newly generated while changing the voxel size in the reconstruction processing, the NLM filter processing for the new radiographic image can be performed quickly and precisely.

### (Item 11)

Further, in the image processing method as recited in the above-described Item 10,
the basic noise standard deviation σt in the basic noise deviation function is calculated by the following Formula (1)

σₜ=a₁*N^{a}^{₂}+a₃ (1)

using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of function calculation radiographic images acquired in advance and the noise standard deviation,
the fourth standard deviation correction value f₄ is calculated by the following Formula (8)

$${f}_{4} = {e}_{1} * {( \frac{v}{{v}^{base}} )}^{e 2} + e 3 \qquad ( 8 )$$

using the voxel size v in the reconstruction processing for the radiographic data of the subject, a reference voxel size v_{base} predetermined in advance, a first voxel size model coefficient e₁, a second voxel size model coefficient e₂, and a third voxel size model coefficient e₃, the first voxel size model coefficient e₁, the second voxel size model coefficient e₂, and the third voxel size model coefficient e₃ being acquired from a relation between a reference voxel size in the reconstruction processing for the plurality of function calculation radiographic images acquired in advance and the fourth standard deviation correction value, and
the noise standard deviation σ in the noise reduction processing step satisfies a condition expressed by the following Formula (9).

σ=σₜ*f₄ (9)

According to the image processing method as recited in the above-described Item 11, the basic noise standard deviation σt is calculated using the basic noise deviation function expressed by Formula (1). The basic noise deviation function is a function with the count number N as a variable, and the slope of the term of the count number N, the order of the term of the count number N, and the y-intercept are specified by the first count model coefficient a₁, the second count model coefficient a₂, and the third count model coefficient a₃. Therefore, by using Formula (1), the basic noise deviation function can be determined appropriately even if the count number and the noise standard deviation in each of the function calculation radiographic images are any value. By substituting the value of the count number in the radiographic image of the subject into the term of the count number N in the basic noise deviation function, the basic noise standard deviation σt can be quickly determined.

The fourth standard deviation correction value f₄ is calculated using the fourth correction function expressed in Formula (8). The fourth correction function is a function with the voxel size v as a variable, and the slope of the term including the voxel size v, the order of the term including the voxel size v, and the y-intercept are specified by the first relaxation parameter model coefficient d₁ and the second relaxation parameter model coefficient d₂. Therefore, by using Formula (8), the fourth standard deviation correction value can be determined appropriately even if the voxel size and the noise standard deviation in each of the function calculation radiographic images are any value. Then, by substituting the voxel size of the radiographic image of the subject into the term of the voxel size v in the fourth correction function, the fourth standard deviation correction value f₄ can be quickly determined.

The value of the noise standard deviation σ is calculated by Formula (9) using the basic noise standard deviation σt and the fourth standard deviation correction value f₄. Therefore, when the basic noise standard deviation σt and the fourth standard deviation correction value f₄ are determined, the noise standard deviation σ value suitable for NLM filter processing for the radiographic image of the subject is determined. Therefore, the calculation required to calculate the noise standard deviation can be simplified and shortened.

### (Item 12)

Further, in the image processing method as recited in the above-described Item 3,
the standard deviation correction function includes
a first correction function obtained in advance as a function in which the iteration number in the reconstruction processing and a first standard deviation correction value correspond to each other,
a second correction function acquired in advance as a function in which a subset number in the reconstruction processing and a second standard deviation correction value correspond to each other,
a third correction function acquired in advance as a function in which a relaxation parameter in the reconstruction processing and a third standard deviation correction value correspond to each other, and
a fourth correction function acquired in advance as a function in which a voxel size in the reconstruction processing and a fourth standard deviation correction value correspond to each other,
wherein the correction value calculation step
calculates the first standard deviation correction value in the radiographic image of the subject by substituting the iteration number in the reconstruction processing into the first correction function,
calculates the second standard deviation correction value in the radiographic image of the subject by substituting the subset number in the reconstruction processing into the second correction function,
calculates the third standard deviation correction value in the radiographic image of the subject by substituting the relaxation parameter in the reconstruction processing into the third correction function, and
calculates the fourth standard deviation correction value in the radiographic image of the subject by substituting the voxel size in the reconstruction step into the fourth correction function,
the correction arithmetic step calculates the noise standard deviation in the radiographic image of the subject by correcting the basic noise standard deviation in the radiographic image of the subject calculated in the basic noise standard deviation calculation step, using the first standard deviation correction value, the second standard deviation correction value, the third standard deviation correction value, and the fourth standard deviation correction value in the radiographic image of the subject.

According to the image processing method as recited in the above-described Item 12, the standard deviation correction functions acquired in advance include a first correction function, a second correction function, a third correction function, and a fourth correction function. The first correction function is a function in which the iteration number in the reconstruction processing and the first standard deviation correction value. The second correction function is a function in which the subset number in the reconstruction processing and the second standard deviation correction value correspond to each other. The third correction function is a function in which the relaxation parameter in the reconstruction processing and the third standard deviation correction value correspond to each other. The fourth correction function is a function in which the voxel size in the reconstruction processing and the fourth standard deviation correction value correspond to each other.

In this case, the basic noise standard deviation is corrected and the noise standard deviation is calculated according to the iteration number, the subset number, the relaxation parameter, and the voxel size in the reconstruction processing. Therefore, even in cases where various parameter values, such as, e.g., the iteration number, in the reconstruction processing of the radiographic image of the subject, are changed, the value of the noise standard deviation appropriate for the NLM filter processing corresponding to each parameter value after the change is calculated. That is, even in cases where a radiographic image is newly generated while changing various parameter values in the reconstruction process, the NLM filter processing for the new radiographic image can be performed quickly and accurately.

### (Item 13)

Further, in the image processing method as recited in the above-described Item 12,
the basic noise standard deviation σt in the basic noise deviation function is calculated by the following Formula (1)

σₜ=a₁*N^{a}^{₂}+a₃ (1)

using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of function calculation radiographic images acquired in advance and the noise standard deviation,
the first standard deviation correction value f₁ is calculated by the following Formula (2)

$${f}_{1} = {b}_{1} * {log}_{2} ( \frac{i}{{i}^{base}} ) + {b}_{2} \qquad ( 2 )$$

using the iteration number i in the reconstruction processing for radiographic data of the subject, a reference iteration number i_{base} determined in advance, a first iteration number model coefficient b₁, and a second iteration number coefficient b₂, the first iteration number model coefficient b₁ and the second iteration number coefficient b₂ being obtained from a relation between the iteration number in the reconstruction processing for a plurality of function calculation radiographic images acquired in advance and the first standard deviation correction value,
the second standard deviation correction value f₂ is calculated by the following Formula (4)

$${f}_{2} = {c}_{1} * {log}_{2} ( \frac{s}{{s}^{base}} ) + {c}_{2} \qquad ( 4 )$$

using the subset number s in the reconstruction processing for the radiographic data of the subject, a reference subset number s_{base} determined in advance, a first subset number coefficient c₁, and a second subset number coefficient c₂, the first subset number coefficient c₁ and the second subset number coefficient c₂ being obtained from a relation between the subset number in the reconstruction processing for the plurality of function calculation radiographic images acquired in advance and the second standard deviation correction value,
the third standard deviation correction value f₃ is calculated by the following Formula (6)

$${f}_{3} = {d}_{1} * {log}_{2} ( \frac{r}{{r}^{base}} ) + {d}_{2} \qquad ( 5 )$$

using the relaxation parameter r in the reconstruction processing for the radiographic data of the subject, a reference relaxation parameter r_{base} determined in advance, a first relaxation parameter model coefficient d₁, and a second relaxation parameter model coefficient d₂, the first relaxation parameter model coefficient d₁ and the second relaxation parameter model coefficient d₂ being acquired from a relation between the relaxation parameter in the reconstruction processing for the plurality of function calculation radiographic images acquired in advance and the third standard deviation correction value,
the fourth standard deviation correction value f₄ is calculated by the following Formula (8)

$${f}_{4} = {e}_{1} * {( \frac{v}{{v}^{base}} )}^{e 2} + e 3 \qquad ( 8 )$$

using the voxel size v in the reconstruction processing for the radiographic data of the subject, a reference voxel size v_{base} determined in advance, a first voxel size model coefficients e₁, a second voxel size model coefficient e₂, and a third voxel size model coefficient e₃, the first voxel size model coefficients e₁, the second voxel size model coefficient e₂, and the third voxel size model coefficient e₃ being acquired from a relation between the reference voxel size in the reconstruction processing for the plurality of function calculation radiographic images acquired in advance and the fourth standard deviation correction value, and
the noise standard deviation σ in the noise reduction processing step satisfies a condition expressed by the following Formula (10).

σ=σₜ*f₁*f₂*f₃*f₄ (10)

According to the image processing method as recited in the above-described Item 13, the basic noise standard deviation σt is calculated using the basic noise deviation function expressed by Formula (1). The basic noise deviation function is a function with the count number N as a variable, and the slope of the term of the count number N, the order of the term of the count number N, and the y-intercept are specified by the first count model coefficient a₁, the second count model coefficient a₂, and the third count model coefficient a₃. Therefore, by using Formula (1), the basic noise deviation function can be determined appropriately even if the count number and the noise standard deviation in each of the function calculation radiographic images are any value. By substituting the value of the count number in the radiographic image of the subject into the term of the count number N in the basic noise deviation function, the basic noise standard deviation σt can be quickly determined.

The first standard deviation correction value f₁ is calculated using the first correction function expressed by Formula (2). The first correction function is a function with the iteration number i as a variable, and the slope of the term including iteration number i and the y-intercept are specified by the first and second iteration number model coefficients b₁ and b₂. Therefore, by using Formula (2), the first standard deviation correction value can be determined appropriately even if the iteration number and the noise standard deviation in each function calculation radiographic image are any value. By substituting the iteration number in the radiographic image of the subject into the term of the iteration number i in the first correction function, the first standard deviation correction value f₁ can be quickly determined.

The second standard deviation correction value f₂ is calculated using the second correction function expressed by Formula (4). The second correction function is a function with the subset number s as a variable, and the slope of the term containing the subset number s and the y-intercept are specified by the first subset model coefficient c₁ and the second subset model coefficient c₂. Therefore, by using Formula (4), the second standard deviation correction value can be determined appropriately even if the subset number and the noise standard deviation in each of the function calculation radiographic images are any value. By substituting the value of the subset number in the radiographic image of the subject into the term of the subset number s in the second correction function, the second standard deviation correction value f₂ can be quickly determined.

The third standard deviation correction value f₃ is calculated using the third correction function expressed by Formula (6). The third correction function is a function with the relaxation parameter r as a variable, and the slope of the term including the relaxation parameter r and the y-intercept are specified by the first relaxation parameter model coefficient d₁ and the second relaxation parameter model coefficient d₂. Therefore, by using Formula (6), the third standard deviation correction value can be determined appropriately even if the relaxation parameter and the noise standard deviation in each function calculation radiographic image are any value. By substituting the relaxation parameter of the radiographic image of the subject into the term of the relaxation parameter r in the third correction function, the third standard deviation correction value f₃ can be quickly determined.

The fourth standard deviation correction value f₄ is calculated using the fourth correction function expressed by Formula (8). The fourth correction function is a function with the voxel size v as a variable, and the slope of the term including the voxel size v, the order of the term including the voxel size v, and the y-intercept are specified by the first relaxation parameter model coefficients d₁ and the second relaxation parameter model coefficients d₂. Therefore, by using Formula (8), the fourth standard deviation correction value can be determined appropriately even if the voxel size and the noise standard deviation in each of the function calculation radiographic images are any value. By substituting the voxel size of the radiographic image of the subject into the term of the voxel size v in the fourth correction function, the fourth standard deviation correction value f4 can be quickly determined.

The value of noise standard deviation σ is calculated by Formula (10) using the basic noise standard deviation σt, the first standard deviation correction value f₁, the second standard deviation correction value f₂, the third standard deviation correction value f₃, and the fourth standard deviation correction value f₄. Therefore, by determining the basic noise standard deviation σt, the first standard deviation correction value f₁, the second standard deviation correction value f₂, the third standard deviation correction value f₃, and the fourth standard deviation correction value f₄, the value of the noise standard deviation σ suitable for the NLM filter processing for the radiographic image of the subject is determined. Therefore, the calculation required to calculate the noise standard deviation can be simplified and shortened.

### (Item 14)

An image processing apparatus according to this embodiment comprises: a reconstruction processing unit configured to reconstruct a radiographic image of a subject by performing reconstruction processing on radiographic data of the subject for which radiographic imaging has been performed;
a count number calculation unit configured to calculate a count number in a subject area in the radiographic image of the subject;
a standard deviation calculation unit configured to calculate a noise standard deviation in the radiographic image of the subject from a relation between the count number in each of a plurality of function calculation radiographic images acquired in advance and the noise standard deviation function by substituting the count number in the subject area into a basic noise deviation function acquired in advance as a function in which a value of the count number and a value of the noise standard deviation corresponds to each other; and
a noise reduction processing unit configured to perform NLM filter processing on the radiographic image of the subject using the noise standard deviation calculated by the standard deviation calculation unit.

According to the image processing apparatus as recited in the above-described Item 14, the basic noise deviation function, which is a function in which the value of the count number and the noise standard deviation value correspond, is acquired in advance. The basic noise deviation function is obtained from the relation between the count number and the basic noise standard deviation in each of the previously acquired function calculation radiographic images. After reconstructing the radiographic image of the subject in the reconstruction processing unit, the count number calculation unit calculates the count number in the subject area in the radiographic image of the subject.

The standard deviation calculation unit calculates the noise standard deviation in the radiographic image of the subject by substituting the count number calculation unit of the subject area into the basic noise deviation function. Since the basic noise deviation function is a function in which the value of the count number and the value of the noise standard deviation correspond, the appropriate noise standard deviation value for a radiographic image of the subject can be quickly calculated by substituting the count number in the subject area into the basic noise standard deviation function. Since the value of the noise standard deviation can be specified by a simple operation of substituting the count number into the basic noise deviation function acquired in advance, the time required to specify the noise standard deviation can be greatly reduced, and the burden on the user can be reduced.

The noise reduction processing unit performs NLM filter processing using the noise standard deviation calculated by the standard deviation calculation unit. Since the standard deviation calculation unit determines the appropriate noise standard deviation parameters for the NLM filter processing, the accuracy of the NLM filter processing performed by the noise reduction processing unit can be improved.

Further, in the conventional NLM filter processing, the parameter of the appropriate noise standard deviation differs according to the count number of radiographic images. And when the imaging condition of radiographic image differs, the count number of the radiographic image also differs. Therefore, in the past, each time the imaging condition was changed to generate a radiographic image, it was necessary to specify the parameter of the noise standard deviation according to the changed imaging condition by trial and error.

On the other hand, in this image processing apparatus, the noise standard deviation is calculated by substituting the count number of the radiographic image into the basic noise deviation function. Since the basic noise deviation function is a function in which the value of the count number and the value of the noise standard deviation correspond, even if the count number is changed, the value of the noise standard deviation according to the changed count number can be quickly calculated by substituting the count number after the change into the basic noise deviation function. Therefore, even in cases where a number of radiographic images are captured while frequently changing the capturing conditions, it is no longer necessary to specify the noise standard deviation parameter by trial and error each time the capturing condition is changed. As a result, in cases where noise reduction processing by NLM filter processing is performed while frequently changing the imaging condition, the time required for the noise reduction processing can be further shortened, further reducing the burden on the user.

### (Item 15)

Further, in the image processing device as recited in the above-described Item 14,
a basic noise standard deviation σt in the basic noise deviation function is calculated by the following Formula (1)

σₜ=a₁*N^{a}^{₂}+a₃ (1)

using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of function calculation radiographic images acquired in advance and the noise standard deviation, and
the noise standard deviation σ used in the noise reduction processing unit satisfies a condition of σ=σt.

According to the image processing apparatus as recited in the above-described Item 15, the basic noise standard deviation σt is calculated using the basic noise deviation function expressed by Formula (1). The basic noise deviation function is a function with the count number N as a variable, and the slope of the term of the count number N, the order of the term of the count number N, and the y-intercept are specified by the first count model coefficient a₁, the second count model coefficient a₂, and the third count model coefficient a₃. Therefore, by using Formula (1), the basic noise deviation function can be determined appropriately even if the count number and the noise standard deviation in each of the function calculation radiographic images are any value.

The basic noise standard deviation σt and the noise standard deviation σ satisfy the condition σ=σt. Since each of the first count model coefficient a₁, the second count model coefficient a₂, and the third count model coefficient a₃ are obtained as constants, the basic noise standard deviation is determined by substituting the value of the count number of the radiographic image of the subject into the term of the count number N. Since the basic noise standard deviation and the noise standard deviation are equal, the value of the noise standard deviation suitable for NLM filter processing for the radiographic image of the subject is determined by determining the basic noise standard deviation. Therefore, the calculation required to calculate the noise standard deviation can be simplified and shortened.

### (Item 16)

Further, in the image processing apparatus as recited in the above-described Item 14,
the standard deviation calculation unit includes:
a basic noise standard deviation calculation unit configured to calculate the basic noise standard deviation in the radiographic image of the subject by substituting the count number in the subject area into a basic noise standard deviation function acquired in advance as a function in which a value of the count number and a value of the basic noise standard deviation correspond to each other;

a correction value calculation unit configured to calculate a standard deviation correction value in the radiographic image of the subject by substituting a parameter value of the reconstruction processing in the reconstruction processing into a standard deviation correction function acquired in advance as a function in which the parameter value of the reconstruction processing and the standard deviation correction value correspond to each other; and
a correction arithmetic unit configured to calculate the noise standard deviation in the radiographic image of the subject by correcting the basic noise standard deviation in the radiographic image of the subject calculated by the basic noise standard deviation calculation unit, using the standard deviation correction value in the radiographic image of the subject calculated by the basic noise standard deviation calculation unit.

According to the image processing apparatus as recited in the above-described Item 16, the value obtained by correcting the basic noise standard deviation is calculated as the noise standard deviation. In other words, in addition to the basic noise standard deviation function, a standard deviation correction function is acquired in advance. The standard deviation correction function is a function in which the parameter value of the reconstruction processing and the standard deviation correction value correspond to each other.

By substituting the parameter value of the reconstruction processing to be performed on the radiographic image of the subject into the standard deviation correction function, the correction value calculation unit calculates the standard deviation correction value in the radiographic image of the subject. The correction arithmetic unit calculates the noise standard deviation in the radiographic image of the subject by correcting the basic noise standard deviation with the standard deviation correction value.

In this configuration, not only the count number, which varies with the imaging conditions but also the parameter value of the reconstruction processing, which vary according to the reconstruction processing condition, is included as a factor for calculating the noise standard deviation. Therefore, not only when the imaging condition of the radiographic image changes but also when the reconstruction processing condition of the radiographic image changes, the noise standard deviation value appropriate for the radiographic image generated under the changed reconstruction processing condition can be quickly calculated. Therefore, even in cases where the reconstruction processing condition is frequently changed, the NLM filter processing with high accuracy can be performed quickly.

### (Item 17)

Further, in the image processing apparatus as recited in the above-described Item 16,
the standard deviation correction function includes a first correction function acquired in advance as a function in which the iteration number in the reconstruction processing and a first standard deviation correction value correspond to each other,
the correction value calculation unit calculates the first standard deviation correction value in the radiographic image of the subject by substituting the iteration number in the reconstruction processing into the first correction function, and
the correction arithmetic unit calculates the noise standard deviation in the radiographic image of the subject by correcting the basic noise standard deviation in the radiographic image of the subject calculated by the basic noise standard deviation calculation unit using the first standard deviation correction value in the radiographic image of the subject.

According to the image processing apparatus as recited in Item 17, the standard deviation correction function acquired in advance includes the first correction function. The first correction function is a function in which the number of iterations in the reconstruction processing and the first standard deviation correction value correspond to each other. In this case, the basic noise standard deviation is corrected according to the iteration number value in the reconstruction processing, and the noise standard deviation is calculated. Therefore, even in cases where the iteration number in the reconstruction processing of the radiographic image of the subject changes, the noise standard deviation value appropriate for the NLM filter processing corresponding to the iteration number after the change is calculated. That is, even in cases where a radiographic image is newly generated while changing the iteration number in the reconstruction processing, the NLM filter processing for the new radiographic image can be performed quickly and accurately.

### (Item 18)

Further, in the image processing apparatus as recited in claim 17,
the basic noise standard deviation σt in the basic noise deviation function is calculated by the following Formula (1)

σₜ=a₁*N^{a}^{₂}+a₃ (1)

using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of a plurality of function calculation radiographic images acquired in advance and the noise standard deviation,
the first standard deviation correction value f₁ is calculated by the following Formula (2)

$${f}_{1} = {b}_{1} * {log}_{2} ( \frac{i}{{i}^{base}} ) + {b}_{2} \qquad ( 2 )$$

using the iteration number i in the reconstruction processing for radiographic data of the subject, a reference iteration number i_{base} determined in advance, a first iteration number model coefficient b₁, and a second iteration number model coefficient b₂, the first iteration number model coefficient b₁ and the second iteration number model coefficient b₂ being acquired from a relation between the iteration number in the reconstruction processing for the plurality of function calculation radiographic images acquired in advance and the first standard deviation correction value, and
the noise standard deviation σ in the noise reduction processing unit satisfies a condition expressed by the following Formula (3).

σ=σₜ*f₁ (3)

According to the image processing apparatus as recited in the above-described Item 18, the basic noise standard deviation σt is calculated using the basic noise deviation function expressed by Formula (1). The basic noise deviation function is a function with the count number N as a variable, and the slope of the term of the count number N, the order of the term of the count number N, and the y-intercept are specified by the first count model coefficient a₁, the second count model coefficient a₂, and the third count model coefficient a₃. Therefore, by using Formula (1), the basic noise deviation function can be determined appropriately even if the count number and the noise standard deviation in each of the function calculation radiographic images are any value. By substituting the value of the count number in the radiographic image of the subject into the term of the count number N in the basic noise deviation function, the basic noise standard deviation σt can be quickly determined.

The first standard deviation correction value f₁ is calculated using the first correction function expressed by Formula (2). The first correction function is a function with the iteration number i as a variable, and the slope of the term including iteration number i and the y-intercept are specified by the first iteration number model coefficient b₁ and the second iteration number model coefficient b₂. Therefore, by using Formula (2), the first standard deviation correction value can be determined appropriately even if the iteration number and the noise standard deviation in each function calculation radiographic image are any value. By substituting the value of the iteration number in the radiographic image of the subject into the term of the iteration number i in the first correction function, the first standard deviation correction value f₁ can be quickly determined.

The value of the noise standard deviation σ is calculated by Formula (3) using the basic noise standard deviation σt and the first standard deviation correction value f₁. Therefore, by determining the basic noise standard deviation σt and the first standard deviation correction value f₁, the noise standard deviation σ value suitable for the NLM filter processing for the radiographic image of the subject is determined. Therefore, the calculation required to calculate the noise standard deviation can be simplified and shortened.

### (Item 19)

Further, in the image processing apparatus as recited in the above-described Item 16,
the standard deviation correction function includes a second correction function acquired in advance as a function in which the subset number in the reconstruction processing and a second standard deviation correction value correspond to each other,
the correction value calculation unit calculates the second standard deviation correction value in the radiographic image of the subject by substituting the subset number in the reconstruction processing into the second correction function, and
the correction arithmetic unit calculates the noise standard deviation in the radiographic image of the subject by correcting the basic noise standard deviation in the radiographic image of the subject calculated by the basic noise standard deviation calculation unit using the second standard deviation correction value in the radiographic image of the subject.

According to the image processing apparatus as recited in the above-described Item 19, the standard deviation correction function acquired in advance includes the second correction function. The second correction function is a function in which the subset number in the reconstruction processing and the second standard deviation correction value correspond to each other. In this case, the basic noise standard deviation is corrected according to the subset number in the reconstruction processing, and the noise standard deviation is calculated. Therefore, even in cases where the subset number in the reconstruction processing of the radiographic image of the subject changes, the noise standard deviation value appropriate for the NLM filter processing corresponding to the subset number after such change is calculated. That is, even in cases where a radiographic image is newly generated while changing the subset number in the reconstruction processing, the NLM filter processing for the new radiographic image can be performed quickly and precisely.

### (Item 20)

Further, in the image processing apparatus as recited in the above-described Item 19,
the basic noise standard deviation σt in the basic noise deviation function is calculated by the following Formula (1)

σₜ=a₁*N^{a}^{₂}+a₃ (1)

using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of radiographic images acquired in advance and the noise standard deviation,
the second standard deviation correction value f₂ is calculated by the following Formula (4)

$${f}_{2} = {c}_{1} * {log}_{2} ( \frac{s}{{s}^{base}} ) + {c}_{2} \qquad ( 4 )$$

using the subset number s in the reconstruction processing for radiographic data of the subject, a reference subset number s_{base} determined in advance, a first subset model coefficient c₁, and a second subset model coefficient c₂, the first subset model coefficient c₁ and the second subset model coefficient c₂ being acquired from a relation between the subset number in the reconstruction processing for the plurality of function calculation radiographic images acquired in advance and a second standard deviation correction value, and
the noise standard deviation σ in the noise reduction processing unit satisfies a condition expressed by the following Formula (5).

σ=σₜ*f₂ (5)

According to the image processing apparatus as recited in the above-described Item 20, the basic noise standard deviation σt is calculated using the basic noise deviation function expressed by Formula (1). The basic noise deviation function is a function with the count number N as a variable, and the slope of the term of the count number N, the order of the term of the count number N, and the y-intercept are specified by the first count model coefficient a₁, the second count model coefficient a₂, and the third count model coefficient a₃. Therefore, by using Formula (1), the basic noise deviation function can be determined appropriately even if the count number in each function calculation radiographic image and the noise standard deviation are any value. By substituting the value of the count number in the radiographic image of the subject into the term of the count number N in the basic noise deviation function, the basic noise standard deviation σt can be quickly determined.

The second standard deviation correction value f₂ is calculated using the second correction function expressed by Formula (4). The second correction function is a function with the subset number s as a variable, and the slope and y-intercept of the term including the subset number s are specified by the first subset model coefficient c₁ and the second subset model coefficient c₂. Therefore, by using Formula (4), the second standard deviation correction value can be determined appropriately even if the subset number and the noise standard deviation in each of the function calculation radiographic images are any value. By substituting the value of the subset number in the radiographic image of the subject into the term of the subset number s in the second correction function, the second standard deviation correction value f₂ can be quickly determined.

The value of the noise standard deviation σ is calculated by Formula (5) using the basic noise standard deviation σt and the second standard deviation correction value f₂. Therefore, by determining the basic noise standard deviation σt and the second standard deviation correction value f₂, the appropriate noise standard deviation σ value for the NLM filter processing for the radiographic image of the subject is determined. Therefore, the calculation required to calculate the noise standard deviation can be simplified and shortened.

### (Item 21)

Further, in the image processing apparatus as recited in the above-described Item 16,
the standard deviation correction function includes a third correction function acquired in advance as a function in which a relaxation parameter in the reconstruction processing and a third standard deviation correction value correspond to each other,
the correction value calculation unit calculates the third standard deviation correction value in the radiographic image of the subject by substituting the relaxation parameter in the reconstruction processing into the third correction function, and
the correction arithmetic unit calculates the noise standard deviation in the radiographic image of the subject by correcting the basic noise standard deviation in the radiographic image of the subject calculated by the basic noise standard deviation calculation unit using the third standard deviation correction value in the radiographic image of the subject.

According to the image processing apparatus as recited in the above-described Item 21, the standard deviation correction function acquired in advance includes a third correction function. The third correction function is a function in which the relaxation parameter in the reconstruction processing and the third standard deviation correction value correspond to each other. In this case, the basic noise standard deviation is corrected according to the relaxation parameter in the reconstruction processing, and the noise standard deviation is calculated. Therefore, even in cases where the relaxation parameter in the reconstruction processing of the radiographic image of the subject is changed, the noise standard deviation value appropriate for the NLM filter processing corresponding to the relaxation parameter after the change is calculated. That is, even in cases where a radiographic image is newly generated while changing the relaxation parameter in the reconstruction processing, the NLM filter processing for the new radiographic image can be performed quickly and precisely.

### (Item 22)

Further, in the image processing apparatus as recited in the above-described Item 21,
the basic noise standard deviation σt in the basic noise deviation function is calculated by the following Formula (1)

σₜ=a₁*N^{a}^{₂}=a₃ (1)

using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of function calculation radiographic images acquired in advance and the noise standard deviation,
the third standard deviation correction value f₃ is calculated by the following Formula (6)

$${f}_{3} = {d}_{1} * {log}_{2} ( \frac{r}{{r}^{base}} ) + {d}_{2} \qquad ( 6 )$$

using the relaxation parameter r in the reconstruction processing for radiographic data of the subject, a reference relaxation parameter r_{base} determined in advance, a first relaxation parameter model coefficient d₁, and a second relaxation parameter model coefficient d₂, the first relaxation parameter model coefficient d₁ and the second relaxation parameter model coefficient d₂ being acquired from a relation between the relaxation parameter in the reconstruction processing for the plurality of function calculation radiographic images acquired in advance and the third standard deviation correction value, and
the noise standard deviation σ in the noise reduction processing unit satisfies a condition expressed by the following Formula (7).

σ=σₜ*f₃ (7)

According to the image processing apparatus as recited in the above-described Item 22, the basic noise standard deviation σt is calculated using the basic noise deviation function expressed by Formula (1). The basic noise deviation function is a function with the count number N as a variable, and the slope of the term of the count number N, the order of the term of the count number N, and the y-intercept are specified by the first count model coefficient a₁, the second count model coefficient a₂, and the third count model coefficient a₃. Therefore, by using Formula (1), the basic noise deviation function can be determined appropriately even if the count number and the noise standard deviation in each of the function calculation radiographic images are any value. By substituting the value of the count number in the radiographic image of the subject into the term of the count number N in the basic noise deviation function, the basic noise standard deviation σt can be quickly determined.

The third standard deviation correction value f₃ is calculated using the third correction function expressed by Formula (6). The third correction function is a function with the relaxation parameter r as a variable, and the slope of the term including the relaxation parameter r and the y-intercept are specified by the first relaxation parameter model coefficient d₁ and the second relaxation parameter model coefficient d₂. Therefore, by using Formula (6), the third standard deviation correction value can be determined appropriately even if the relaxation parameter and the noise standard deviation in each function calculation radiographic image are any value. By substituting the relaxation parameter of the radiographic image of the subject into the term of the relaxation parameter r in the third correction function, the third standard deviation correction value f₃ can be quickly determined.

The value of the noise standard deviation σ is calculated by formula (7) using the basic noise standard deviation σt and the third standard deviation correction value f₃. Therefore, by determining the basic noise standard deviation σt and the third standard deviation correction value f₃, the appropriate noise standard deviation σ value for the NLM filter processing for the radiographic image of the subject is determined. Therefore, the calculation required to calculate the noise standard deviation can be simplified and shortened.

### (Item 23)

Further, in the image processing apparatus as recited in the above-described Item 16,
the standard deviation correction function includes a fourth correction function acquired in advance as a function in which a voxel size in the reconstruction processing and a fourth standard deviation correction value correspond to each other,
the correction value calculation unit calculates the fourth standard deviation correction value in the radiographic image of the subject by substituting the voxel size in the reconstruction processing into the fourth correction function, and
the correction arithmetic unit calculates the noise standard deviation in the radiographic image of the subject by correcting the basic noise standard deviation in the radiographic image of the subject calculated by the basic noise standard deviation calculation unit using the fourth standard deviation correction value in the radiographic image of the subject.

According to the image processing apparatus as recited in the above-described Item 23, the standard deviation correction function acquired in advance includes a fourth correction function. The fourth correction function is a function in which the voxel size in the reconstruction processing and the fourth standard deviation correction value correspond to each other. In this case, the basic noise standard deviation is corrected according to the voxel size in the reconstruction processing, and the noise standard deviation is calculated. Therefore, even in cases where the voxel size in the reconstruction processing of the radiographic image of the subject changes, the noise standard deviation value appropriate for the NLM filter processing corresponding to the voxel size after the change is calculated. That is, even in cases where a radiographic image is newly generated while changing the voxel size in the reconstruction processing, the NLM filter processing for the new radiographic image can be performed quickly and accurately.

### (Item 24)

Further, in the image processing apparatus as recited in the above-described Item 23,
the basic noise standard deviation σt in the basic noise deviation function is calculated by the following Formula (1)

σₜ=a₁*N^{a}^{₂}+a₃ (1)

using the count number N in the subject area, a first count model coefficient a₁, a second count model coefficient a₂, and a third count model coefficient a₃, the first count model coefficient a₁, the second count model coefficient a₂, and the third count model coefficient a₃, being acquired from a relation between the count number in each of the plurality of function calculation radiographic images of the subject acquired in advance and the noise standard deviation,
the fourth standard deviation correction value f₄ is calculated by the following Formula (8)

$${f}_{4} = {e}_{1} * ( \frac{v}{{v}^{base}} ) + e 3 \qquad ( 8 )$$

using a voxel size v in the reconstruction processing for radiographic data of the subject, a reference voxel size v_{base} determined in advance, a first voxel size model coefficient e₁, a second voxel size model coefficient e₂, and a third voxel size model coefficient e₃, the first voxel size model coefficient e₁, the second voxel size model coefficient e₂, and the third voxel size model coefficient e₃ being acquired from a relation between the reference voxel size in the reconstruction processing for the plurality of function calculation radiographic images acquired in advance and the fourth standard deviation correction value, and
the noise standard deviation σ in the noise reduction processing unit satisfies a condition expressed by the following Formula (9)

σ=σₜ*f₄ (9)

According to the image processing apparatus as recited in the above-described in Item 24, the basic noise standard deviation σt is calculated using the basic noise deviation function expressed by Formula (1). The basic noise deviation function is a function with the count number N as a variable, and the slope of the term of the count number N, the order of the term of the count number N, and the y-intercept are specified by the first count model coefficient a₁, the second count model coefficient a₂, and the third count model coefficient a₃. Therefore, by using Formula (1), the basic noise deviation function can be determined appropriately even if the count number and the noise standard deviation in each of the function calculation radiographic images are any value. By substituting the value of the count number in the radiographic image of the subject into the term of the count number N in the basic noise deviation function, the basic noise standard deviation σt can be quickly determined.

The fourth standard deviation correction value f₄ is calculated using the fourth correction function expressed by Formula (8). The fourth correction function is a function with the voxel size v as a variable, and the slope of the term including the voxel size v, the order of the term including the voxel size v, and the y-intercept are specified by the first relaxation parameter model coefficient d₁ and the second relaxation parameter model coefficient d₂. Therefore, by using Formula (8), the fourth standard deviation correction value can be determined appropriately even if the voxel size and the noise standard deviation in each of the function calculation radiographic images are any value. By substituting the voxel size of the subject's radiographic image into the voxel size v term in the fourth correction function, the fourth standard deviation correction value f₄ can be quickly determined.

The value of the noise standard deviation σ is calculated by Formula (9) using the basic noise standard deviation σt and the fourth standard deviation correction value f₄. Therefore, when the basic noise standard deviation σt and the fourth standard deviation correction value f₄ are determined, the appropriate noise standard deviation σ value for the NLM filter processing for the radiographic image of the subject is determined. Therefore, the calculation required to calculate the noise standard deviation can be simplified and shortened.

### (Item 25)

Further, in the image processing apparatus as recited in the above-described Item 16,
the standard deviation correction function includes
a first correction function acquired in advance as a function in which an iteration number in the reconstruction processing and a first standard deviation correction value correspond to each other,
a second correction function acquired in advance as a function in which the subset number in the reconstruction processing and a second standard deviation correction value correspond to each other,
a third correction function acquired in advance as a function in which a relaxation parameter in the reconstruction processing and a third standard deviation correction value correspond to each other, and
a fourth correction function acquired in advance as a function in which a voxel size in the reconstruction processing and a fourth standard deviation correction value correspond to each other,
the correction value calculation unit
calculates a first standard deviation correction value in the radiographic image of the subject by substituting the iteration number in the reconstruction processing into the first correction function,
calculates a second standard deviation correction value in the radiographic image of the subject by substituting the subset number in the reconstruction processing into the second correction function,
calculates a third standard deviation correction value in the radiographic image of the subject by substituting a relaxation parameter in the reconstruction processing into the third correction function, and
calculates a fourth standard deviation correction value in the radiographic image of the subject by substituting a voxel size in the reconstruction processing into the fourth correction function, and
the correction arithmetic unit calculates the noise standard deviation in the radiographic image of the subject by correcting the basic noise standard deviation in the radiographic image of the subject calculated by the basic noise standard deviation calculation unit using the first standard deviation correction value, the second standard deviation correction value, the third standard deviation correction value, and the fourth standard deviation correction value in the radiographic image of the subject.

According to the image processing apparatus as recited in the above-described Item 25, the standard deviation correction functions acquired in advance include the first correction function, the second correction function, the third correction function, and the fourth correction function. The first correction function is a function in which the number of iterations in the reconstruction processing and the first standard deviation correction value correspond to each other. The second correction function is a function in which the subset number in the reconstruction processing and the second standard deviation correction value correspond to each other. The third correction function is a function in which the relaxation parameter in the reconstruction processing and the third standard deviation correction value correspond to each other. The fourth correction function is a function in which the voxel size in the reconstruction processing and the fourth standard deviation correction value correspond to each other.

In this case, the basic noise standard deviation is corrected and the noise standard deviation is calculated according to the iteration number, the subset number, the relaxation parameter, and the voxel size in the reconstruction processing. Therefore, even in cases where various parameter values, such as, e.g., the iteration number in the reconstruction processing of the radiographic image of the subject, are changed, the noise standard deviation value appropriate for the NLM filter processing corresponding to each parameter value after the change is calculated. That is, even in cases where a radiographic image is newly generated while changing various parameter values in the reconstruction process, the NLM filter processing for the new radiographic image can be performed quickly and accurately.

### (Item 26)

Further, in the image processing apparatus as recited in the above-described Item 25,
a basic noise deviation function in the basic noise deviation σt is calculated by the following Formula (1)

σₜ=a₁*N^{a}^{₂}+a₃ (1)

using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of function calculation radiographic images of the subject acquired in advance and the noise standard deviation,
the first standard deviation correction value f₁ is calculated by the following Formula (2)

$${f}_{1} = {b}_{1} * {log}_{2} ( \frac{i}{{i}^{base}} ) + {b}_{2} \qquad ( 2 )$$

using the iteration number i in the reconstruction processing for radiographic data of the subject, a standard iteration number i_{base} determined in advance, a first iteration number model coefficient b₁, and a second iteration number model coefficient b₂, the first iteration number model coefficient b₁ and the second iteration number model coefficient b₂ being acquired from a relation between the iteration number in the reconstruction processing for the plurality of function calculation radiographic images of the subject and the first standard deviation correction value,
the second standard deviation correction value f₂ is calculated by the following Formula (4).

$${f}_{2} = {c}_{1} * {log}_{2} ( \frac{s}{{s}^{base}} ) + {c}_{2} \qquad ( 4 )$$

using the subset number s in the reconstruction processing for radiographic data of the subject, a reference subset number s_{base} predefined in advance, a first subset model coefficient c₁, a second subset model coefficient c₂, the first subset model coefficient c₁ and the second subset model coefficient c₂ being acquired from a relation between the subset number in the reconstruction processing for the plurality of function calculation radiographic images acquired in advance and the second standard correction value,
the third standard deviation correction value f₃ is calculated by the following Formula (6)

$${f}_{3} = {d}_{1} * {log}_{2} ( \frac{r}{{r}^{base}} ) + {d}_{2} \qquad ( 6 )$$

using the relaxation parameter r in the reconstruction processing for radiographic data of the subject, a reference relaxation parameter r_{base} predetermined in advance, a first relaxation parameter model coefficient d₁, and a second relaxation parameter model coefficient d₂, the first relaxation parameter model coefficient d₁ and the second relaxation parameter model coefficient d₂ being acquired from a relation between the relaxation parameter in the reconstruction processing for the plurality of function calculation radiographic images acquired in advance and the third standard deviation correction value,
the fourth standard deviation correction value f₄ is calculated by the following Formula (8)

$${f}_{4} = {e}_{1} * {log}_{2} ( \frac{v}{{v}^{base}} ) + e 3 \qquad ( 8 )$$

using the voxel size v in the reconstruction processing for radiographic data of the subject, a reference voxel size v_{base} determined in advance, a first voxel size model coefficient e₁, a second voxel size model coefficient e₂, and a third voxel size model coefficient e₃, the first voxel size model coefficient e₁, the second voxel size model coefficient e₂, and the third voxel size model coefficient e₃ being acquired from a relation between the reference voxel size in the reconstruction processing for the plurality of function calculation radiographic images acquired in advance and the fourth standard deviation correction value, and
the noise standard deviation σ in the noise reduction processing unit satisfies a condition expressed by the following Formula (10).

σ=σₜ*f₁*f₂*f₃*f₄ (10)

According to the image processing apparatus as recited in the above-described Item 26, the basic noise standard deviation σt is calculated using the basic noise deviation function expressed by Formula (1). The basic noise deviation function is a function with the count number N as a variable, and the slope of the term of the count number N, the order of the term of the count number N, and the y-intercept are specified by the first count model coefficient a₁, the second count model coefficient a₂, and the third count model coefficient a₃.

Therefore, by using Formula (1), the basic noise deviation function can be determined appropriately even if the count number and the noise standard deviation in each of the function calculation radiographic images are any value. By substituting the value of the count number in the radiographic image of the subject into the term of the count number N in the basic noise deviation function, the basic noise standard deviation σt can be quickly determined.

The first standard deviation correction value f₁ is calculated using the first correction function expressed by Formula (2). The first correction function is a function with the iteration number i as a variable, and the slope of the term including iteration number i and the y-intercept are specified by the first iteration number model coefficient b₁ and the second iteration number model coefficient b₂. Therefore, by using Formula (2), the first standard deviation correction value can be determined appropriately even if the iteration number and the noise standard deviation in each function calculation radiographic image are any value. By substituting the iteration number in the radiographic image of the subject into the term for the iteration number i in the first correction function, the first standard deviation correction value f₁ can be quickly determined.

The second standard deviation correction value f₂ is calculated using the second correction function expressed by Formula (4). The second correction function is a function with the subset number s as a variable, and the slope and y-intercept of the term including the subset number s are specified by the first subset model coefficient c₁ and the second subset model coefficient c₂. Therefore, by using Formula (4), the second standard deviation correction value can be determined appropriately even if the subset number and the noise standard deviation in each of the function calculation radiographic images are any value. By substituting the value of the subset number in the radiographic image of the subject into the term for the subset number s in the second correction function, the second standard deviation correction value f₂ can be quickly determined.

The third standard deviation correction value f₃ is calculated using the third correction function expressed by Formula (6). The third correction function is a function with the relaxation parameter r as a variable, and the slope of the term including the relaxation parameter r and the y-intercept are specified by the first relaxation parameter model coefficient d₁ and the second relaxation parameter model coefficient d₂. Therefore, by using Formula (6), the third standard deviation correction value can be determined appropriately even if the relaxation parameter and the noise standard deviation in each function calculation radiographic image are any value. By substituting the relaxation parameter of the radiographic image of the subject into the term of the relaxation parameter r in the third correction function, the third standard deviation correction value f₃ can be quickly determined.

The fourth standard deviation correction value f₄ is calculated using the fourth correction function expressed by Formula (8). The fourth correction function is a function with the voxel size v as a variable, and the slope of the term including the voxel size v, the order of the term including the voxel size v, and the y-intercept are specified by the first relaxation parameter model coefficient d₁ and the second relaxation parameter model coefficient d₂. Therefore, by using Formula (8), the fourth standard deviation correction value can be determined appropriately even if the voxel size and the noise standard deviation in each of the function calculation radiographic images are any value. By substituting the voxel size of the radiographic image of the subject into the term of the voxel size v in the fourth correction function, the fourth standard deviation correction value f₄ can be quickly determined.

The value of the noise standard deviation σ is calculated by Formula (10) using the basic noise standard deviation σt, the first standard deviation correction value f₁, the second standard deviation correction value f₂, the third standard deviation correction value f₃, and the fourth standard deviation correction value f₄. Therefore, when the basic noise standard deviation σt, the first standard deviation correction value f₁, the second standard deviation correction value f₂, the third standard deviation correction value f₃, and the fourth standard deviation correction value f₄ are determined, the noise standard deviation σ value suitable for the NLM filter processing for the radiographic image of the subject is determined. Therefore, the calculation required to calculate the noise standard deviation can be simplified and shortened.

### (Item 27)

A nuclear medicine diagnostic apparatus comprises:
a radiation detector configured to detect radiation transmitted through a subject and output radiation data; and
the image processing apparatus as recited in any one of the above-described Items 14 to 26.

According to the nuclear medicine diagnostic apparatus as recited in the above-described Item 27, the basic noise deviation function, which is a function in which the value of the count number and the value of the noise standard deviation correspond, is acquired in advance in the image processing apparatus. The basic noise deviation function is obtained from the relation between the count number and the basic noise standard deviation in each of the previously acquired function calculation radiographic images. After reconstructing the radiographic image of the subject in the reconstruction processing unit, the count number calculation unit calculates the count number in the subject area in the radiographic image of the subject.

By substituting the count number calculation unit of the subject area into the basic noise deviation function, the standard deviation calculation unit calculates the noise standard deviation in the radiographic image of the subject. Since the basic noise deviation function is a function in which the value of the count number and the value of the noise standard deviation correspond, the appropriate noise standard deviation value for a radiographic image of the subject can be quickly calculated by substituting the count number in the subject area into the basic noise standard deviation function. Since the value of the noise standard deviation can be specified by a simple operation of substituting the count number into the basic noise deviation function acquired in advance, the time required to specify the noise standard deviation can be greatly reduced, and the burden on the user can be reduced.

The noise reduction processing unit performs NLM filter processing using the noise standard deviation calculated by the standard deviation calculation unit. Since the standard deviation calculation unit determines the noise standard deviation parameters appropriate for NLM filter processing, the accuracy of the NLM filter processing performed by the noise reduction processing unit can be improved.

### Other Examples

Note that the examples disclosed here are in all respects illustrative and not restrictive. The scope of the present invention includes the claims and all modifications within the meaning and scope equivalent to the claims. As an example, the present invention can be modified and implemented as follows.

(1) In each of the above-described examples, the method of estimating the basic noise standard deviation model Pa is not limited to the method of generating a scatter diagram V. In other words, any method may be used as long as the basic noise standard deviation model Pa can be estimated as a model (function) that can identify the basic noise standard deviation σt by identifying the value of the count number N. Further, in the scatter diagram V, it is not limited to the configuration in which the count number N corresponds to the x-axis, and the noise standard deviation σ corresponds to the y-axis. In the scatter diagram V, the parameter corresponding to the x-axis and the parameter corresponding to the y-axis may be changed as needed. This applies to the method of estimating the correction noise standard deviation models Pb-Pe in the same manner and is not limited to the method of generating scatter diagrams VA to VD. Further, in the scatter diagrams VA to VD, the parameters corresponding to the x-axis and the parameters corresponding to the y-axis may be changed as needed.

(2) In the above-described Example 6, the feature in which all of Examples 2 to 5 are combined was described, but it may be a feature in which some of Examples to 5 are combined. As an example, the feature may be a combination of Example 2 and Example 4.

In the case of the feature in which Example 2 and Example 4 are combined, the iteration number i and the relaxation parameter r are used as the parameter values for the reconstruction processing. In the configuration in which Examples 2 and 4 are combined, the processes in Steps SA3 to SA4 and Steps SA7 to SA8 are omitted in the flowchart according to Step SA of Example 6, shown in FIG. 14. In the flowchart for Step S6 in Example 6 shown in FIG. 15, Steps S6C and S6E are omitted.

(3) In each of the above-described Examples, the model estimation image group L is not limited to an image of the phantom F as a subject. In each image constituting of the model estimation image group L, a living subject, for example the subject M, or an object other than the phantom F, may be used as the subject.

(4) In the above-described Examples, the detection unit 7 has a structure of five detector rings 9 stacked in the x-direction, but the number of detector rings 9 arranged in the x-direction may be changed as needed. The detector ring 9 may have a configuration composed of a single layer about the x-direction, or two or more detector rings 9 may be stacked in the x-direction.

(5) In the above-described Example, a PET apparatus was described as an example of a nuclear medicine diagnostic device, but it is not limited to a PET apparatus as long as it is a device that generates radiographic images G by reconstruction processing. As an example, it can be applied to a SPECT device (SPECT: Single Photon Emission Computed Tomography), etc.

### Description of Reference Symbols

1 . . . PET apparatus
2 . . . Top board
3 . . . Bed apparatus
4 . . . Opening
5 . . . Gantry
7 . . . Detector
9 . . . Detector ring
11 . . . Radiation detector
13 . . . Data acquisition unit
15 . . . Image processing apparatus
17 . . . Image generation unit
19 . . . Input unit
21 . . . Display unit
23 . . . Storage unit
25 . . . Model estimation unit
27 . . . Reconstruction processing unit
29 . . . Counts calculation unit
31 . . . Standard deviation calculation unit
33 . . . Noise reduction processing unit
35 . . . Basic model estimation unit
37 . . . Correction model estimation unit
39 . . . Reconstruction value calculation unit
41 . . . Basic deviation calculation unit
43 . . . Correction value calculation unit
45 . . . Correction arithmetic unit
M . . . Subject
F . . . Phantom
P . . . Noise deviation model
Pa . . . Basic noise deviation model
Pb . . . Correction noise deviation model
Pc . . . Correction noise deviation model
Pd . . . Correction noise deviation model
Pe . . . Correction noise deviation model
f . . . Standard deviation correction value
N . . . Count number
G . . . Reconstructed image
H . . . Noise reduced image
L . . . Model estimation image group
i . . . Iteration number
s . . . Sub set number
r . . . Relaxation parameter
v . . . Voxel size

1. An image processing method comprising:
a reconstruction step of reconstructing a radiographic image of a subject by performing reconstruction processing on radiological data of the subject;
a count number calculation step of calculating a count number in a subject area in the radiographic image of the subject;
a standard deviation calculation step of calculating a noise standard deviation in the radiographic image of the subject from a relation between the count number in each of a plurality of function calculation radiographic images acquired in advance and the noise standard deviation, by substituting the count number in the subject area into a basic noise deviation function acquired in advance as a function in which a value of the count number and a value of the noise standard deviation correspond to each other; and
a noise reduction processing step of performing NLM filter processing on the radiographic image of the subject, using the noise standard deviation calculated in the standard deviation calculation step.

2. The image processing method as recited in claim 1,
wherein a basic noise standard deviation σt in the basic noise deviation function is calculated by a following Formula (1)
σₜ=a₁*N^{a}^{₂}+a₃ (1)
using the count number N in the subject area, and a first count model coefficient a₁, a second count model coefficient a₂, and a third count model coefficient a₃, the first count model coefficient a₁, the second count model coefficient a₂, and the third count model coefficient a₃ being obtained from a relation between the count number in each of the plurality of function calculation radiographic images acquired in advance and the noise standard deviation, and
wherein the noise standard deviation σ in the noise reduction processing step satisfies a condition of σ=σt.

3. The image processing method as recited in claim 1,
wherein the standard deviation calculation step comprises:
a basic noise standard deviation calculation step of calculating a basic noise standard deviation in the radiographic image of the subject by substituting the count number in the subject area into the basic noise deviation function acquired in advance as a function in which a value of the count number and a value of the basic noise standard deviation correspond to each other;
a correction value calculation step of calculating a standard deviation correction value in the radiographic image of the subject by substituting a parameter value of the reconstitution processing in the reconstitution step into a standard deviation correction function acquired in advance as a function in which the parameter value of the reconstruction processing and the standard deviation correction value correspond to each other; and
a correction arithmetic step of calculating the noise standard deviation in the radiographic image of the subject calculated in the basic noise standard deviation calculation step by correcting the basic noise standard deviation in the radiographic image of the subject by using the standard deviation correction value in the radiographic image of the subject calculated in the correction value calculation step.

4. The image processing method as recited in claim 3,
wherein the standard deviation correction function includes a first correction function acquired in advance as a function in which an iteration number in the reconstruction processing and a first standard deviation correction value correspond to each other,
wherein the correction value calculation step calculates the first standard deviation correction value in the radiographic image of the subject by substituting the iteration number in the reconstruction processing into the first correction function, and
wherein the correction arithmetic step calculates the noise standard deviation in the radiographic image of the subject by correcting the basic noise standard deviation in the radiographic image of the subject calculated in the basic noise standard deviation calculation step using the first standard deviation correction value in the radiographic image of the subject.

5. The image processing method as recited in claim 4,
wherein the basic noise standard deviation σt in the basic noise deviation function is calculated by the following Formula (1)
σₜ=a₁*N^{a}^{₂}+a₃ (1)
using the count number N in the subject area, and a first count model coefficient a₁, a second count model coefficient a₂, and a third count model coefficient a₃, the first count model coefficient a₁, the second count model coefficient a₂, and the third count model coefficient a₃ being acquired from a relation between the count value in each of the plurality of radiographic images acquired in advance and the noise standard deviation,
wherein the first standard deviation correction value f₁ is calculated from the following Formula (2)
$${f}_{1} = {b}_{1} * {log}_{2} ( \frac{i}{{i}^{base}} ) + {b}_{2} \qquad ( 2 )$$
using an iteration number i in the reconstruction processing for radiographic data of the subject, a reference iteration number i_{base} determined in advance, a first iteration number model coefficient b₁, and a second iteration number model coefficient b₂, the first iteration number model coefficient b₁ and the second iteration number model coefficient b₂ being acquired from a relation between the iteration number in the reconstruction processing of the plurality of function calculation radiographic images acquired in advance and the first standard deviation correction value, and
wherein the noise standard deviation σ in the noise reduction processing step satisfies a condition expressed by the following Formula (3).
σ=σₜ*f₁ (3)

6. The image processing method as recited in claim 3,
wherein the standard deviation correction function includes a second correction function acquired in advance as a function in which the subset number in the reconstruction processing and a second standard deviation correction value correspond to each other,
wherein the correction value calculation step calculates a second standard deviation correction value in the radiographic image of the subject by substituting a subset number in the reconstruction processing into the second correction function, and
wherein the correction arithmetic step calculates the noise standard deviation in the radiographic image of the subject by correcting the basic noise standard deviation in the radiographic image of the subject calculated in the basic noise standard deviation calculation step, using the second standard deviation correction value in the radiographic image of the subject.

7. The image processing method as recited in claim 6,
wherein the basic noise standard deviation σt in the basic noise deviation function is calculated by the following Formula (1)
σₜ=a₁*N^{a}^{₂}+a₃ (1)
using the count number N in the subject area, a first count model coefficient a₁, a second count model coefficient a₂, and a third count model coefficient a₃, the first count model coefficient a₁, the second count model coefficient a₂, and the third count model coefficient a₃ being acquired in advance from a relation between the count number in each of the plurality of function calculation radiographic images acquired in advance and the noise standard deviation,
wherein the second standard deviation correction value f₂ is calculated by the following Formula (4)
$${f}_{2} = {c}_{1} * {log}_{2} ( \frac{s}{{s}^{base}} ) + {c}_{2} \qquad ( 4 )$$
using the subset number s in the reconstruction processing for radiographic data of the subject, a reference subset number s_{base} determined in advance, a first subset model coefficient c₁, and a second subset model coefficient c₂, the first subset model coefficient c₁ and the second subset model coefficient c₂ being acquired from a relation between the subset number in the reconstruction processing for the plurality of function calculation radiographic images acquired in advance and the second standard model coefficient, and
wherein the noise standard deviation σ in the noise reduction step satisfies a condition expressed by the following Formula (5).
σ=σₜ*f₂ (5)

8. The image processing method as recited in claim 3,
wherein the standard deviation correction function includes a third correction function acquired in advance as a function in which a relaxation parameter in the reconstruction processing and a third standard deviation correction value correspond to each other,
wherein the correction value calculation step calculates a third standard deviation correction value in the radiographic image of the subject by substituting the relaxation parameter in the reconstruction processing into the third correction function, and
wherein the correction arithmetic step calculates the noise standard deviation in the radiographic image of the subject by correcting the basic noise standard deviation in the radiographic image of the subject calculated in the basic noise standard deviation calculation step, using the third standard deviation correction value in the radiographic image of the subject.

9. The image processing method as recited in claim 8,
wherein the basic noise standard deviation σt in the basic noise deviation function is calculated by the following Formula (1)
σₜ=a₁*N^{a}^{₂}+a₃ (1)
using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of function calculation radiographic images acquired in advance and the noise standard deviation,
wherein the third standard deviation correction value f₃ is calculated by the following Formula (6)
$${f}_{3} = {d}_{1} * {log}_{2} ( \frac{r}{{r}^{base}} ) + {d}_{2} \qquad ( 6 )$$
using the relaxation parameter r in the reconstruction processing for the radiographic data of the subject, a reference relaxation parameter r_{base} predetermined in advance, a first relaxation parameter model coefficient d₁, and a second relaxation parameter model coefficient d₂, the first relaxation parameter model coefficient d₁ and the second relaxation parameter model coefficient d₂ being acquired in advance from a relation between the relaxation parameter in the reconstruction processing for the plurality of function calculation radiographic images acquired in advance and the third standard deviation correction value, and
wherein the noise standard deviation σ in the noise reduction processing step satisfies a condition expressed by the following Formula (7).
σ=σₜ*f₃ (7)

10. The image processing method as recited in claim 3,
wherein the standard deviation correction function includes a fourth correction function acquired in advance as a function in which a voxel size in the reconstruction processing and a fourth standard deviation correction value corresponds to each other,
wherein the correction value calculation step calculates a fourth standard deviation correction value in the radiographic image of the subject by substituting the voxel size in the reconstruction processing into the fourth correction function, and
wherein the correction arithmetic step calculates the noise standard deviation in the radiographic image of the subject by correcting the basic noise standard deviation in the radiographic image of the subject calculated in the basic noise standard deviation calculation step, using the fourth standard deviation correction value in the radiographic image of the subject.

11. The image processing method as recited in claim 10,
wherein the basic noise standard deviation σt in the basic noise deviation function is calculated by the following Formula (1)
σₜ=a₁*N^{a}^{₂}+a₃ (1)
using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of function calculation radiographic images acquired in advance and the noise standard deviation,
wherein the fourth standard deviation correction value f₄ is calculated by the following Formula (8)
$${f}_{4} = {e}_{1} * {( \frac{v}{{v}^{base}} )}^{e 2} + e 3 \qquad ( 8 )$$
using the voxel size v in the reconstruction processing for the radiographic data of the subject, a reference voxel size v_{base} predetermined in advance, a first voxel size model coefficient e₁, a second voxel size model coefficient e₂, and a third voxel size model coefficient e₃, the first voxel size model coefficient e₁, the second voxel size model coefficient e₂, and the third voxel size model coefficient e₃ being acquired from a relation between a reference voxel size in the reconstruction processing for the plurality of function calculation radiographic images acquired in advance and the fourth standard deviation correction value, and
wherein the noise standard deviation σ in the noise reduction processing step satisfies a condition expressed by the following Formula (9).
σ=σₜ*f₄ (9)

12. The image processing method as recited in claim 3,
wherein the standard deviation correction function includes
a first correction function obtained in advance as a function in which the iteration number in the reconstruction processing and a first standard deviation correction value correspond to each other,
a second correction function acquired in advance as a function in which a subset number in the reconstruction processing and a second standard deviation correction value correspond to each other,
a third correction function acquired in advance as a function in which a relaxation parameter in the reconstruction processing and a third standard deviation correction value correspond to each other, and
a fourth correction function acquired in advance as a function in which a voxel size in the reconstruction processing and a fourth standard deviation correction value correspond to each other,
wherein the correction value calculation step
calculates the first standard deviation correction value in the radiographic image of the subject by substituting the iteration number in the reconstruction processing into the first correction function,
calculates the second standard deviation correction value in the radiographic image of the subject by substituting the subset number in the reconstruction processing into the second correction function,
calculates the third standard deviation correction value in the radiographic image of the subject by substituting the relaxation parameter in the reconstruction processing into the third correction function, and
calculates the fourth standard deviation correction value in the radiographic image of the subject by substituting the voxel size in the reconstruction step into the fourth correction function,
wherein the correction arithmetic step calculates the noise standard deviation in the radiographic image of the subject by correcting the basic noise standard deviation in the radiographic image of the subject calculated in the basic noise standard deviation calculation step, using the first standard deviation correction value, the second standard deviation correction value, the third standard deviation correction value, and the fourth standard deviation correction value in the radiographic image of the subject.

13. The image processing method as recited in claim 12,
wherein the basic noise standard deviation σt in the basic noise deviation function is calculated by the following Formula (1)
σₜ=a₁*N^{a}^{₂}+a₃ (1)
using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of function calculation radiographic images acquired in advance and the noise standard deviation,
wherein the first standard deviation correction value f₁ is calculated by the following Formula (2)
$${f}_{1} = {b}_{1} * {log}_{2} ( \frac{i}{{i}^{base}} ) + {b}_{2} \qquad ( 2 )$$
using the iteration number i in the reconstruction processing for radiographic data of the subject, a reference iteration number i_{base} determined in advance, a first iteration number model coefficient b₁, and a second iteration number coefficient b₂, the first iteration number model coefficient b₁ and the second iteration number coefficient b₂ being obtained from a relation between the iteration number in the reconstruction processing for a plurality of function calculation radiographic images acquired in advance and the first standard deviation correction value,
wherein the second standard deviation correction value f₂ is calculated by the following Formula (4)
$${f}_{2} = {c}_{1} * {log}_{2} ( \frac{s}{{s}^{base}} ) + {c}_{2} \qquad ( 4 )$$
using the subset number s in the reconstruction processing for the radiographic data of the subject, a reference subset number s_{base} determined in advance, a first subset number coefficient c₁, and a second subset number coefficient c₂, the first subset number coefficient c₁ and the second subset number coefficient c₂ being obtained from a relation between the subset number in the reconstruction processing for the plurality of function calculation radiographic images acquired in advance and the second standard deviation correction value,
wherein the third standard deviation correction value f₃ is calculated by the following Formula (6)
$${f}_{3} = {d}_{1} * {log}_{2} ( \frac{r}{{r}^{base}} ) + {d}_{2} \qquad ( 6 )$$
using the relaxation parameter r in the reconstruction processing for the radiographic data of the subject, a reference relaxation parameter r_{base} determined in advance, a first relaxation parameter model coefficient d₁, and a second relaxation parameter model coefficient d₂, the first relaxation parameter model coefficient d₁ and the second relaxation parameter model coefficient d₂ being acquired from a relation between the relaxation parameter in the reconstruction processing for the plurality of function calculation radiographic images acquired in advance and the third standard deviation correction value,
wherein the fourth standard deviation correction value f₄ is calculated by the following Formula (8)
$${f}_{4} = {e}_{1} * {( \frac{v}{{v}^{base}} )}^{e 2} + e3 \qquad ( 8 )$$
using the voxel size v in the reconstruction processing for the radiographic data of the subject, a reference voxel size v_{base} determined in advance, a first voxel size model coefficients e₁, a second voxel size model coefficient e₂, and a third voxel size model coefficient e₃, the first voxel size model coefficients e₁, the second voxel size model coefficient e₂, and the third voxel size model coefficient e₃ being acquired from a relation between the reference voxel size in the reconstruction processing for the plurality of function calculation radiographic images acquired in advance and the fourth standard deviation correction value, and
wherein the noise standard deviation σ in the noise reduction processing step satisfies a condition expressed by the following Formula (10).
σ=σₜ*f₁*f₂*f₃*f₄ (10)

14. An image processing apparatus comprising:
a reconstruction processing unit configured to reconstruct a radiographic image of a subject by performing reconstruction processing on radiographic data of the subject for which radiographic imaging has been performed;
a count number calculation unit configured to calculate a count number in a subject area in the radiographic image of the subject;
a standard deviation calculation unit configured to calculate a noise standard deviation in the radiographic image of the subject from a relation between the count number in each of a plurality of function calculation radiographic images acquired in advance and the noise standard deviation function by substituting the count number in the subject area into a basic noise deviation function acquired in advance as a function in which a value of the count number and a value of the noise standard deviation corresponds to each other; and
a noise reduction processing unit configured to perform NLM filter processing on the radiographic image of the subject using the noise standard deviation calculated by the standard deviation calculation unit.

15. The image processing device as recited in claim 14,
wherein a basic noise standard deviation σt in the basic noise deviation function is calculated by the following Formula (1)
σₜ=a₁*N^{a}^{₂}+a₃ (1)
using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of function calculation radiographic images acquired in advance and the noise standard deviation, and
wherein the noise standard deviation σ used in the noise reduction processing unit satisfies a condition of σ=σt.

16. The image processing apparatus as recited in claim 14,
wherein the standard deviation calculation unit includes:
a basic noise standard deviation calculation unit configured to calculate the basic noise standard deviation in the radiographic image of the subject by substituting the count number in the subject area into a basic noise standard deviation function acquired in advance as a function in which a value of the count number and a value of the basic noise standard deviation correspond to each other;
a correction value calculation unit configured to calculate a standard deviation correction value in the radiographic image of the subject by substituting a parameter value of the reconstruction processing in the reconstruction processing into a standard deviation correction function acquired in advance as a function in which the parameter value of the reconstruction processing and the standard deviation correction value correspond to each other; and
a correction arithmetic unit configured to calculate the noise standard deviation in the radiographic image of the subject by correcting the basic noise standard deviation in the radiographic image of the subject calculated by the basic noise standard deviation calculation unit, using the standard deviation correction value in the radiographic image of the subject calculated by the basic noise standard deviation calculation unit.

17. The image processing apparatus as recited in claim 16,
wherein the standard deviation correction function includes a first correction function acquired in advance as a function in which the iteration number in the reconstruction processing and a first standard deviation correction value correspond to each other,
wherein the correction value calculation unit calculates the first standard deviation correction value in the radiographic image of the subject by substituting the iteration number in the reconstruction processing into the first correction function, and
wherein the correction arithmetic unit calculates the noise standard deviation in the radiographic image of the subject by correcting the basic noise standard deviation in the radiographic image of the subject calculated by the basic noise standard deviation calculation unit using the first standard deviation correction value in the radiographic image of the subject.

18. The image processing apparatus as recited in claim 17,
wherein the basic noise standard deviation σt in the basic noise deviation function is calculated by the following Formula (1)
σₜ=a₁*N^{a}^{₂}+a₃ (1)
using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of a plurality of function calculation radiographic images acquired in advance and the noise standard deviation,
wherein the first standard deviation correction value f₁ is calculated by the following Formula (2)
$${f}_{1} = {b}_{1} * {log}_{2} ( \frac{i}{{i}^{base}} ) + {b}_{2} \qquad ( 2 )$$
using the iteration number i in the reconstruction processing for radiographic data of the subject, a reference iteration number i_{base} determined in advance, a first iteration number model coefficient b₁, and a second iteration number model coefficient b₂, the first iteration number model coefficient b₁ and the second iteration number model coefficient b₂ being acquired from a relation between the iteration number in the reconstruction processing for the plurality of function calculation radiographic images acquired in advance and the first standard deviation correction value, and
wherein the noise standard deviation σ in the noise reduction processing unit satisfies a condition expressed by the following Formula (3).
σ=σₜ*f₁ (3)

19. The image processing apparatus as recited in claim 16,
wherein the standard deviation correction function includes a second correction function acquired in advance as a function in which the subset number in the reconstruction processing and a second standard deviation correction value correspond to each other,
wherein the correction value calculation unit calculates the second standard deviation correction value in the radiographic image of the subject by substituting the subset number in the reconstruction processing into the second correction function, and
wherein the correction arithmetic unit calculates the noise standard deviation in the radiographic image of the subject by correcting the basic noise standard deviation in the radiographic image of the subject calculated by the basic noise standard deviation calculation unit using the second standard deviation correction value in the radiographic image of the subject.

20. The image processing apparatus as recited in claim 19,
wherein the basic noise standard deviation σt in the basic noise deviation function is calculated by the following Formula (1)
σₜ=a₁*N^{a}^{₂}+a₃ (1)
using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of radiographic images acquired in advance and the noise standard deviation,
wherein the second standard deviation correction value f₂ is calculated by the following Formula (4)
$${f}_{2} = {c}_{1} * {log}_{2} ( \frac{s}{{s}^{base}} ) + {c}_{2} \qquad ( 4 )$$
using the subset number s in the reconstruction processing for radiographic data of the subject, a reference subset number s_{base} determined in advance, a first subset model coefficient c₁, and a second subset model coefficient c₂, the first subset model coefficient c₁ and the second subset model coefficient c₂ being acquired from a relation between the subset number in the reconstruction processing for the plurality of function calculation radiographic images acquired in advance and a second standard deviation correction value, and
wherein the noise standard deviation σ in the noise reduction processing unit satisfies a condition expressed by the following Formula (5).
σ=σₜ*f₂ (5)

21. The image processing apparatus as recited in claim 16,
wherein the standard deviation correction function includes a third correction function acquired in advance as a function in which a relaxation parameter in the reconstruction processing and a third standard deviation correction value correspond to each other,
wherein the correction value calculation unit calculates the third standard deviation correction value in the radiographic image of the subject by substituting the relaxation parameter in the reconstruction processing into the third correction function, and
wherein the correction arithmetic unit calculates the noise standard deviation in the radiographic image of the subject by correcting the basic noise standard deviation in the radiographic image of the subject calculated by the basic noise standard deviation calculation unit using the third standard deviation correction value in the radiographic image of the subject.

22. The image processing apparatus as recited in claim 21,
wherein the basic noise standard deviation σt in the basic noise deviation function is calculated by the following Formula (1)
σₜ=a₁*N^{a}^{₂}+a₃ (1)
using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of function calculation radiographic images acquired in advance and the noise standard deviation,
wherein the third standard deviation correction value f₃ is calculated by the following Formula (6)
$${f}_{3} = {d}_{1} * {log}_{2} ( \frac{r}{{r}^{base}} ) + {d}_{2} \qquad ( 6 )$$
using the relaxation parameter r in the reconstruction processing for radiographic data of the subject, a reference relaxation parameter r_{base} determined in advance, a first relaxation parameter model coefficient d₁, and a second relaxation parameter model coefficient d₂, the first relaxation parameter model coefficient d₁ and the second relaxation parameter model coefficient d₂ being acquired from a relation between the relaxation parameter in the reconstruction processing for the plurality of function calculation radiographic images acquired in advance and the third standard deviation correction value, and
wherein the noise standard deviation σ in the noise reduction processing unit satisfies a condition expressed by the following Formula (7).
σ=σₜ*f₃ (7)

23. The image processing apparatus as recited in claim 16,
wherein the standard deviation correction function includes a fourth correction function acquired in advance as a function in which a voxel size in the reconstruction processing and a fourth standard deviation correction value correspond to each other,
wherein the correction value calculation unit calculates the fourth standard deviation correction value in the radiographic image of the subject by substituting the voxel size in the reconstruction processing into the fourth correction function, and
wherein the correction arithmetic unit calculates the noise standard deviation in the radiographic image of the subject by correcting the basic noise standard deviation in the radiographic image of the subject calculated by the basic noise standard deviation calculation unit using the fourth standard deviation correction value in the radiographic image of the subject.

24. The image processing apparatus as recited in claim 23,
wherein the basic noise standard deviation σt in the basic noise deviation function is calculated by the following Formula (1)
σₜ=a₁*N^{a}^{₂}+a₃ (1)
using the count number N in the subject area, a first count model coefficient a₁, a second count model coefficient a₂, and a third count model coefficient a₃, the first count model coefficient a₁, the second count model coefficient a₂, and the third count model coefficient a₃, being acquired from a relation between the count number in each of the plurality of function calculation radiographic images of the subject acquired in advance and the noise standard deviation,
wherein the fourth standard deviation correction value f₄ is calculated by the following Formula (8)
$${f}_{4} = {e}_{1} * {( \frac{v}{{v}^{base}} )}^{e 2} + e3 \qquad ( 8 )$$
using a voxel size v in the reconstruction processing for radiographic data of the subject, a reference voxel size v_{base} determined in advance, a first voxel size model coefficient e₁, a second voxel size model coefficient e₂, and a third voxel size model coefficient e₃, the first voxel size model coefficient e₁, the second voxel size model coefficient e₂, and the third voxel size model coefficient e₃ being acquired from a relation between the reference voxel size in the reconstruction processing for the plurality of function calculation radiographic images acquired in advance and the fourth standard deviation correction value, and
wherein the noise standard deviation σ in the noise reduction processing unit satisfies a condition expressed by the following Formula (9)
σ=σₜ*f₄ (9)

25. The image processing apparatus as recited in claim 16,
wherein the standard deviation correction function includes
a first correction function acquired in advance as a function in which an iteration number in the reconstruction processing and a first standard deviation correction value correspond to each other,
a second correction function acquired in advance as a function in which the subset number in the reconstruction processing and a second standard deviation correction value correspond to each other,
a third correction function acquired in advance as a function in which a relaxation parameter in the reconstruction processing and a third standard deviation correction value correspond to each other, and
a fourth correction function acquired in advance as a function in which a voxel size in the reconstruction processing and a fourth standard deviation correction value correspond to each other,
wherein the correction value calculation unit
calculates a first standard deviation correction value in the radiographic image of the subject by substituting the iteration number in the reconstruction processing into the first correction function,
calculates a second standard deviation correction value in the radiographic image of the subject by substituting the subset number in the reconstruction processing into the second correction function,
calculates a third standard deviation correction value in the radiographic image of the subject by substituting a relaxation parameter in the reconstruction processing into the third correction function, and
calculates a fourth standard deviation correction value in the radiographic image of the subject by substituting a voxel size in the reconstruction processing into the fourth correction function, and
wherein the correction arithmetic unit calculates the noise standard deviation in the radiographic image of the subject by correcting the basic noise standard deviation in the radiographic image of the subject calculated by the basic noise standard deviation calculation unit using the first standard deviation correction value, the second standard deviation correction value, the third standard deviation correction value, and the fourth standard deviation correction value in the radiographic image of the subject.

26. The image processing apparatus as recited in claim 25,
wherein a basic noise deviation function in the basic noise deviation σt is calculated by the following Formula (1)
σₜ=a₁*N^{a}^{₂}+a₃ (1)
using the count number N in the subject area, a first count model coefficient a₁, a second count model coefficient a₂, and a third count model coefficient a₃, the first count model coefficient a₁, the second count model coefficient a₂, and the third count model coefficient a₃ being acquired from a relation between the count number in each of the plurality of function calculation radiographic images of the subject acquired in advance and the noise standard deviation,
wherein the first standard deviation correction value f₁ is calculated by the following Formula (2)
$${f}_{1} = {b}_{1} * {log}_{2} ( \frac{i}{{i}^{base}} ) + {b}_{2} \qquad ( 2 )$$
using the iteration number i in the reconstruction processing for radiographic data of the subject, a standard iteration number i_{base} determined in advance, a first iteration number model coefficient b₁, and a second iteration number model coefficient b₂, the first iteration number model coefficient b₁ and the second iteration number model coefficient b₂ being acquired from a relation between the iteration number in the reconstruction processing for the plurality of function calculation radiographic images of the subject and the first standard deviation correction value,
wherein the second standard deviation correction value f₂ is calculated by the following Formula (4).
$${f}_{2} = {c}_{1} * {log}_{2} ( \frac{s}{{s}^{base}} ) + {c}_{2} \qquad ( 4 )$$
using the subset number s in the reconstruction processing for radiographic data of the subject, a reference subset number s_{base} predefined in advance, a first subset model coefficient c₁, a second subset model coefficient c₂, the first subset model coefficient c₁ and the second subset model coefficient c₂ being acquired from a relation between the subset number in the reconstruction processing for the plurality of function calculation radiographic images acquired in advance and the second standard correction value,
wherein the third standard deviation correction value f₃ is calculated by the following Formula (6)
$${f}_{3} = {d}_{1} * {log}_{2} ( \frac{r}{{r}^{base}} ) + {d}_{2} \qquad ( 6 )$$
using the relaxation parameter r in the reconstruction processing for radiographic data of the subject, a reference relaxation parameter r_{base} predetermined in advance, a first relaxation parameter model coefficient d₁, and a second relaxation parameter model coefficient d₂, the first relaxation parameter model coefficient d₁ and the second relaxation parameter model coefficient d₂ being acquired from a relation between the relaxation parameter in the reconstruction processing for the plurality of function calculation radiographic images acquired in advance and the third standard deviation correction value,
wherein the fourth standard deviation correction value f₄ is calculated by the following Formula (8)
$${f}_{4} = {e}_{1} * {( \frac{v}{{v}^{base}} )}^{e 2} + e 3 \qquad ( 8 )$$
using the voxel size v in the reconstruction processing for radiographic data of the subject, a reference voxel size v_{base} determined in advance, a first voxel size model coefficient e₁, a second voxel size model coefficient e₂, and a third voxel size model coefficient e₃, the first voxel size model coefficient e₁, the second voxel size model coefficient e₂, and the third voxel size model coefficient e₃ being acquired from a relation between the reference voxel size in the reconstruction processing for the plurality of function calculation radiographic images acquired in advance and the fourth standard deviation correction value, and
wherein the noise standard deviation σ in the noise reduction processing unit satisfies a condition expressed by the following Formula (10).
σ=σₜ*f₁*f₂*f₃*f₄ (10)

27. A nuclear medicine diagnostic apparatus comprising:
a radiation detector configured to detect radiation transmitted through a subject and output radiation data; and
the image processing apparatus as recited in claim 14.
